(19) United States
(12) Patent Application Publication
(10) Pub. No.: US 2016/0153649 A1
(43) Pub. Date: Jun. 2, 2016

(54) LED LIGHT FIXTURE

(71) Applicant: Cree, Inc., Durham, NC (US)

(72) Inventors: Kurt S. Wilcox, Libertyville, IL (US); Brian Kinnune, Racine, WI (US); Nathan Snell, Raleigh, NC (US); Jeremy Sorenson, Oak Creek, WI (US); Corey Goldstein, Mt. Pleasant, WI (US); Nicholas W. Medendorp, JR., Raleigh, NC (US)

(21) Appl. No.: 15/017,971

(22) Filed: Feb. 8, 2016

Related U.S. Application Data
(63) Continuation of application No. 14/708,558, filed on May 11, 2015, now Pat. No. 9,261,270.
Application No. 14/708,558 is a continuation of application No. 13/834,525, filed on Mar. 15, 2013, now Pat. No. 9,039,223.
Application No. 13/834,525 is a continuation of application No. 13/294,459, filed on Nov. 11, 2011, now Pat. No. 8,425,071.
Application No. 13/294,459 is a continuation of application No. 12/629,986, filed on Dec. 3, 2009, now Pat. No. 8,070,306.
Application No. 12/629,986 is a continuation of application No. 11/860,887, filed on Sep. 25, 2007, now Pat. No. 7,686,469.
Application No. 11/860,887 is a continuation-in-part of application No. 11/541,908, filed on Sep. 30, 2006, now abandoned.
Application No. 11/541,908 is a continuation-in-part of application No. 14/708,422, filed on May 11, 2015, now Pat. No. 9,255,705.
Application No. 14/708,422 is a continuation of application No. 14/246,776, filed on Apr. 7, 2014, now Pat. No. 9,028,087.
Application No. 14/246,776 is a continuation-in-part of application No. 13/764,743, filed on Feb. 11, 2013, now Pat. No. 9,243,794.
Application No. 13/764,743 is a continuation-in-part of application No. 13/764,736, filed on Feb. 11, 2013, now Pat. No. 9,222,632.
Application No. 13/764,736 is a continuation-in-part of application No. 13/764,746, filed on Feb. 11, 2013, now Pat. No. 9,212,812.
Application No. 13/764,743 is a continuation-in-part of application No. 29/444,511, filed on Jan. 31, 2013, now Pat. No. D718482.
Application No. 13/764,736 is a continuation-in-part of application No. 29/444,511, filed on Jan. 31, 2013, now Pat. No. D718482.
Application No. 14/246,776 is a continuation-in-part of application No. 13/839,922, filed on Mar. 15, 2013.
Application No. 13/839,922 is a continuation-in-part of application No. 14/719,359, filed on May 22, 2015, now Pat. No. 9,261,271.
Application No. 14/719,359 is a continuation of application No. 14/087,971, filed on Nov. 22, 2013, now Pat. No. 9,039,241.
Application No. 14/087,971 is a continuation of application No. 13/680,481, filed on Nov. 19, 2012, now Pat. No. 8,622,584.
Application No. 13/680,481 is a continuation of application No. 13/333,198, filed on Dec. 21, 2011, now Pat. No. 8,313,222.
Application No. 13/333,198 is a continuation of application No. 12/418,364, filed on Apr. 3, 2009, now Pat. No. 8,092,049.
(60) Provisional application No. 61/624,211, filed on Apr. 13, 2012.
(60) Provisional application No. 61/042,690, filed on Apr. 4, 2008.

(51) Int. Cl. F21V 29/83; F21V 29/71; F21V 29/76; F21S 2/00; F21V 23/00; F21V 29/507; F21V 29/70; F21K 99/00

(52) U.S. Cl. CPC F21V 29/83; F21V 29/70; F21V 29/71; F21K 9/10; F21S 2/005; F21V 23/009; F21V 29/507; F21V 29/763; F21Y 2101/02; F21W 2131/103

(57) ABSTRACT

An LED light fixture including a housing portion and a base together defining an open space therebetween permitting air/water-flow therethrough. The housing portion forms a chamber enclosing at least one driver. The base extends from the housing portion and supports at least one LED illuminator outside the chamber. The housing portion and the base may each be formed as part of a one piece with the open space along at least three sides of the base. Alternatively, the base may be a separate structure secured with respect to the housing. Such base may be a single-piece extrusion supporting a plurality of LED modules or comprise a plurality of extruded heat sinks. Each heat sink may support one or more LED modules.

### RELATED APPLICATION

This application is a continuation of patent application Ser. No. 14/708,558, filed May 11, 2015, now U.S. Pat. No. 9,261,270, issued Feb. 16, 2016, which is a continuation of patent application Ser. No. 13/834,525, filed Mar. 15, 2013, now U.S. Pat. No. 9,039,223, issued May 26, 2015, which is a continuation of patent application Ser. No. 13/294,459, filed Nov. 11, 2011, now U.S. Pat. No. 8,425,071, issued Apr. 23, 2013, which is a continuation of patent application Ser. No. 12/629,986, filed Dec. 3, 2009, now U.S. Pat. No. 8,070,306, issued Dec. 6, 2011, which is a continuation of patent application Ser. No. 11/860,887, filed Sep. 25, 2007, now U.S. Pat. No. 7,686,469, issued Mar. 30, 2010, which is a continuation-in-part of now abandoned patent application Ser. No. 11/541,908, filed Sep. 30, 2006. This application is also a continuation-in-part of patent application Ser. No. 14/708,422, filed May 11, 2015, now U.S. Pat. No. 9,255,705, issued Feb. 9, 2016, which is a continuation of patent application Ser. No. 14/246,776, filed on Apr. 7, 2014, now U.S. Pat. No. 9,028,087, issued May 12, 2015, which is a continuation-in-part of patent application Ser. Nos. 13/764,743, 13/764,736 and 13/764,746, each filed Feb. 11, 2013, now respective U.S. Pat. No. 9,243,794, issued Jan. 26, 2016, U.S. Pat. No. 9,222,632, issued Dec. 29, 2015, and U.S. Pat. No. 9,212,812, issued Dec. 15, 2015. Patent application Ser. Nos. 13/764,743 and 13/764,736 are each a continuation-in-part of patent application Ser. No. 29/444,511, filed Jan. 31, 2013, now Pat. No. D718,482, issued Nov. 25, 2014. And, patent application Ser. No. 14/246,776 is also a continuation-in-part of patent application Ser. No. 13/839,922, filed Mar. 15, 2013, which is based on U.S. Provisional Application Ser. No. 61/624,211, filed Apr. 13, 2012. This application is also a continuation-in-part of patent application Ser. No. 14/719,359, filed May 22, 2015, now U.S. Pat. No. 9,261,271, issued Feb. 16, 2016, which is a continuation of patent application Ser. No. 14/087,971, filed Nov. 22, 2013, now U.S. Pat. No. 9,039,241, issued May 26, 2015, which in turn is a continuation of patent application Ser. No. 13/680,481, filed Nov. 19, 2012, now U.S. Pat. No. 8,622,584, issued Jan. 7, 2014, which in turn is a continuation of patent application Ser. No. 13/333,198, filed Dec. 21, 2011, now U.S. Pat. No. 8,313,222, issued Nov. 20, 2012, which in turn is a continuation of patent application Ser. No. 12/418,364, filed Apr. 3, 2009, now U.S. Pat. No. 8,092,049, issued Jan. 10, 2012, which in turn is based in part on U.S. Provisional Application Ser. No. 61/042,690, filed Apr. 4, 2008.

The contents of each of application Ser. Nos. 14/708,558, 14/708,422, 14/719,359, 14/246,776, 14/087,971, 13/764,743, 13/834,525, 13/294,459, 12/629,986, 11/860,887, 11/541,908, 13/764,736, 13/764,746, 13/839,922, 61/624,211, 13/680,481, 13/333,198, 12/418,364, 29/444,511 and 61/042,690 are incorporated herein by reference in their entirety.

### FIELD OF THE INVENTION

This invention relates to light fixtures and, more particularly, to light fixtures using light-emitting diodes (LEDs).

### BACKGROUND OF THE INVENTION

In recent years, the use of light-emitting diodes (LEDs) in the development of light fixtures for various common lighting purposes has increased, and this trend has accelerated as advances have been made in the field. Indeed, lighting applications which previously had typically been served by fixtures using what are known as high-intensity discharge (HID) lamps are now being served by LED light fixtures. Such lighting applications include, among a good many others, roadway lighting, factory lighting, parking lot lighting, and commercial building lighting.

High-luminance light fixtures using LED modules as a light source present particularly challenging problems. One particularly challenging problem for high-luminance LED light fixtures relates to heat dissipation. It is of importance for various reasons, one of which relates to extending the useful life of the lighting products. Achieving improvements without expensive additional structure is much desired.

In summary, finding ways to significantly improve the dissipation of heat to the atmosphere from LED light fixtures would be much desired, particularly in a fixture that is easy and inexpensive to manufacture.

### SUMMARY OF THE INVENTION

The present invention relates to improved LED light fixtures. In certain embodiments, the inventive LED light fixture includes a housing portion and a base extending from the housing portion. The housing portion forms a chamber enclosing at least one driver. The base supports at least one LED illuminator outside the chamber. The housing portion and the base define an open space therebetween permitting air/water-flow therethrough.

In certain embodiments, the housing portion and the base are each formed as part of a one piece comprising at least one frame member supporting the base with respect to the housing portion. In some of such embodiments, the one piece includes forward and rearward regions.

In some examples, the rearward region includes the chamber and a rearmost portion adapted for securement to a support member. The base may be within the forward region which defines the open space along at least three sides of the base.

The at least one LED illuminator is in thermal contact with an illuminator-supporting region of the base. In particular embodiments, the at least one LED illuminator has an optical member disposed over at least one LED emitter.

The optical member may be configured for directing emitter light predominantly forward. In some of such embodiments, a rearward shield member extends downwardly at the rearward side of the base. The rearward shield member may extend lower than a lowermost outer-surface portion of the optical member to block rearward illumination therefrom.

In certain embodiments, the base may be a separate structure secured with respect to the housing. The open space may be along at least three sides of the base.

Some examples of the base include a pair of extruded side portions each forming a channel along the base. In certain of such embodiments, the side portions and the base are of a single-piece extrusion secured with respect to the housing. In certain examples of such embodiments, the single-piece extrusion has an illuminator-supporting region.

In some embodiments, the at least one LED illuminator comprises a plurality of LED modules. In certain embodiments, the plurality of LED modules are in thermal contact with the illuminator-supporting region of the single-piece extrusion.

The LED-array modules may be substantially rectangular having predetermined module-lengths. The illuminator-supporting region may have a length which is selected from one module-length and a multiple thereof. In some of such embodiments, at least one of the plurality of modules has a module-length different than the module-length of at least another of the plurality of modules.

Some examples of the base include a plurality of extruded heat sinks. In certain of such examples, the at least one LED illuminator has a plurality of LED modules each in thermal contact with a respective one of the extruded heat sinks. Sometimes, each heat sink supports one of the LED modules such that the number of the modules equals to the number of the heat sinks.

Some embodiments include at least one wall extending within the open space and open for air/water-flow along at least two sides thereof. The at least one wall sometimes extends within the open space substantially along the base. In some examples, the at least one wall divides the open space into an illuminator-adjacent flow region and a chamber-adjacent flow region.

The term “ambient fluid” as used herein means air and/or water around and coming into contact with the light fixture.

The term “projected,” as used with respect to various portion and areas of the fixture, refers to such portions and areas of the fixture in plan views.

As used herein in referring to portions of the devices of this invention, the terms “upward,” “upwardly,” “upper,” “downward,” “downwardly,” “lower,” “upper,” “top,” “bottom” and other like terms assume that the light fixture is in its usual position of use.

In descriptions of this invention, including in the claims below, the terms “comprising,” “including” and “having” (each in their various forms) and the term “with” are each to be understood as being open-ended, rather than limiting, terms.

### BRIEF DESCRIPTION OF THE DRAWINGS

FIG. 1 is a perspective view of a preferred LED lighting fixture in accordance with this invention, including a cut-away portion showing an LED assembly.

FIG. 2 is a perspective view of the LED lighting fixture configured for wall mounting.

FIG. 3 is a perspective view of another LED lighting fixture including a pole-mounting assembly on a pole of square cross-section.

FIG. 4 is a side perspective view of the LED lighting of FIG. 1 broken away at a middle portion to show interior structure.

FIG. 5 is a front perspective view of the LED lighting of FIG. 1 broken away at a middle portion to show interior structure.

FIG. 6 is a fragmentary view of the right portion of FIG. 4.

FIG. 7 is another fragmentary perspective view showing the frame structure partially cut away to illustrate its being bolted together with the border structure.

FIG. 8 is another fragmentary perspective view showing the border structure partially cut-away to illustrate its engagement with the frame structure.

FIG. 9 is a greatly enlarged fragmentary perspective view showing a portion of the chamber-divider wall, the notch therein and the notch-bridge thereover.

FIG. 10 is a perspective view of one LED-array module LED and its related LED heat sink of the LED assembly of the illustrated LED lighting fixtures.

FIG. 11 is a perspective view of two interconnected LED heat sinks of the LED assembly of the illustrated LED lighting fixtures.

FIG. 12 is a fragmentary perspective view from below of the pole-mounting assembly engaged with a pole-attachment portion, with the cover of the pole-mounting assembly removed to show internal parts.

FIG. 13 is a perspective view of the LED lighting fixture of the type having the housing being a substantially H-shaped structure.

FIG. 14 is a top perspective view of another embodiment of the LED lighting fixture including a restraining bracket seen through a cut-away in the protective cover.

FIG. 15 is a perspective view of the restraining bracket of FIG. 14.

FIG. 16 is a perspective view from below of another embodiment of an LED light fixture in accordance with this invention. FIG. 16 shows a version of such LED light fixture including LED-array modules with ten LEDs thereon.

FIG. 17 is a perspective view from above of the LED light fixture of FIG. 16.

FIG. 18 is a perspective view from below of another embodiment of an LED light fixture in accordance with this invention. FIG. 18 shows a version of such LED light fixture including LED-array modules with twenty LEDs thereon.

FIG. 19 is a perspective view from above of the LED light fixture of FIG. 18.

FIG. 20 is a widthwise cross-sectional view of the LED light fixture across the single-piece extrusion showing one configuration of the extrusion.

FIG. 21 is a widthwise cross-sectional view of the LED light fixture across the single-piece extrusion showing another configuration of the extrusion.

FIG. 22 is a fragmentary lengthwise cross-sectional view of the LED light fixture of FIG. 16 taken along lines 22-22 shown in FIG. 19.

FIGS. 23-25 are heat-dissipation diagrams showing air-flow through the LED light fixture.

FIG. 26 is a perspective view from below of the LED light fixture of FIG. 16 shown with a lower portion in open position.

FIG. 27 is a bottom plan view of the LED light fixture of FIG. 16.

FIG. 28 is a bottom plan view of the LED light fixture of FIG. 27 with an LED arrangement including two side-by-side LED-array modules.

FIG. 29 is a bottom plan view of the LED light fixture of FIG. 18.

FIG. 30 is a bottom plan view of the LED light fixture of FIG. 29 with an LED arrangement including two side-by-side LED-array modules.

FIG. 31 is a bottom plan view of the LED light fixture of FIG. 29 with an LED arrangement including side-by-side LED-array modules having different lengths.

FIG. 32 is a bottom plan view of an embodiment of the LED light fixture with LED-array modules mounted in end-to-end relationship to one another.

FIGS. 33-35 are bottom plan views of embodiments of the LED light fixture of FIG. 32 with same-length LED-array modules mounted in end-to-end relationship to one another showing alternative arrangements of the LED-array modules.

FIGS. 36, 37 and 37A are bottom plan views of yet more embodiments of the LED light fixture of FIG. 32 showing an LED arrangement with a combination of same-length and different-length LED-array modules in end-to-end relationship to one another.

FIG. 38 is a bottom plan view of still another embodiment of the LED light fixture with different-length LED-array modules mounted in end-to-end relationship to one another.

FIGS. 39-41 are bottom plan views of alternative embodiments of the LED light fixture of FIG. 38 showing alternative arrangements of such LED-array modules.

FIG. 42 is a fragmentary lengthwise cross-sectional view of the LED light fixture of FIG. 32 taken along lines 42-42 to show a closed wireway formed of and along the extrusion.

FIG. 43 is a bottom plan view of an embodiment of the LED light fixture which has a venting aperture through a base of the extrusion.

FIG. 44 is a bottom plan view of another embodiment of the LED light fixture as in FIG. 43 but with an alternative arrangement of LED modules.

FIG. 45 is a fragmentary lengthwise cross-sectional view of the LED light fixture of FIG. 43 taken along lines 45-45.

FIG. 46 is a fragmentary perspective view from below of the LED light fixture of FIG. 43 showing a deflector member within the venting aperture.

FIG. 47 is a top plan view of the embodiment of the LED light fixture of FIG. 43.

FIG. 48 is a perspective view from below of an upper portion of a first-end portion of a housing of the inventive LED light fixture.

FIG. 49 is a front perspective view of the upper portion of FIG. 48.

FIG. 50 is a rear perspective view of an end-casting of a second-end portion of the housing of the inventive LED light fixture.

FIG. 51 is a front perspective view of the end-casting of FIG. 49.

FIG. 52 is a widthwise cross-sectional view of the LED light fixture across the single-piece extrusion showing an example of a wireway retention channel.

FIG. 53 is a fragmentary perspective view from below of the single-piece extrusion of the LED light fixture of FIG. 46.

FIG. 54 is a fragmentary perspective view from above of the single-piece extrusion of FIG. 52 showing a wireway tube extending from the retention channel.

FIG. 55 is a fragmentary perspective view from above of the single-piece extrusion of FIG. 52 showing a wireway tube extending from the retention channel and received by the second end-portion.

FIG. 56 is a fragmentary perspective view from above of the single-piece extrusion of FIG. 52 with the wireway tube secured with respect to the second end-portion.

FIG. 57 is a perspective view from below of one embodiment of an LED light fixture in accordance with this invention.

FIG. 58 is a perspective view from above of the LED light fixture of FIG. 57.

FIG. 59 is a top plan view of the LED light fixture of FIG. 57.

FIG. 60 is a bottom plan view of the LED light fixture of FIG. 57.

FIG. 61 is an exploded perspective view of the LED lighting of FIG. 57.

FIG. 62 is another perspective view showing a front of the LED light fixture from below with open cover member and secured to a support member.

FIG. 63 is a fragmentary perspective view showing the disengaged forward end of the cover member with an integrated latching member.

FIG. 64 is another fragmentary perspective view showing the rearward end of the cover member with an integrated hinging member.

FIG. 65 is a side rear perspective view showing the LED light fixture secured with respect to a support member and having its cover member hanging open.

FIG. 66 is a top rear perspective view showing the LED light fixture secured with respect to the support.

FIG. 67 is a fragmentary front perspective view from below illustrating the forward region of the fixture with its LED assembly therein, including its LED illuminator.

FIG. 68 is a fragmentary side perspective view from below showing the same portions of the fixtures as shown in FIG. 67 from a somewhat different angle.

FIG. 69 is a side-to-side cross-sectional view of the LED light fixture taken along section 69-69 as indicated in FIG. 60.

FIG. 70 is a front elevation of the LED light fixture of FIG. 57.

FIG. 71 is a rear elevation of the LED light fixture of FIG. 57.

FIG. 72 is a side cross-sectional view of the LED light fixture taken along section 72-72 as indicated in FIG. 60.

FIG. 73 is a bottom plan view of one embodiment of the LED light fixture secured to a support member and with its cover member open.

FIG. 74 is a bottom plan view similar to FIG. 73 but with the cover in its closed position.

FIG. 75 is a top plan view of the LED light fixture secured to a support member.

FIG. 76 is a top perspective view of an alternative embodiment of this invention.

FIG. 77 is a front top perspective view of another alternative embodiment of this invention.

FIG. 78 is an exploded perspective view of the LED light fixture of FIG. 77.

FIG. 79 is a bottom perspective view of yet another alternative embodiment of this invention.

FIG. 80 is a bottom perspective view of still another embodiment of this invention.

FIG. 81 is a bottom plan view showing the LED light fixture of FIG. 80 without its LED illuminator in place.

FIG. 82 is a bottom perspective partially-exploded view of the LED light fixture of FIG. 80.

FIGS. 83 and 84 are enlarged perspective views of two examples of LED packages usable in LED light fixtures of this invention, the LED packages including different arrays of LEDs on a submount with an asymmetric primary lens overmolded on the LED arrays.

FIG. 85 is an enlarged perspective of yet another example of an LED package which has a single LED on a submount with an overmolded hemispheric primary lens.

FIG. 86 is an enlarged side view of the LED package of FIG. 85.

FIG. 87 is an enlarged top plan view of the LED package of FIG. 85.

FIG. 88 is a fragmentary side-to-side cross-sectional view similar to FIG. 69, but illustrating the heat sink having a surface opposite the LED illuminator which slopes toward both lateral sides of the heat sink.

FIG. 89 is a fragmentary front-to-back cross-sectional view similar to FIG. 72, but illustrating the heat sink having a surface opposite the LED illuminator which slopes toward both the front and back sides of the heat sink.

FIG. 90 is a bottom plan view of still another embodiment of the invention.

FIGS. 91-93 are schematic top plan views of the LED light fixture of FIG. 57, such figures serving to indicate particular projected areas of the fixture for purposes of facilitating description of certain aspects of the invention.

FIGS. 94-96 are bottom plan views of still alternative embodiments of the invention.

FIGS. 94A-96A are bottom plan views of yet other alternative embodiments of the invention.

### DETAILED DESCRIPTION OF EXEMPLARY EMBODIMENTS

The figures illustrate exemplary embodiments of LED light fixtures in accordance with this invention.

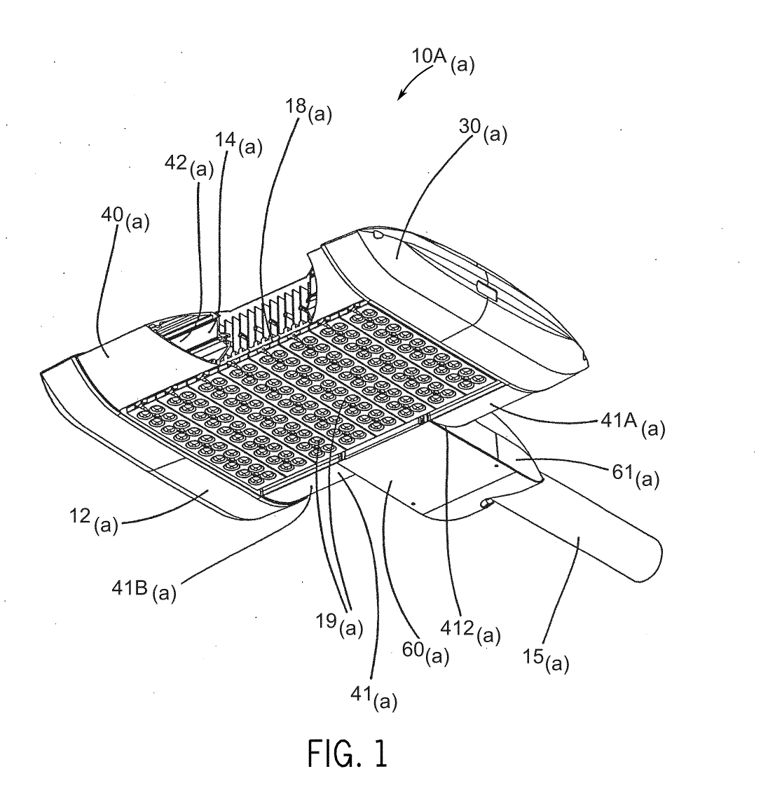

FIGS. 1-15 illustrate exemplary LED lighting fixtures 10A₍ₐ₎-10D₍ₐ₎ in accordance with this invention. Common or similar parts are given the same numbers in the drawings of both embodiments, and the lighting fixtures are often referred to by the numeral 10₍ₐ₎, without the A or D lettering used in the drawings, and in the singular for convenience.

Lighting fixture 10₍ₐ₎ includes a housing 12₍ₐ₎ that forms a substantially air/water-tight chamber 14₍ₐ₎, at least one electronic LED driver 16₍ₐ₎ enclosed within chamber 14₍ₐ₎ and an LED assembly 18₍ₐ₎ secured with respect to housing 12₍ₐ₎ adjacent thereto in non-air/water-tight condition. LED assembly 18₍ₐ₎ has a plurality of LED-array modules 19₍ₐ₎ each secured to an LED heat sink 20₍ₐ₎.

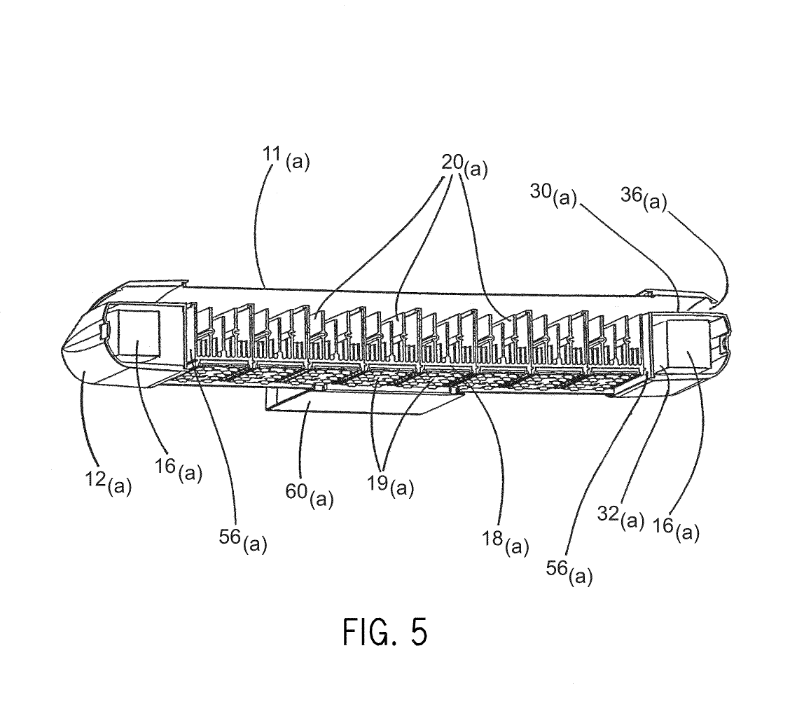

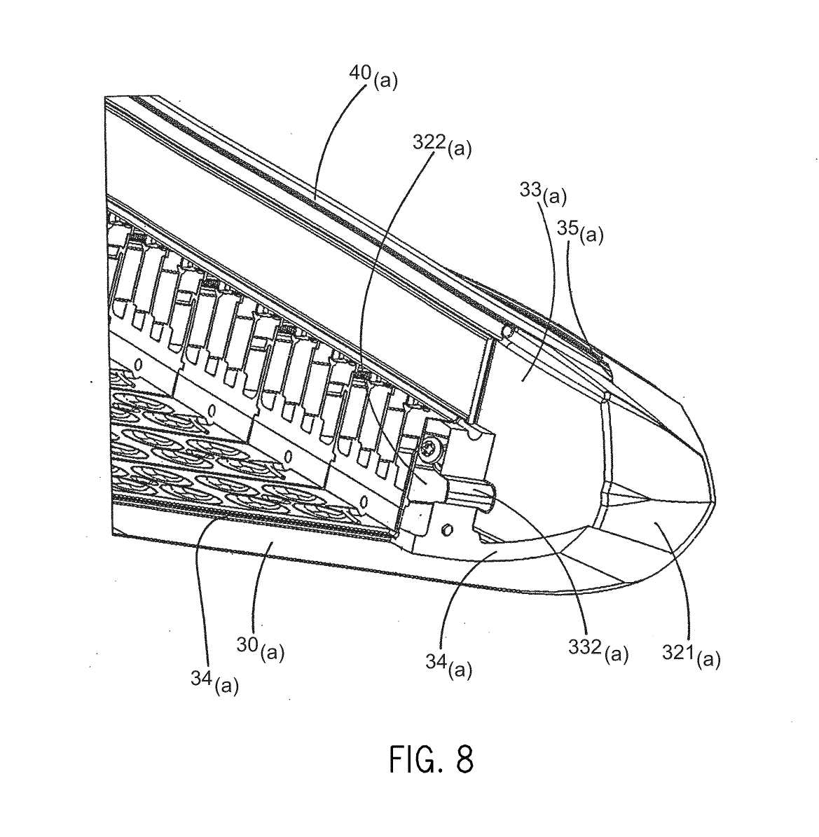

As seen in FIGS. 1-4, 7 and 8, housing 12₍ₐ₎ includes a frame structure 30₍ₐ₎ forming a frame-portion 32₍ₐ₎ of chamber 14₍ₐ₎ with an opening edge 34₍ₐ₎ thereabout and a border structure 40₍ₐ₎ (sometimes referred to as a nose structure 40₍ₐ₎) secured to frame structure 30₍ₐ₎ and forming a border-portion 42₍ₐ₎ (sometimes referred to as nose-portion 42₍ₐ₎) of chamber 14₍ₐ₎. As best seen in FIG. 8, opening edge 34₍ₐ₎ of frame-portion 30₍ₐ₎ of chamber 14₍ₐ₎ includes a groove 35₍ₐ₎ configured for mating air/water-tight engagement with border structure 40₍ₐ₎. Border structure 40₍ₐ₎ is an extrusion, preferably of aluminum. FIG. 5 shows electronic LED drivers 16₍ₐ₎ enclosed in frame-portion 32₍ₐ₎ of chamber 14₍ₐ₎.

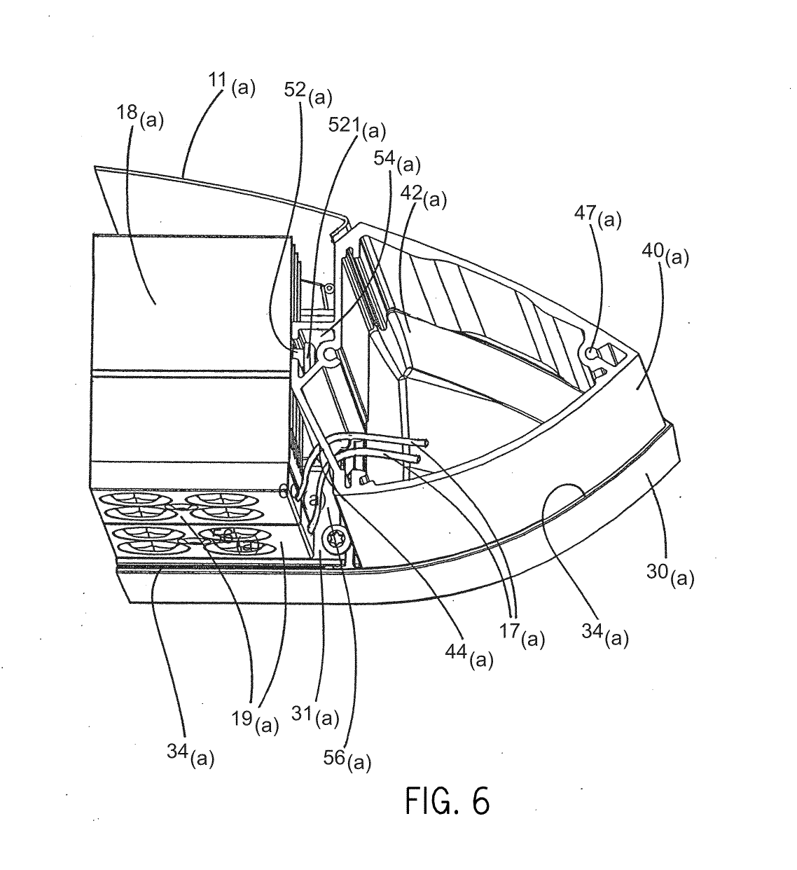

As best seen in FIG. 6, border structure 40₍ₐ₎ includes substantially air/water-tight wire-accesses 44₍ₐ₎ for passage of wires 17₍ₐ₎ between LED assembly 18₍ₐ₎ and water/air-tight chamber 14₍ₐ₎.

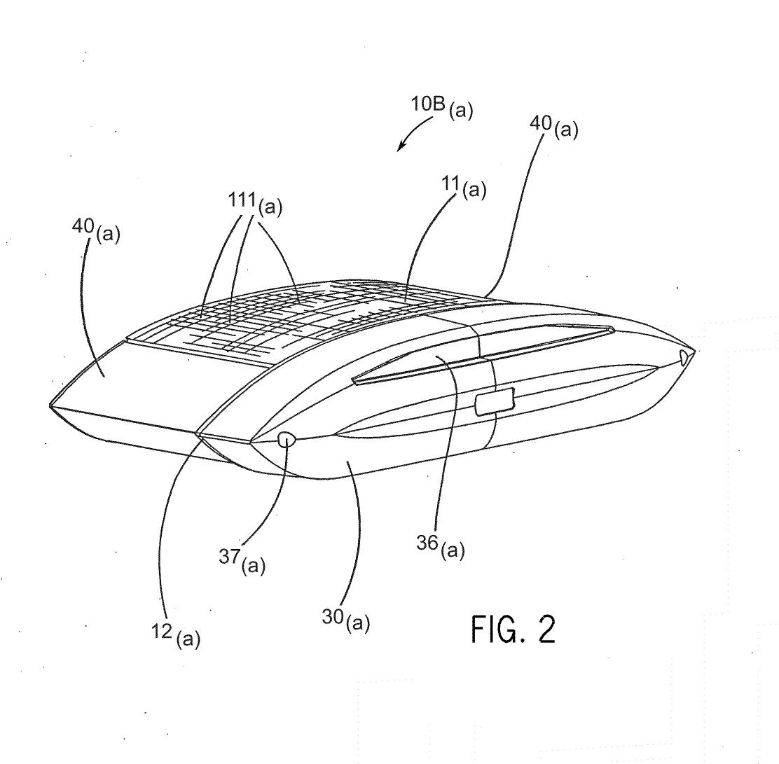

FIGS. 2, 3, 5 and 7 show that frame structure 30₍ₐ₎ includes a vent 36₍ₐ₎ permitting air flow to and from LED assembly 18₍ₐ₎. Vent 36₍ₐ₎ facilitates cooling of LED assembly 18₍ₐ₎.

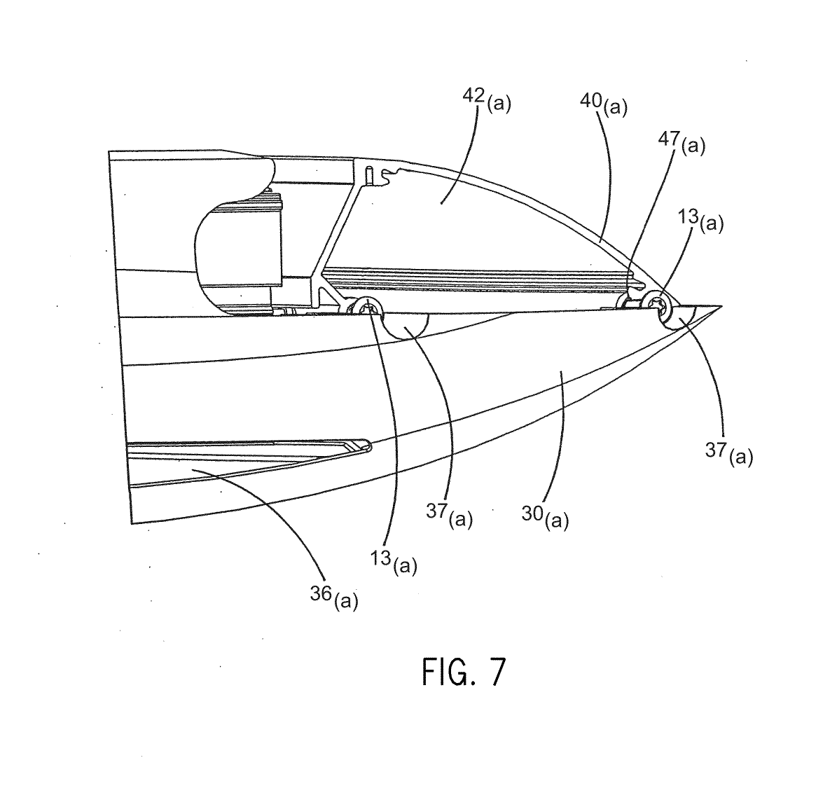

As best illustrated in FIGS. 6 and 7, border structure 40₍ₐ₎ has bolt-receiving border-hole 47₍ₐ₎ therethrough which is isolated from border-portion 42₍ₐ₎ of chamber 14₍ₐ₎. And, frame structure 30₍ₐ₎ has bolt-receiving frame-holes 37₍ₐ₎ therethrough which are isolated from frame-portion 32₍ₐ₎ of chamber 14₍ₐ₎; frame-hole 37₍ₐ₎ is aligned with a respective border-hole 47₍ₐ₎. A bolt 13₍ₐ₎ passes through aligned pair of bolt-receiving holes 37₍ₐ₎ and 47₍ₐ₎ such that border structure 40₍ₐ₎ and frame structure 30₍ₐ₎ are bolted together while maintaining the air/water-tight condition of chamber 14₍ₐ₎.

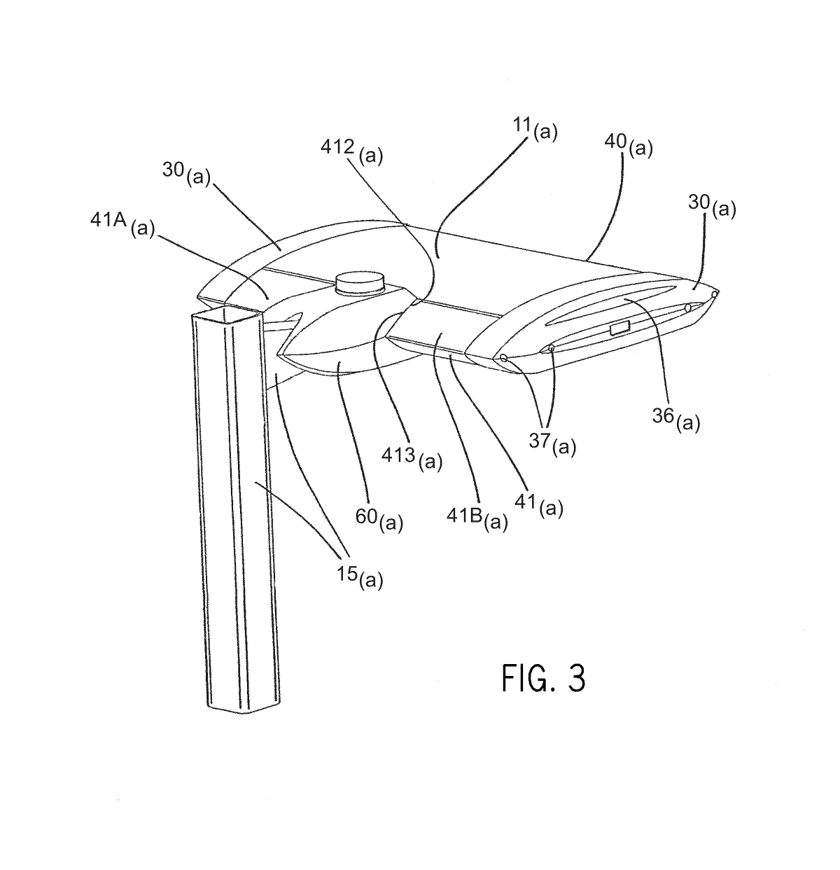

FIGS. 1 and 3 best illustrate certain highly preferred embodiments of this invention in which housing 12₍ₐ₎ is a perimetrical structure which includes a pair of opposed frame structures 30₍ₐ₎ and a pair of opposed nose structures 40₍ₐ₎, making perimetrical structure 12₍ₐ₎ of lighting fixture 10A₍ₐ₎ substantially rectangular. FIGS. 1, 4-8 and 11 illustrate aspects of inventive LED lighting fixture 10A₍ₐ₎.

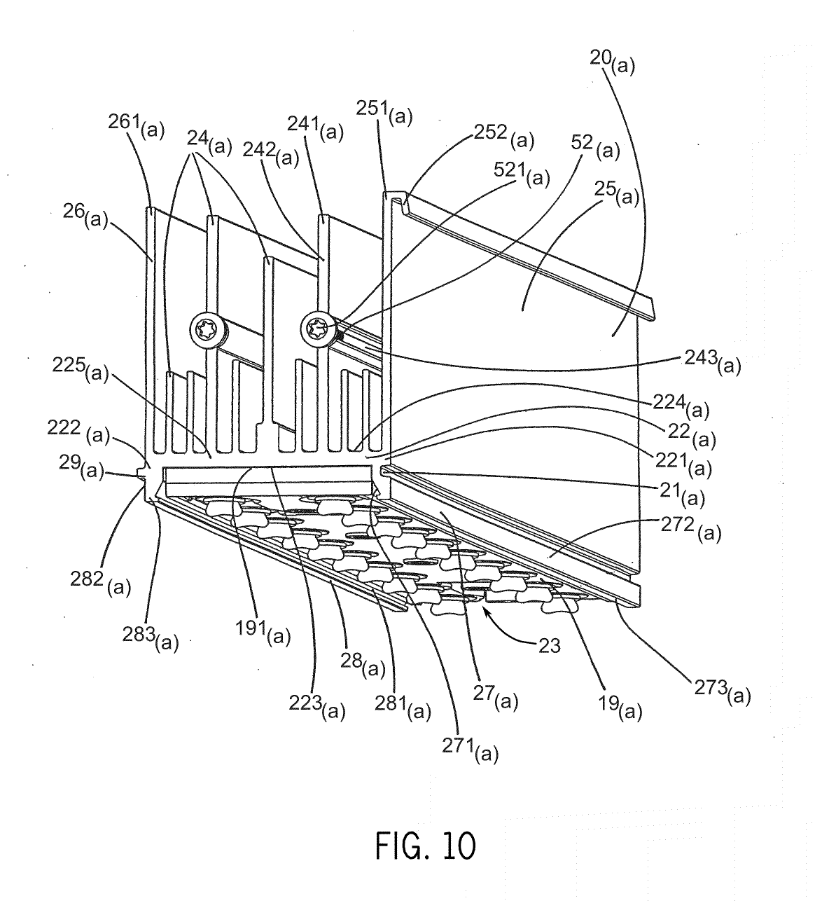

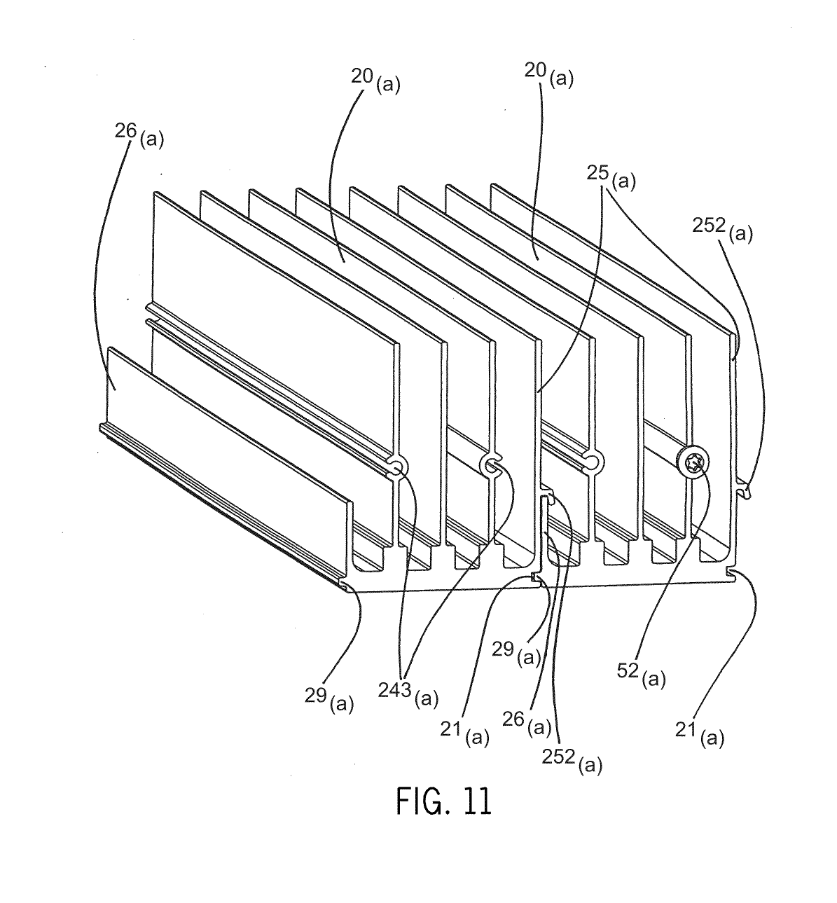

In LED lighting fixtures illustrated in FIGS. 1-15, LED assembly 18₍ₐ₎ includes a plurality of LED-array modules 19₍ₐ₎ each separately mounted on its corresponding LED heat sink 20₍ₐ₎, such LED heat sinks 20₍ₐ₎ being interconnected to hold LED-array modules 19₍ₐ₎ in fixed relative positions. Each heat sink 20₍ₐ₎ includes: a base 22₍ₐ₎ with a back base-surface 223₍ₐ₎, an opposite base-surface 224₍ₐ₎, two base-ends 225₍ₐ₎ and first and second base-sides 221₍ₐ₎ and 222₍ₐ₎; a plurality of inner-fins 24₍ₐ₎ protruding from opposite base-surface 224₍ₐ₎; first and second side-fins 25₍ₐ₎ and 26₍ₐ₎ protruding from opposite base-surface 224₍ₐ₎ and terminating at distal fin-edges 251₍ₐ₎ and 261₍ₐ₎, first side-fin 25₍ₐ₎ including a flange hook 252₍ₐ₎ positioned to engage distal fin-edge 261₍ₐ₎ of second side-fin 26₍ₐ₎ of adjacent heat sink 20₍ₐ₎; and first and second lateral supports 27₍ₐ₎ and 28₍ₐ₎ protruding from back base-surface 223₍ₐ₎, lateral supports 27₍ₐ₎ and 28₍ₐ₎ each having inner portions 271₍ₐ₎ and 281₍ₐ₎, respectively, and outer portion 272₍ₐ₎ and 282₍ₐ₎, respectively. Inner portions 271₍ₐ₎ and 281₍ₐ₎ of first and second lateral supports 27₍ₐ₎ and 28₍ₐ₎ have first and second opposed support-ledges 273₍ₐ₎ and 283₍ₐ₎, respectively, that form a heat-sink-passageway 23₍ₐ₎ which slidably supports an LED-array module 19₍ₐ₎ against back base-surface 223₍ₐ₎. First and second supports 27₍ₐ₎ and 28₍ₐ₎ of each heat sink 20₍ₐ₎ are in substantially planar alignment with first and second side-fins 25₍ₐ₎ and 26₍ₐ₎, respectively. As seen in FIGS. 10 and 11, the flange hook is at 251₍ₐ₎ distal fin-edge of first side-fin 25₍ₐ₎.

Each heat sink 20₍ₐ₎ is a metal (preferably aluminum) extrusion with back base-surface 223₍ₐ₎ of heat sink 20₍ₐ₎ being substantially flat to facilitate heat transfer from LED-array module 19₍ₐ₎, which itself has a flat surface 191₍ₐ₎ against back-base surface 223₍ₐ₎. Each heat sink 20₍ₐ₎ also includes a lateral recess 21₍ₐ₎ at first base-side 221₍ₐ₎ and a lateral protrusion 29₍ₐ₎ at second base-side 222₍ₐ₎, recesses 21₍ₐ₎ and protrusions 29₍ₐ₎ being positioned and configured for mating engagement of protrusion 29₍ₐ₎ of one heat sink 20₍ₐ₎ with recess 21₍ₐ₎ of adjacent heat sink 20₍ₐ₎.

As best seen in FIGS. 1, 4, 5, 6, 10 and 11, first and second side-fins 25₍ₐ₎ and 26₍ₐ₎ are each a continuous wall extending along first and second base-sides 221₍ₐ₎ and 222₍ₐ₎, respectively. Inner-fins 24₍ₐ₎ are also each a continuous wall extending along base 22₍ₐ₎. Inner-fins 24₍ₐ₎ are substantially parallel to side-fins 25₍ₐ₎ and 26₍ₐ₎.

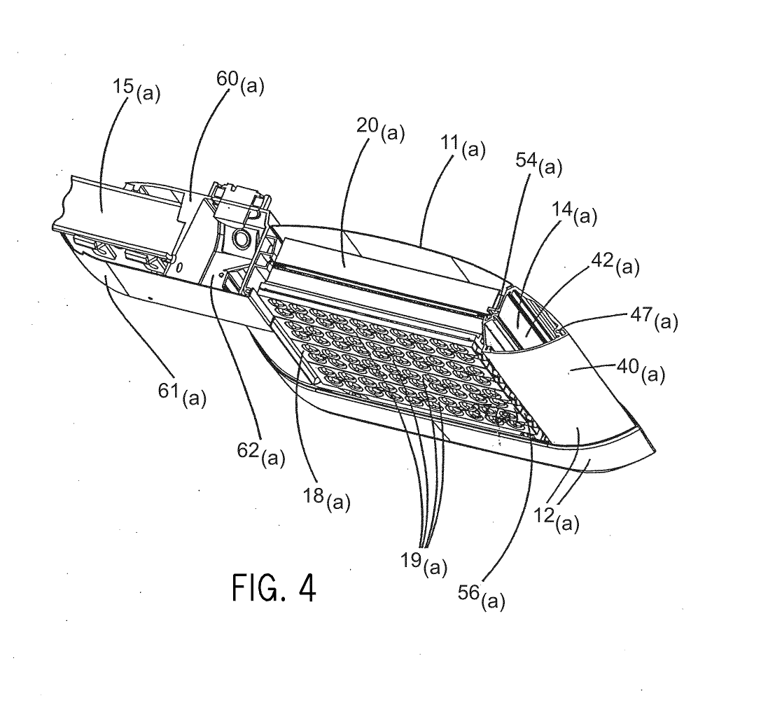

FIGS. 4 and 6 show an interlock of housing 12₍ₐ₎ to LED assembly 18₍ₐ₎. As best seen in FIGS. 10 and 11, in each heat sink 20₍ₐ₎ inner-fins 24₍ₐ₎ include two middle-fins 241₍ₐ₎ each of which includes a fin-end 242₍ₐ₎ forming a mounting hole 243₍ₐ₎. A coupler 52₍ₐ₎ in the form of a screw is engaged in mounting hole 243₍ₐ₎, and extends from heat sink 20₍ₐ₎ to terminate in a coupler-head 521₍ₐ₎. Housing 12₍ₐ₎ has a slotted cavity 54₍ₐ₎ which extends along, and is integrally formed with, each of border structures 40₍ₐ₎ forms the interlock by receiving and engaging coupler-heads 521₍ₐ₎ therein.

FIG. 2 illustrates a version of the invention which is LED lighting fixture 10B₍ₐ₎. In lighting fixture 10B₍ₐ₎, perimetrical structure 12₍ₐ₎ includes a pair of nose structures 40₍ₐ₎ configured for wall mounting and one frame structure 30₍ₐ₎ in substantially perpendicular relationship to each of the two nose structures 40₍ₐ₎.

The substantially rectangular lighting fixture 10A₍ₐ₎ which is best illustrated in FIGS. 1, 3 and 4, perimetrical structure 12₍ₐ₎ includes a pair of opposed frame structures 30₍ₐ₎ and a pair of opposed first nose structure 40₍ₐ₎ and second nose structure 41₍ₐ₎. The second nose structure 41₍ₐ₎ has two spaced sub-portions 41A₍ₐ₎ and 41B₍ₐ₎ with a gap 412₍ₐ₎ therebetween. Sub-portions 41A₍ₐ₎ and 41B₍ₐ₎ each include all of the nose-portion elements. Gap 412₍ₐ₎ accommodates a pole-mounting assembly 60₍ₐ₎, one embodiment of which is shown in FIGS. 1, 3, 4 and 12, that is secured to LED assembly 18₍ₐ₎ between nose sub-portions 41A₍ₐ₎ and 41B₍ₐ₎.

Pole-mounting assembly 60₍ₐ₎ includes a pole-attachment portion 61₍ₐ₎ that receives and secures a pole 15₍ₐ₎ and a substantially air/water-tight section 62₍ₐ₎ that encloses electrical connections and has wire-apertures 64₍ₐ₎. Each wire-aperture 64₍ₐ₎ communicates with the nose-portion 42₍ₐ₎ chamber of a respective one of nose-structure sub-portions 41A₍ₐ₎ and 41B₍ₐ₎. Nose-structure sub-portions 41A₍ₐ₎ and 41B₍ₐ₎ are in air/water-tight engagement with air/water-tight section 62₍ₐ₎ of pole-mounting assembly 60₍ₐ₎. Air/water-tight section 62₍ₐ₎ includes grooves 621₍ₐ₎ on its opposite sides 622₍ₐ₎; grooves 621₍ₐ₎ are configured for mating engagement with end edges 413₍ₐ₎ of nose-structure sub-portions 41A₍ₐ₎ and 41B₍ₐ₎.

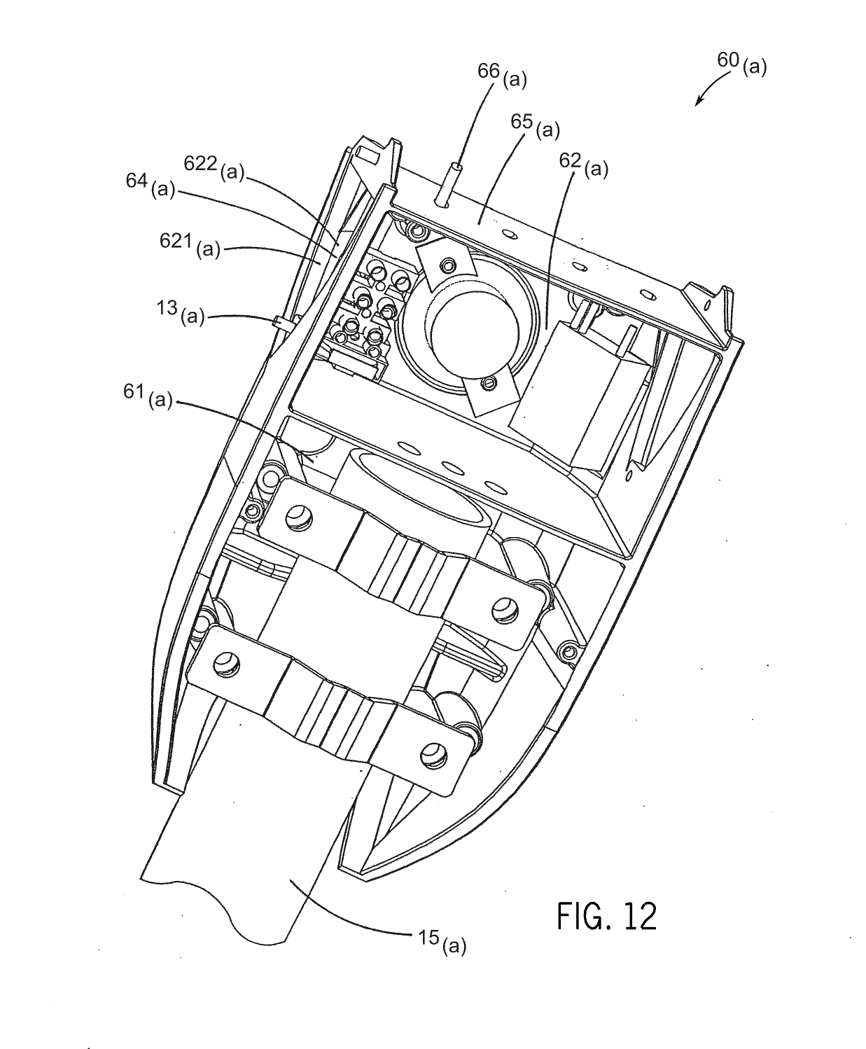

As best seen in FIG. 12, pole-mounting assembly 60₍ₐ₎ has a mounting plate 65₍ₐ₎ abutting LED assembly 18₍ₐ₎, and fastener/couplers 66₍ₐ₎ extend from mounting plate 65₍ₐ₎ into engagement with mounting hole 243₍ₐ₎ of middle-fins 241₍ₐ₎.

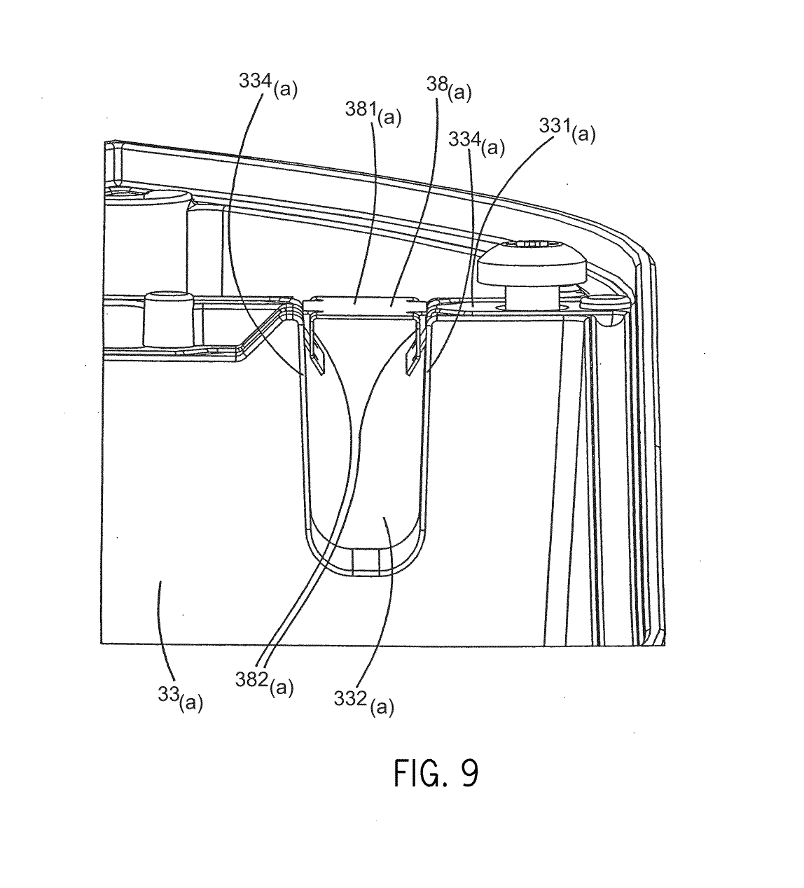

FIGS. 8 and 9 show that frame-portion 32₍ₐ₎ of chamber 14₍ₐ₎ has a chamber-divider 33₍ₐ₎ across chamber 32₍ₐ₎ that divides frame-portion 32₍ₐ₎ of chamber 14₍ₐ₎ into an end part 321₍ₐ₎ and a main part 322₍ₐ₎, which encloses electronic LED driver(s) 16₍ₐ₎. Chamber-divider 33₍ₐ₎ has a divider-edge 331₍ₐ₎. Chamber-divider 33₍ₐ₎ includes a substantially air/water-tight wire-passage therethrough in the form of a notch 332₍ₐ₎ having spaced notch-wall ends 334₍ₐ₎ that terminate at divider-edge 331₍ₐ₎. A notch-bridge 38₍ₐ₎ spans notch 332₍ₐ₎ to maintain the air/water-tight condition of chamber 32₍ₐ₎. Notch-bridge 38₍ₐ₎ includes a bridge-portion 381₍ₐ₎ and a pair of gripping-portions 382₍ₐ₎ which are configured for spring-grip attachment to notch-wall ends 334₍ₐ₎. A removable cover-plate 31₍ₐ₎ seals main part 322₍ₐ₎ of frame-portion 32₍ₐ₎ of chamber 14₍ₐ₎ in substantially air/water-tight condition.

FIGS. 2-6 show that inventive LED lighting fixtures 10₍ₐ₎ include a protective cover 11₍ₐ₎ that extends over LED assembly 18₍ₐ₎ and is secured with respect to housing 12₍ₐ₎. Protective cover 11₍ₐ₎ has perforations 111₍ₐ₎ to permit air and water flow therethrough for access to and from LED assembly 18₍ₐ₎.

As best seen in FIGS. 5 and 6, LED lighting fixture 10₍ₐ₎ has a venting gap 56₍ₐ₎ between housing 12₍ₐ₎ and LED assembly 18₍ₐ₎, to permit air and water flow from heat sink 20₍ₐ₎. Venting gap 56₍ₐ₎ is formed by the interlock of housing 12₍ₐ₎ to LED assembly 18₍ₐ₎ or is a space along outer side-fins of the LED assembly.

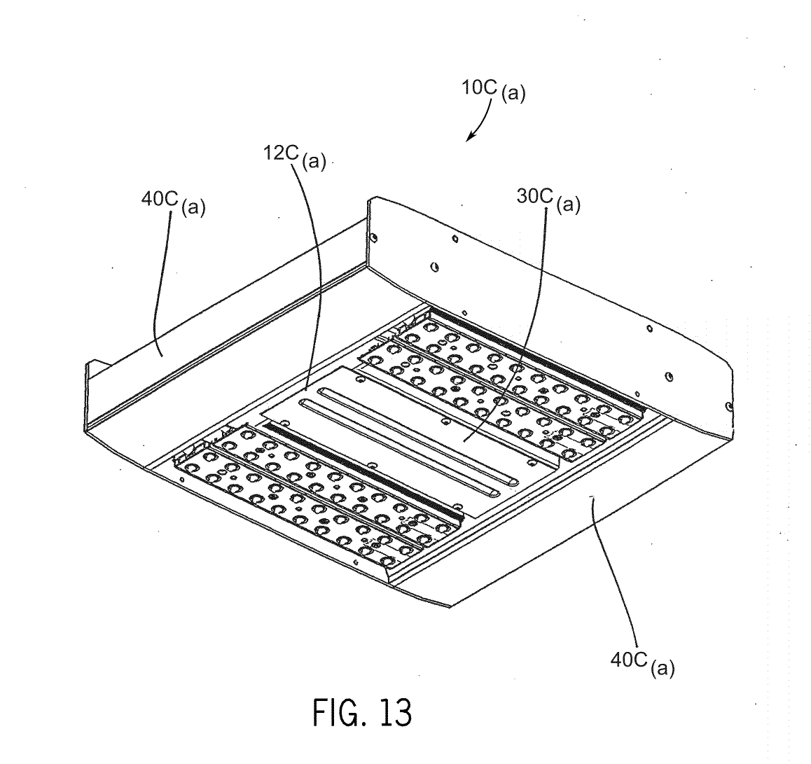

FIG. 13 shows an embodiment of the inventive lighting fixture 10C₍ₐ₎ in which frame structure 30C₍ₐ₎ is a sole frame structure, and housing 12C₍ₐ₎ is a substantially H-shaped structure with sole frame structure 30C₍ₐ₎ secured between mid-length positions of the pair of opposed border structures 40C₍ₐ₎.

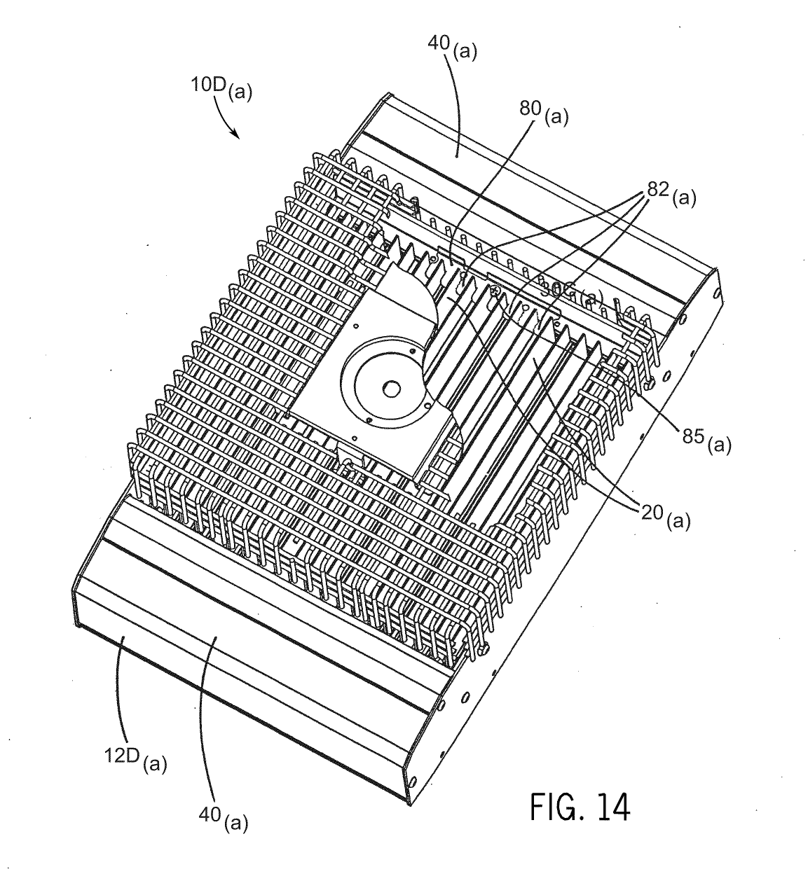

FIG. 14 shows another embodiment of the inventive LED lighting fixture 10D₍ₐ₎ with housing 12D₍ₐ₎ formed by a pair of opposed border structures 40₍ₐ₎ and LED assembly 18₍ₐ₎ secured between border structures 40₍ₐ₎. Lighting fixture 10D₍ₐ₎, as shown on FIG. 14, includes a restraining-bracket 80₍ₐ₎ secured to housing 12D₍ₐ₎ by screws 85₍ₐ₎ through screw-holes 87₍ₐ₎. Bracket 80₍ₐ₎ has a plurality of projections 82₍ₐ₎ each of which extends between adjacent fins of two of heat sinks 20₍ₐ₎.

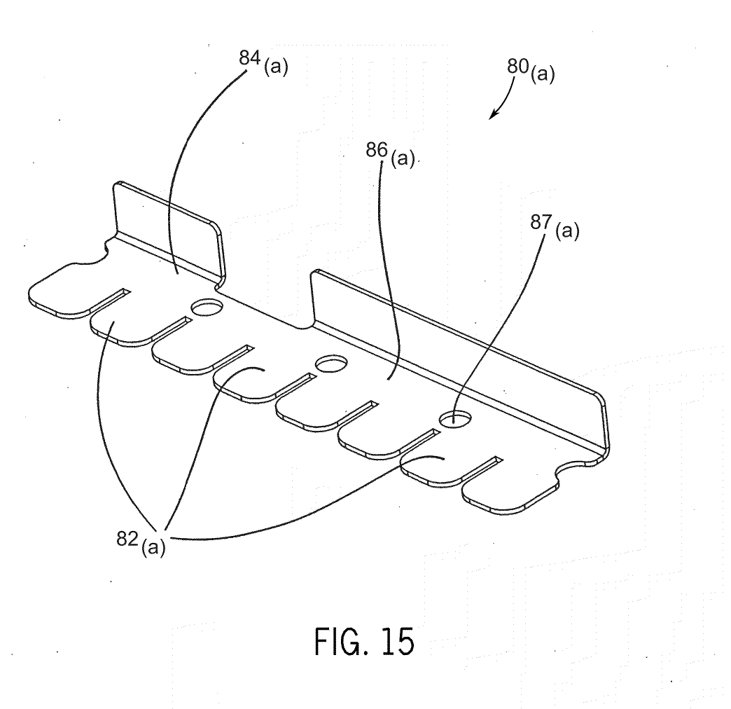

Restraining bracket 80₍ₐ₎, best shown on FIG. 15, is a comb-like structure with an elongated body 84₍ₐ₎ including a spine-portion 86₍ₐ₎ from which the plurality of projections 82₍ₐ₎ extend. Restraining-bracket 80₍ₐ₎ is configured and dimensioned for elongated body 84₍ₐ₎ to be fixedly secured to housing 12₍ₐ₎ and for projections 82₍ₐ₎ to snugly fit in spaces between adjacent heat-sink fins.

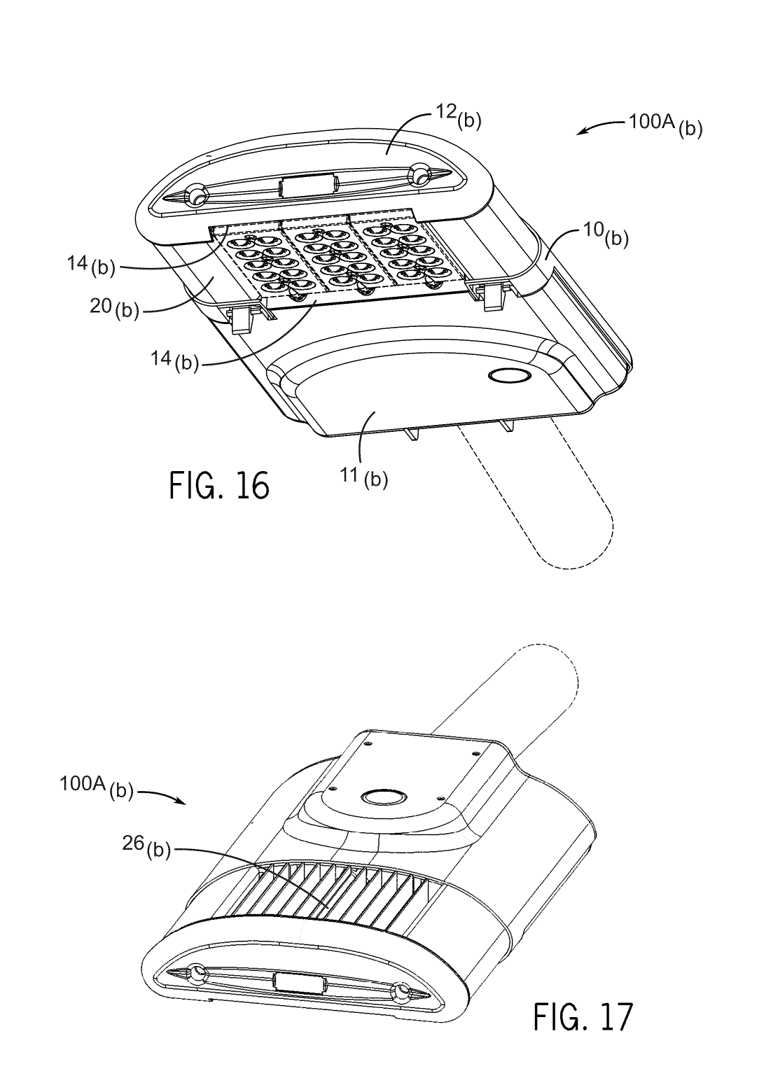

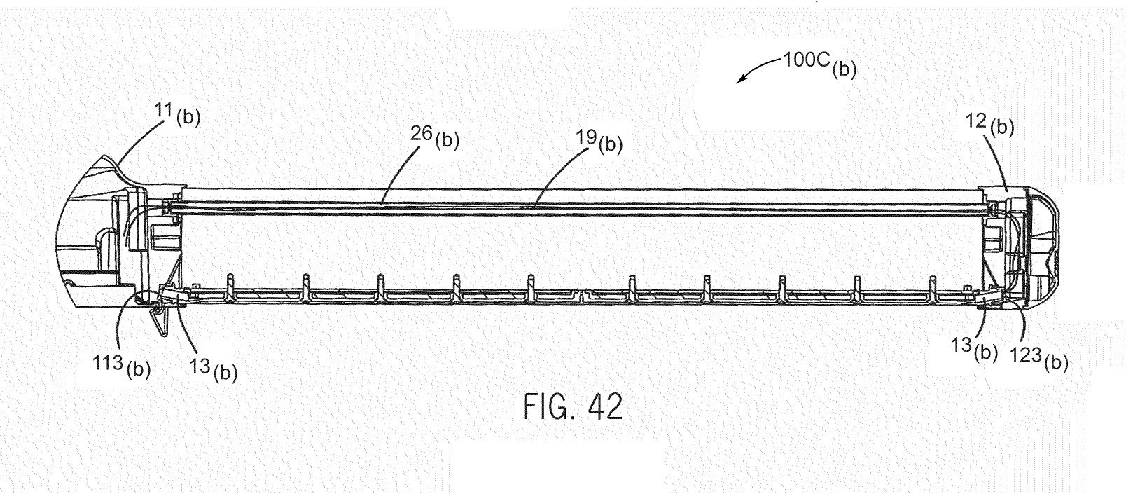

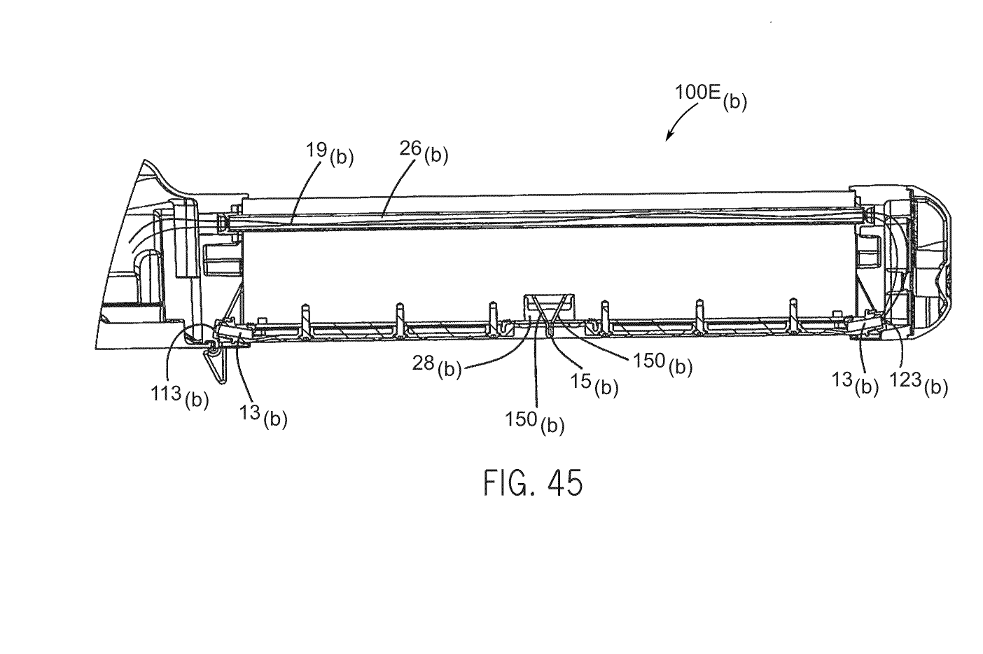

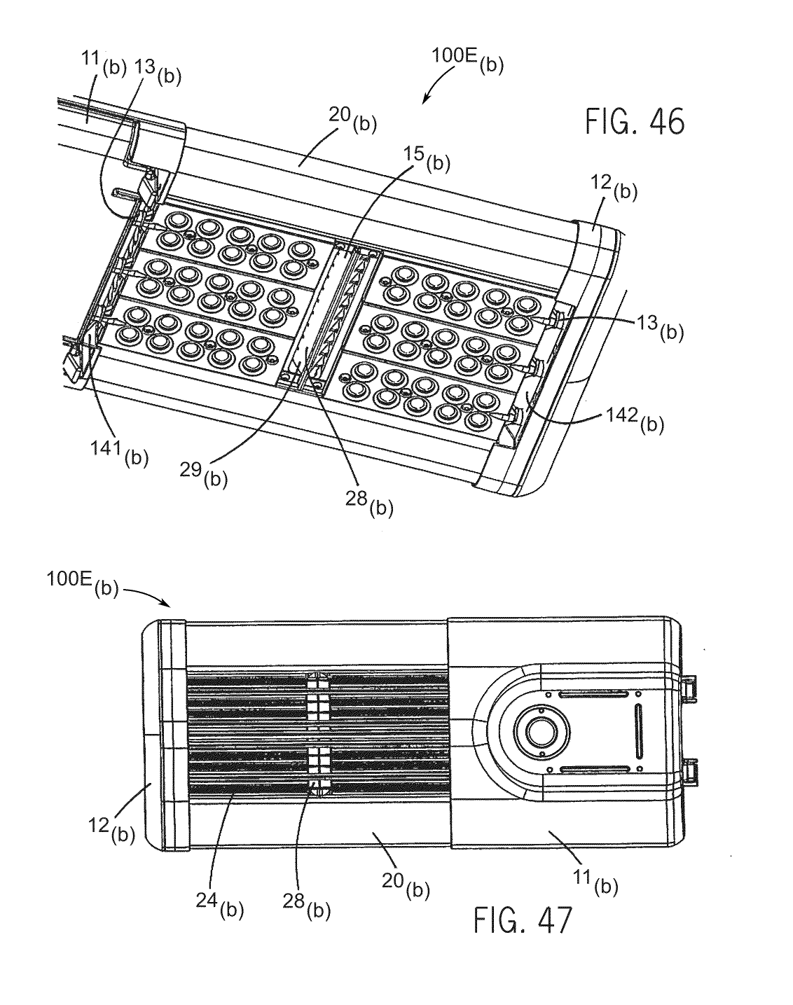

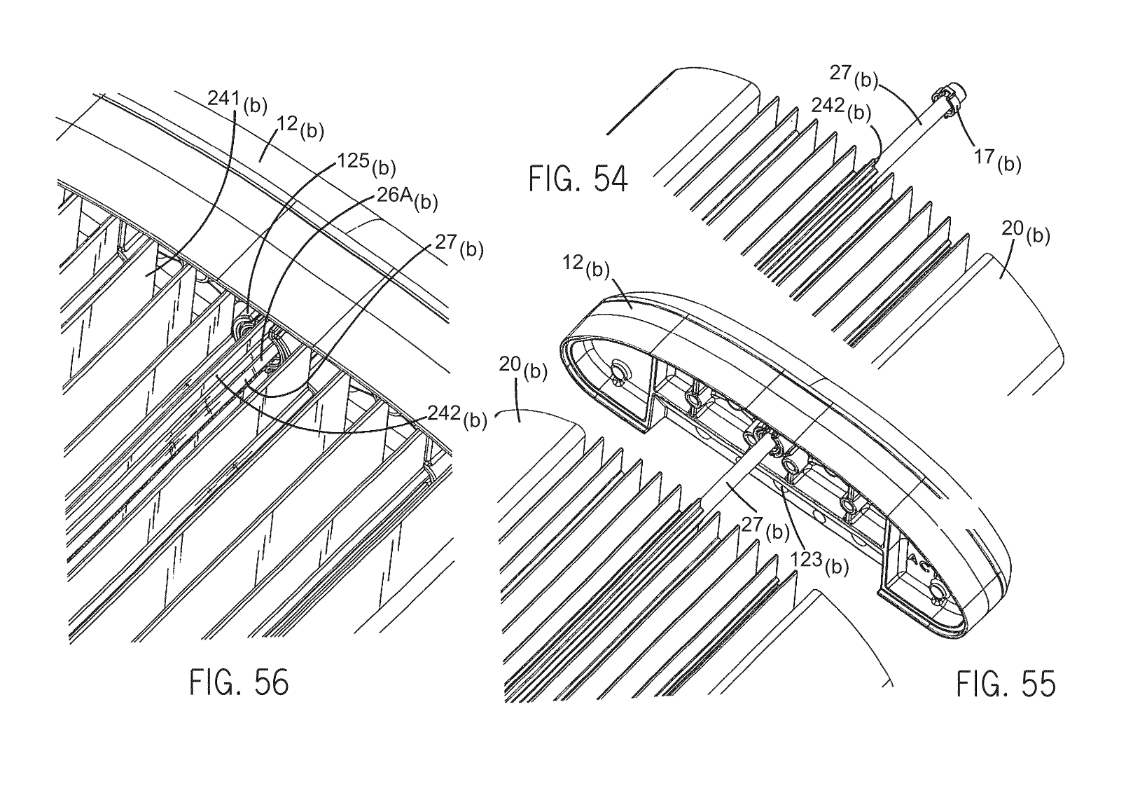

FIGS. 16-56 illustrate preferred embodiments of the LED light fixture 100A_{(b)}-100E_{(b)} in accordance with this invention. Common or similar parts are given same numbers in the drawings of all embodiments, and the floodlight fixtures are often referred to by the numeral 100_{(b)}, without the A or E lettering used in the drawings, and in the singular for convenience.

Floodlight fixture 100_{(b)} includes a housing 10_{(b)} that has a first end-portion 11_{(b)} and a second end-portion 12_{(b)} and a single-piece extrusion 20_{(b)} that has first and second ends 201_{(b)} and 202_{(b)}, respectively, with first and second end-portions 11_{(b)} and 12_{(b)} secured with respect to first and second ends 201_{(b)} and 202_{(b)}, respectively. Single-piece extrusion 20_{(b)} includes a substantially planar base 22_{(b)} extending between first and second ends 201_{(b)} and 202_{(b)}. Base 22_{(b)} has an LED-adjacent surface 220_{(b)} and an opposite surface 221_{(b)}. Single-piece extrusion 20_{(b)} further has a heat-dissipating section 24_{(b)} having heat-dissipating surfaces 241_{(b)} extending from opposite surface 221_{(b)}. Light fixture 100_{(b)} further includes an LED arrangement 30_{(b)} mounted to LED-adjacent surface 220_{(b)} in non-water/air-tight condition with respect to housing 10_{(b)}. (See FIGS. 16, 18, 22, 27-46) In these embodiments, second end portion 12_{(b)} forms an endcap 120_{(b)}.

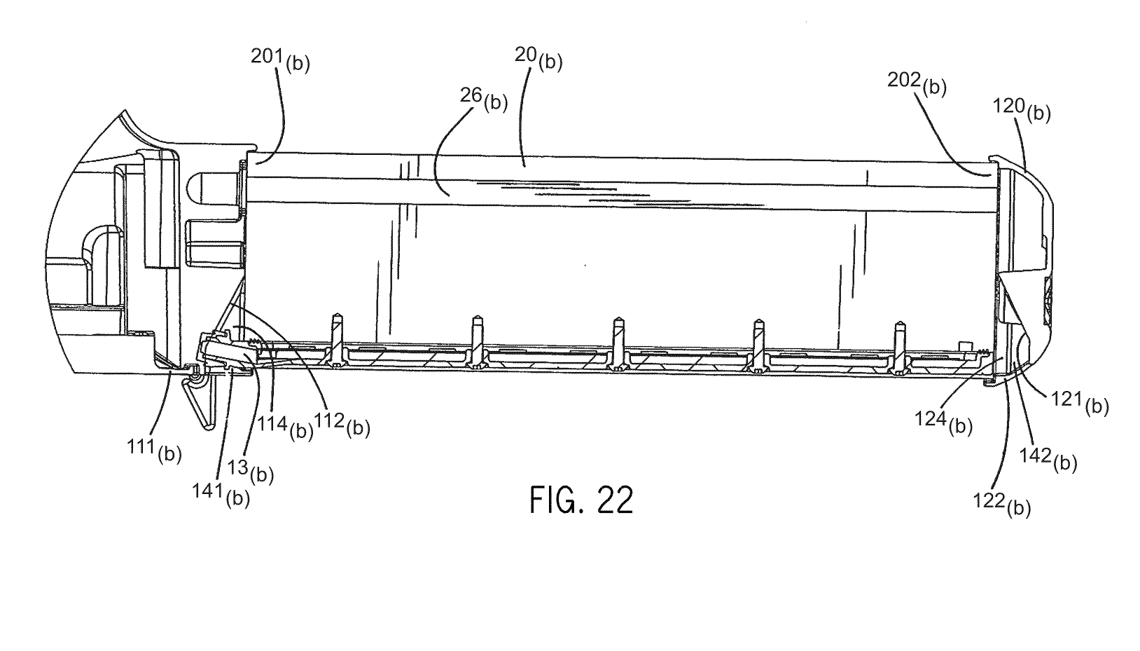

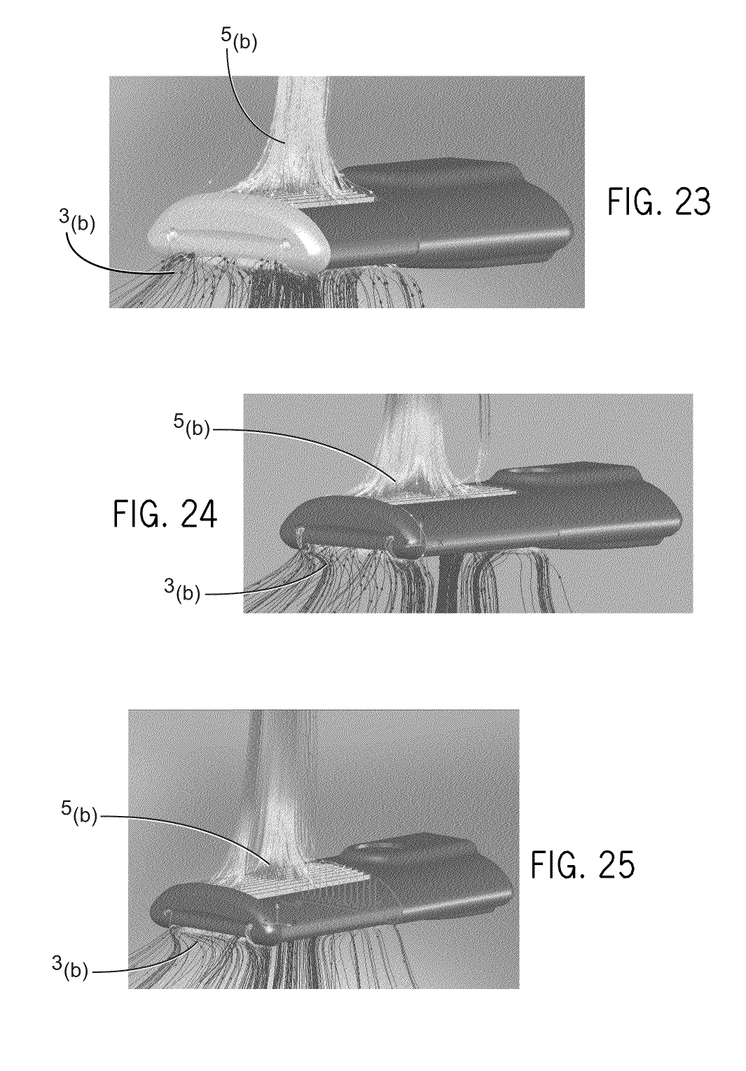

As best seen at least in FIGS. 22, 27, 29, 42 and 45, housing 10_{(b)} forms a venting gap 14_{(b)} between each end-portion 11_{(b)} and 12_{(b)} and single-piece extrusion 20_{(b)} to provide ingress of cool air 3_{(b)} to and along the heat-dissipating surfaces 241_{(b)} by upward flow of heated air 5_{(b)} therefrom. FIGS. 23-25 illustrate the flow of air through heat-dissipating section 24_{(b)} of extrusion 20_{(b)}. The upward flow of heated air 5_{(b)} draws cool air 3_{(b)} into heat-dissipating section 24_{(b)} and along heat-dissipating surfaces 241_{(b)} without any aid from mechanical devices such as fans or the like.

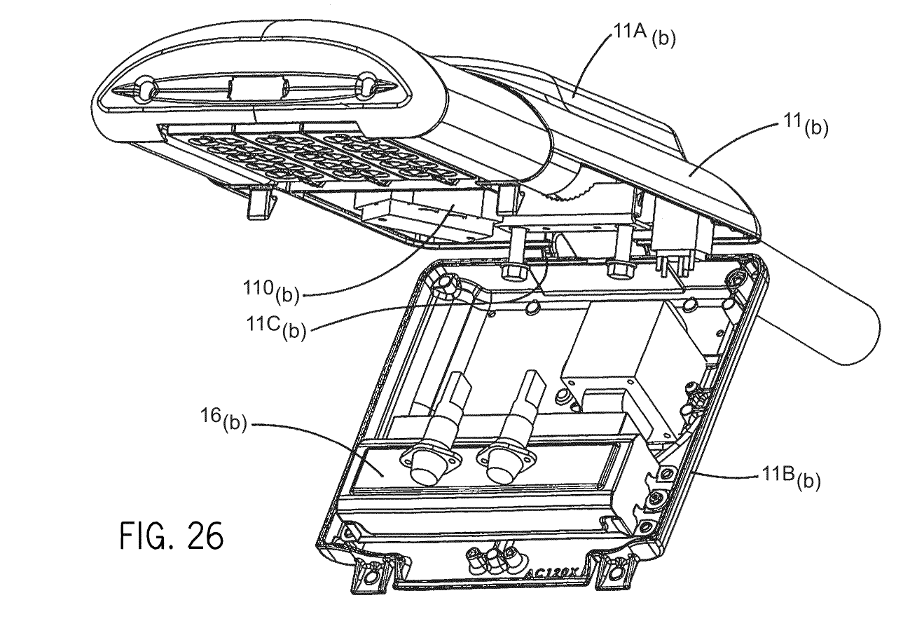

As seen in FIG. 26, first end-portion 11_{(b)} forms a water/air-tight chamber 110_{(b)} enclosing an electronic LED driver 16_{(b)} and/or other electronic and electrical components needed for LED light fixtures. First end-portion 11_{(b)} has upper and lower portions 11A_{(b)} and 11B_{(b)} which are hinged together by a hinge 11C_{(b)}. This hinging arrangement facilitates easy opening of first end-portion 11_{(b)} by the downward swinging of lower portion 11B_{(b)}. LED driver 16_{(b)} is mounted on lower portion 11B_{(b)} for easy maintenance.

First end-portion 11_{(b)} at first end 201_{(b)} of extrusion 20_{(b)} has a lower surface 111_{(b)} and an extrusion-adjacent end surface 112_{(b)}. As best seen in FIGS. 22, 42 and 45, extrusion-adjacent end surface 112_{(b)} and lower surface 111_{(b)} form a first recess 114_{(b)} which extends away from first end 201_{(b)} of extrusion 20_{(b)} and defines a first venting gap 141_{(b)}. End surface 112_{(b)} along first recess 114_{(b)} is tapered such that first venting gap 141_{(b)} is upwardly narrowed, thereby directing and accelerating the air flow along heat-dissipating surfaces 241_{(b)}.

Endcap 120_{(b)} at second end 202_{(b)} of extrusion 20_{(b)} has an inner surface 121_{(b)} and a lower edge-portion 122_{(b)}. Inner surface 121_{(b)} and lower edge-portion 122_{(b)} of endcap 120_{(b)} form a second recess 124_{(b)} which extends away from second end 202_{(b)} of extrusion 20_{(b)} and defines a second venting gap 142_{(b)}. Inner surface 121_{(b)} along second recess 142_{(b)} is tapered such that second venting gap 142_{(b)} is upwardly narrowed, thereby directing and accelerating the air flow along heat-dissipating surfaces 241_{(b)}.

As best seen in FIGS. 16, 18, 22 and 26-46, LED arrangement 30_{(b)} is secured outside water/air-tight chamber 110_{(b)} and is free from fixture enclosures. LED arrangement 30_{(b)} includes a plurality of LED-array modules 31_{(b)} or 32_{(b)}. As further seen in these FIGURES, LED-array modules 31_{(b)} and 32_{(b)} are substantially rectangular elongate modules.

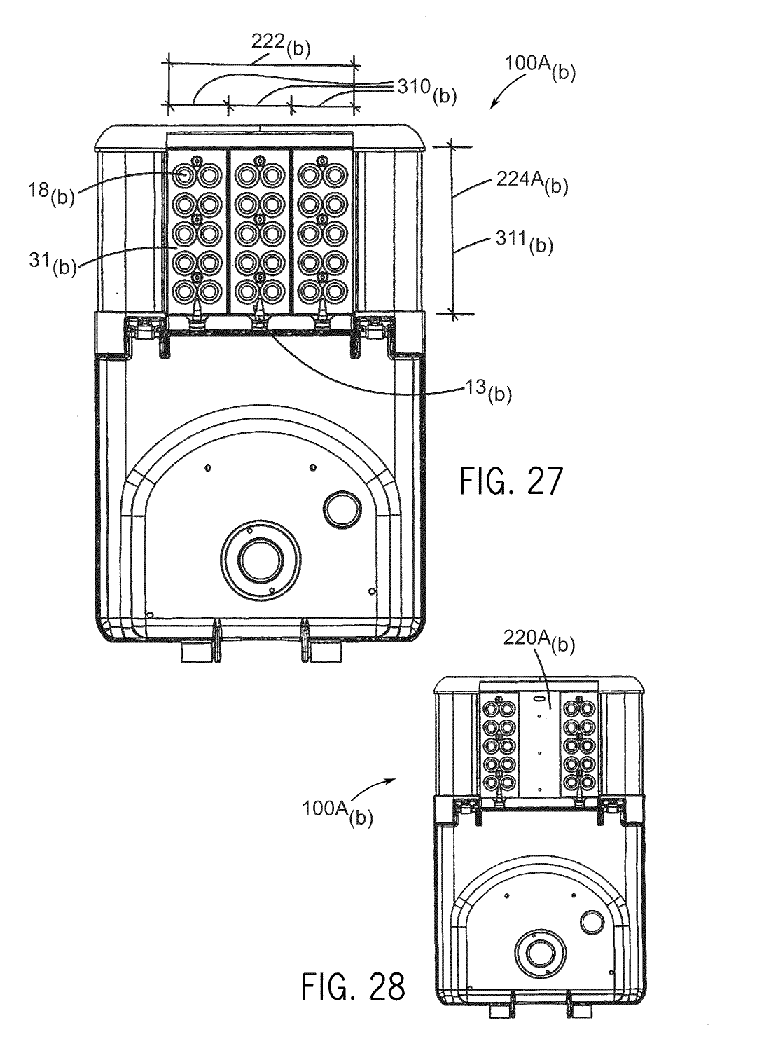

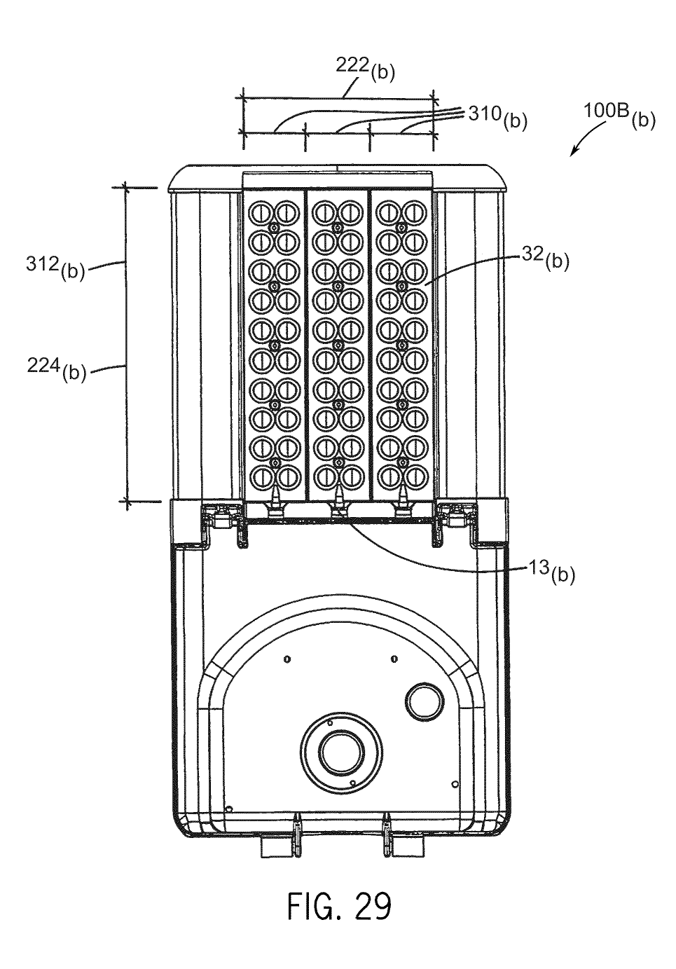

LED-array modules 31_{(b)} and 32_{(b)} each have a common module-width 310_{(b)} (see FIGS. 27-46). LED-adjacent surface 220A_{(b)} has a width 222_{(b)} which is approximately the multiple of the maximum number of LED-array modules mountable in side-by-side relationship thereon by common module-width 310_{(b)}. FIGS. 28, 30 and 31 show alternative arrangements of LED-array modules 31_{(b)} on LED-adjacent surface 220_{(b)} of same width 222_{(b)} as shown in FIGS. 27 and 29.

LED-array modules further have predetermined module-lengths associated with the numbers of LEDs 18_{(b)} on modules 31_{(b)} or 32_{(b)}.

FIGS. 16 and 17 best show LED light fixture 100A_{(b)} with modules 31_{(b)} each having ten LEDs 18_{(b)} thereon determining a module-length 311_{(b)}. Fixture 100A_{(b)} has LED-adjacent surface 220A_{(b)} with a length 224A_{(b)} which is approximately a dimension of predetermined module-lengths 311_{(b)}.

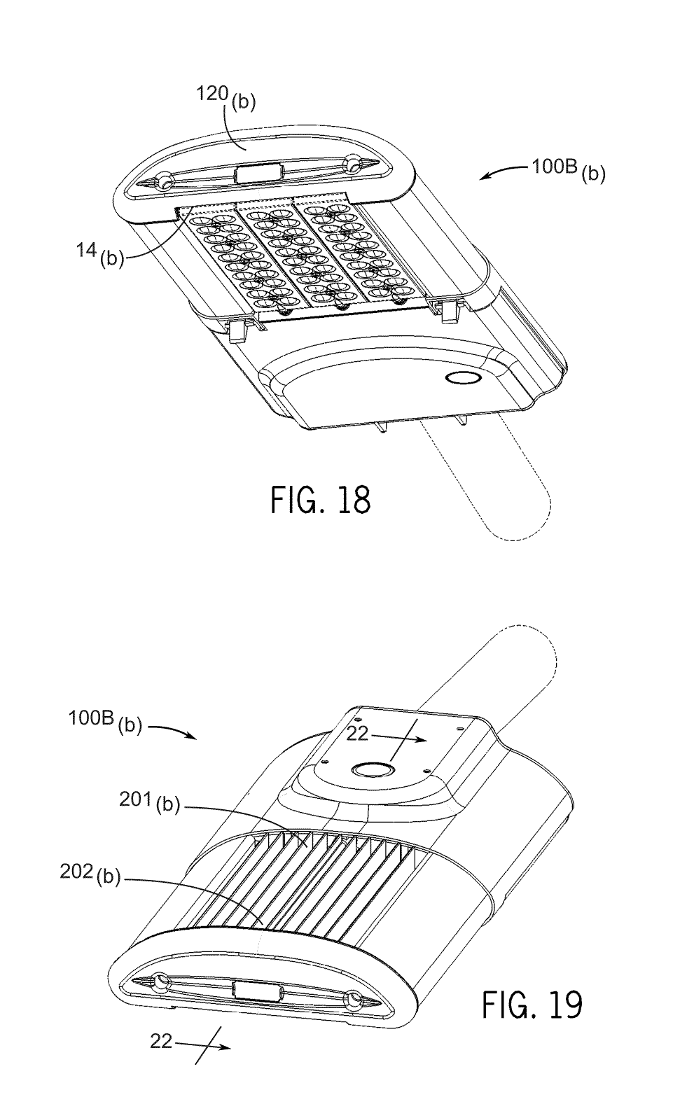

FIGS. 18 and 29 best show LED light fixture 100B_{(b)} with modules 32_{(b)} each having twenty LEDs 18_{(b)} thereon determining a module-length 312_{(b)}. Fixture 100B_{(b)} has LED-adjacent surface 220B_{(b)} with a length 224B_{(b)} which is approximately a dimension of predetermined module-lengths 312_{(b)}.

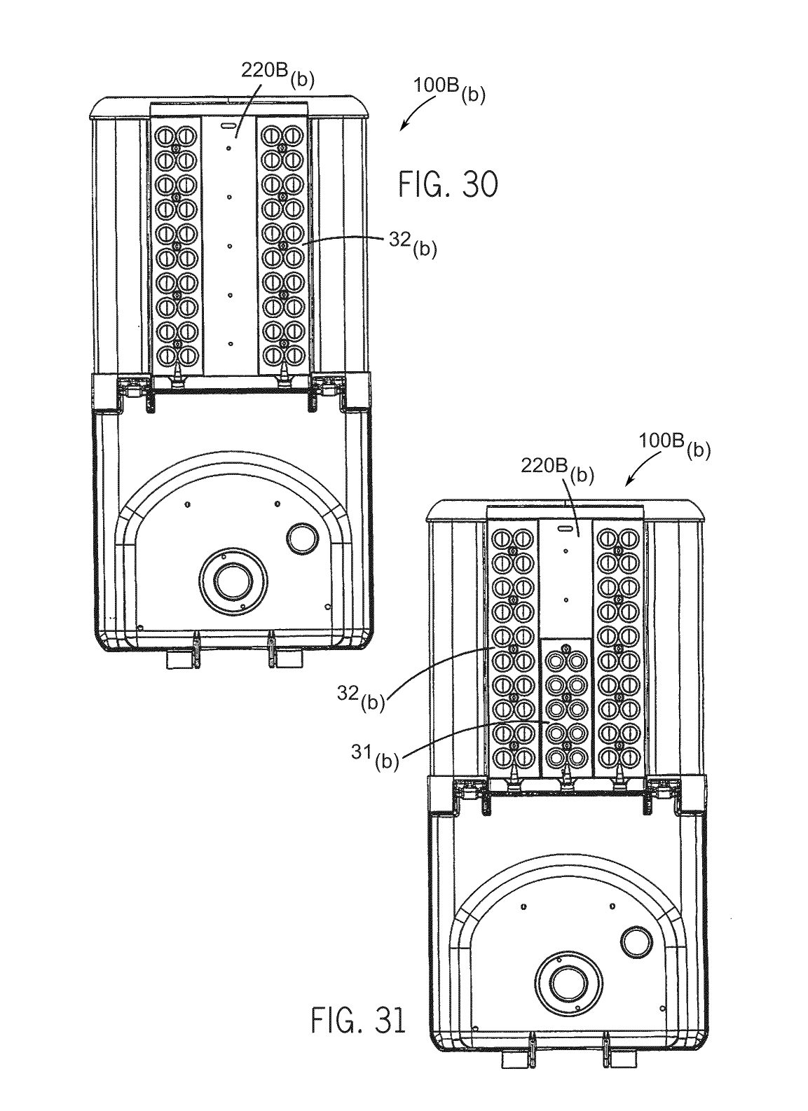

FIGS. 28 and 30 illustrate how, based on illumination requirements, LED lighting fixture 100_{(b)} allows for a variation in a number of modules 31_{(b)} or 32_{(b)} mounted on LED-adjacent surface 220_{(b)}. FIG. 31 illustrates a combination of different-length modules 31_{(b)} and 32_{(b)} on LED-adjacent surface 220B_{(b)}.

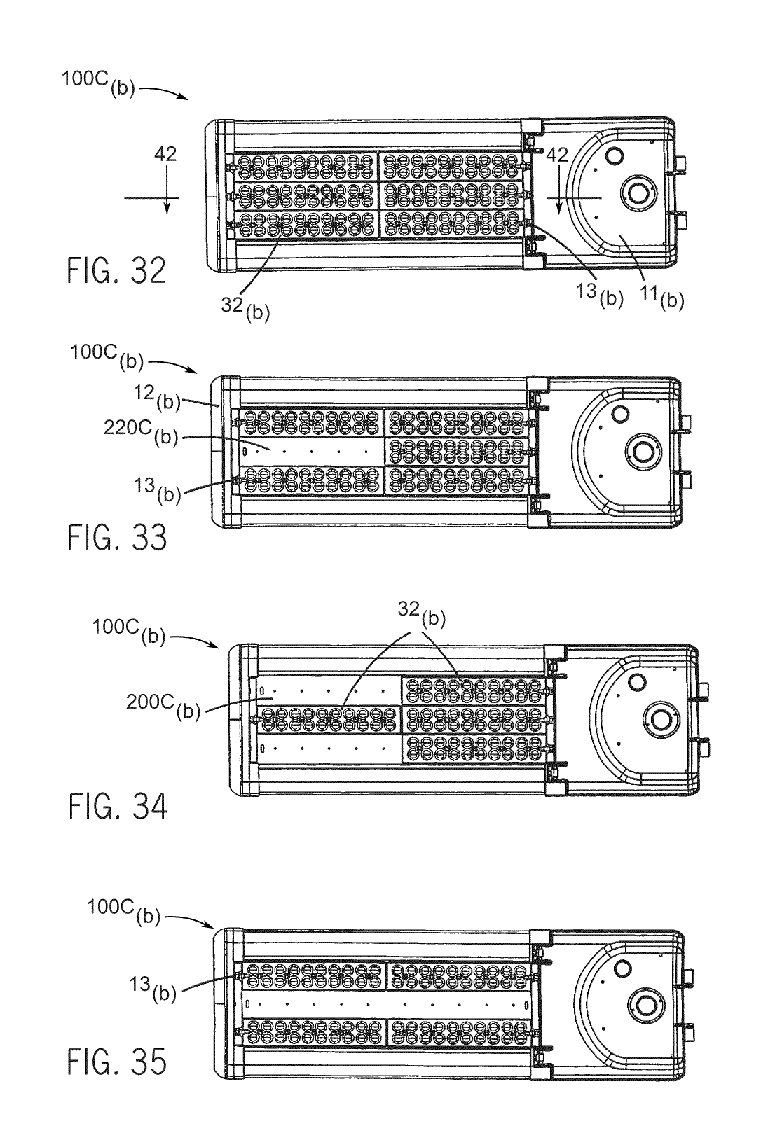

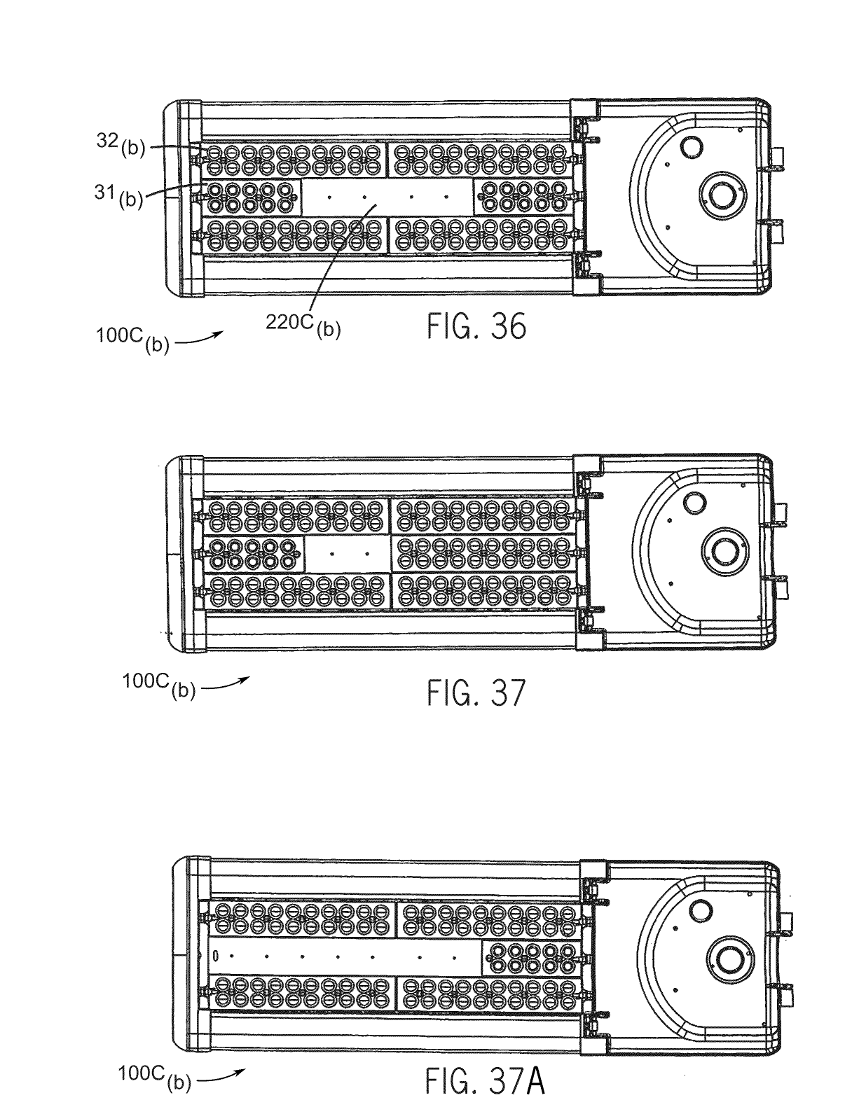

FIGS. 32-35 show an LED light fixture 100C_{(b)} with modules 32_{(b)} each having twenty LEDs 18_{(b)} thereon determining a module-length 312_{(b)}. Fixture 100C_{(b)} has LED-adjacent surface 220C_{(b)} with a length 224C_{(b)} which is approximately a double of module-length 312_{(b)} of each of LED-array modules 32_{(b)}. FIGS. 32-35 show alternative arrangements of LED-array modules 32_{(b)} on LED-adjacent surface 220C_{(b)} of same width 222_{(b)}. FIGS. 36, 37 and 37A show a combination of different-length modules 31_{(b)} and 32_{(b)} on LED-adjacent surface 220C_{(b)}. Such arrangement allows for providing a reduced illumination intensity by reducing a number of LED modules 32_{(b)} or using modules 31_{(b)} with less LEDs.

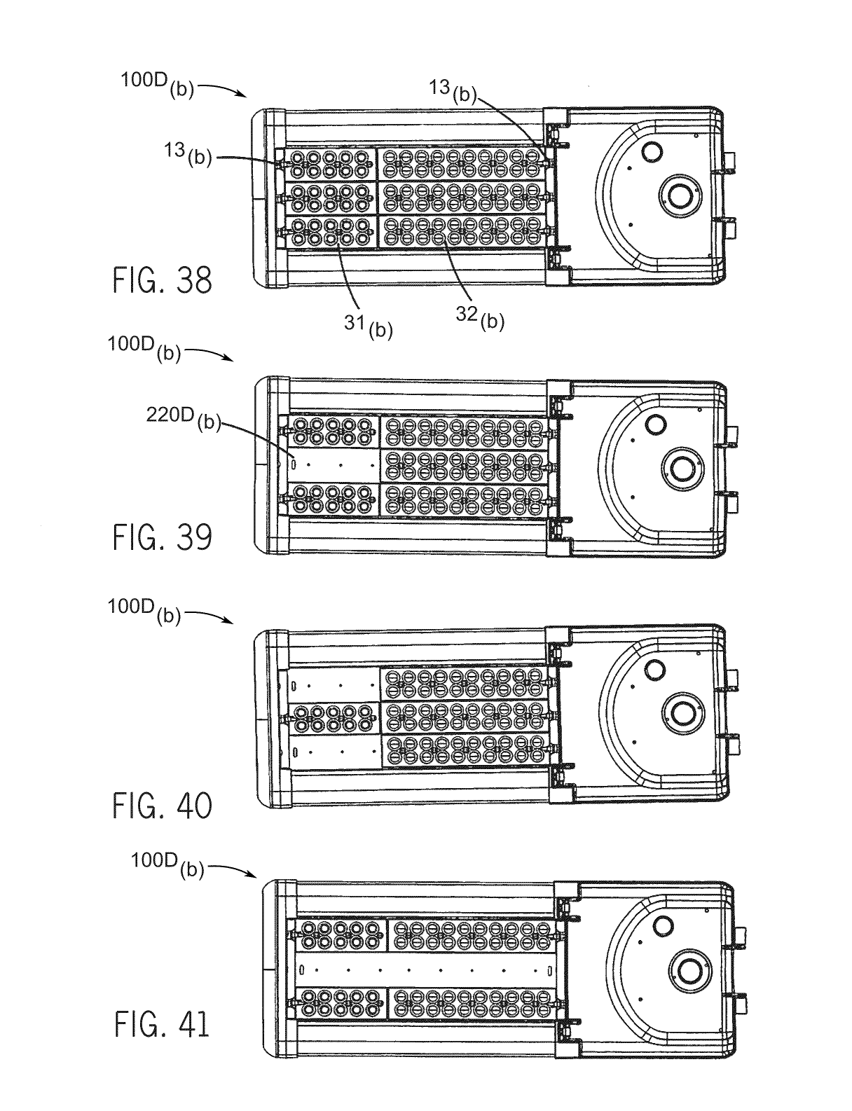

FIGS. 38-41 show an LED light fixture 100D_{(b)} with LED-adjacent surface 220D_{(b)} supporting a plurality of modules of different module-lengths—both modules 31_{(b)} (ten LEDs 18_{(b)}) with module-length 311_{(b)} and modules 32_{(b)} (twenty LEDs 18_{(b)}) with module-length 312_{(b)}. Fixture 100D_{(b)} has LED-adjacent surface 220D_{(b)} with a length 224D_{(b)} which is approximately a sum of module-lengths 311_{(b)} and 312_{(b)} of pairs of LED-array modules 31_{(b)} and 32_{(b)} in end-to-end relationship to one another. FIGS. 38-41 show alternative arrangements of LED-array modules 31_{(b)} and 32_{(b)} on LED-adjacent surface 220D_{(b)}.

FIGS. 32-41 illustrate fixtures 100C_{(b)} and 100D_{(b)} with the plurality of LED-array modules 31_{(b)} and 32_{(b)} in end-to-end relationship to one another. In such arrangement, the modules are positioned as modules 33_{(b)} which are proximal to first end-portion 11_{(b)}, and modules 34_{(b)} which are distal from first end-portion 11_{(b)}. It can be seen in FIGS. 22, 42 and 45, that modules 31_{(b)} and 32_{(b)} include wireways 13_{(b)} that connect to water/air-tight wire-accesses 113_{(b)} and 123_{(b)} of first and second end-portions 11_{(b)} and 12_{(b)}, respectively.

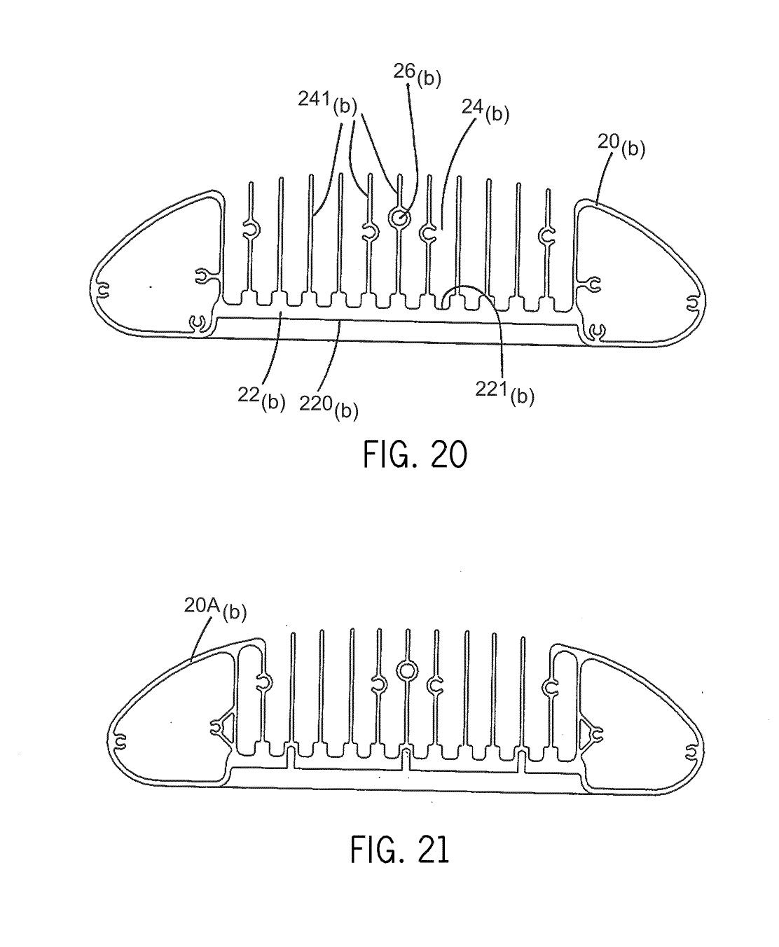

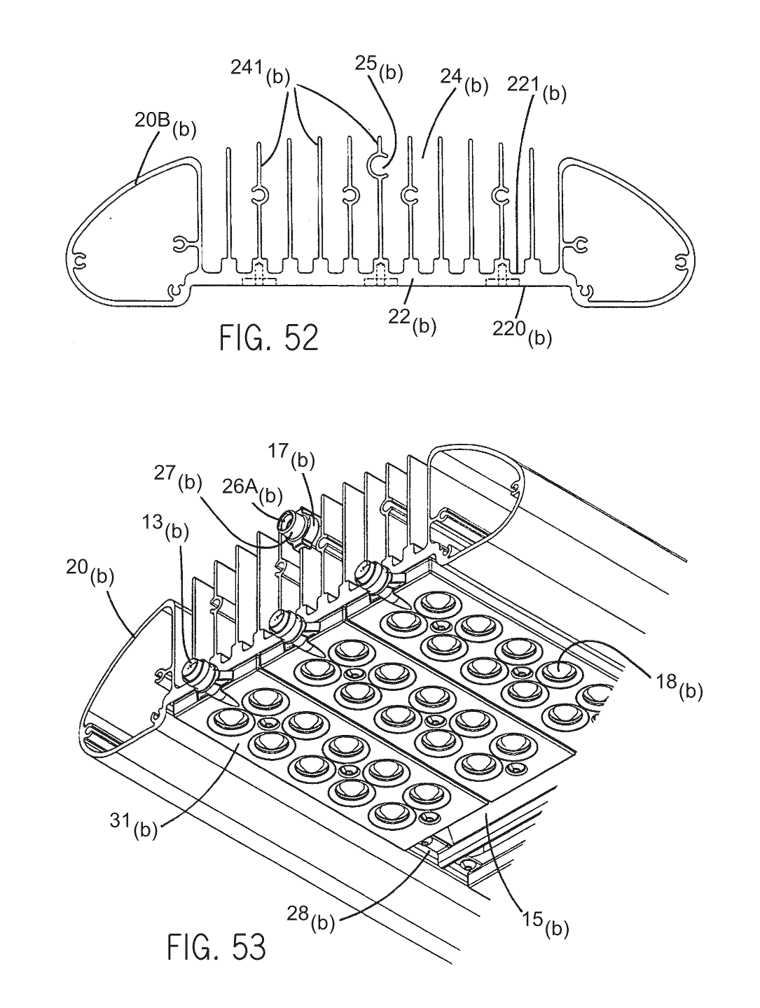

Extrusion 20_{(b)} includes a water/air-tight wireway 26_{(b)} for receiving wires 19_{(b)} from distal LED-array modules 34_{(b)}. Wireway 26_{(b)} is connected to housing 10_{(b)} through wire-accesses 115_{(b)} and 125_{(b)} of first and second end-portions 11_{(b)} and 12_{(b)}, respectively. Wires 19_{(b)} from distal modules 34_{(b)} reach water/air-tight chamber 110_{(b)} of first end-portion 11_{(b)} through wireway 26_{(b)} connected to water/air-tight wire-access 115_{(b)}. Wireway 26_{(b)} extends along and through heat-dissipating section 24_{(b)} and is spaced from base 22_{(b)}. Heat-dissipating section 24_{(b)} includes parallel fins 242_{(b)} along the lengths of single-piece extrusion 20_{(b)}. FIGS. 20 and 21 illustrate wireway 26_{(b)} as formed of and along fin 242_{(b)}. Fin 242_{(b)} is a middle fin positioned at the longitudinal axis of extrusion 20_{(b)}. However, wireway 26_{(b)} may be formed along any other fin. Such choice depends on the fixture configuration and is in no way limited to the shown embodiments. Wireway 26_{(b)} may be positioned along fin 242_{(b)} at any distance from base 22_{(b)} that provides safe temperatures for wires 19_{(b)}. It should, therefore, be appreciated that wireway 26_{(b)} may be positioned at a tip of fin 242_{(b)} with the farthest distance from base 22_{(b)}. Alternatively, if temperature characteristics allow, wireway 26_{(b)} may be positioned near the middle of fin 242_{(b)} and closer to base 22_{(b)}. FIG. 53 shows wireway 26A_{(b)} as an enclosed tube 27_{(b)} secured with respect to fin 242_{(b)}. As can be seen in FIGS. 52 and 54-56, fin 242_{(b)} forms an extruded retention channel 25_{(b)} securely retaining wireway tube 27_{(b)} therein. Wireway 26A_{(b)} may have a jacketed cord or rigid tube which is made of aluminum or other suitable material. As best seen in FIG. 52, extruded retention channel 25_{(b)} has an open “C” shape with an opening being smaller than the largest inner diameter. When the jacketed cord is secured with respect to fin 242_{(b)} by snap fitting or the rigid tube is slid inside retention channel 25_{(b)}, retention channel 25_{(b)} securely holds wireway tube 27_{(b)}.

Wire-accesses 115_{(b)}, 125_{(b)} and wireway 26_{(b)} provide small surfaces between water/air-tight chamber and non-water/air-tight environment. Such small surfaces are insulated with sealing gaskets 17_{(b)} thereabout. In inventive LED light fixture 100_{(b)}, the mounting of single-piece extrusion 20_{(b)} with respect to end-portions 11_{(b)} and 12_{(b)} provides sufficient pressure on sealing gaskets 17_{(b)} such that no additional seal, silicon or the like, is necessary.

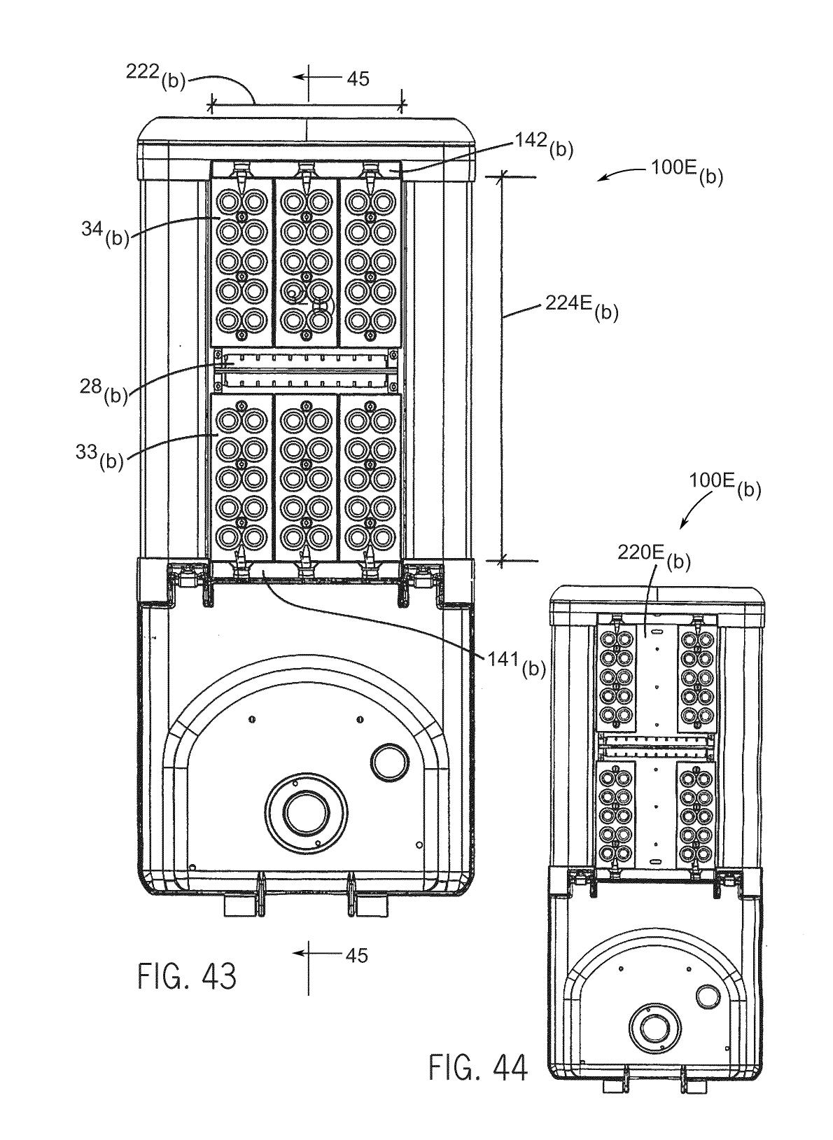

FIGS. 43-47 show LED light fixture 100E_{(b)} in which single-piece extrusion 20E_{(b)} has a venting aperture 28_{(b)} therethrough to provide ingress of cool-air 3_{(b)} to and along heat-dissipating surfaces 241_{(b} by upward flow of heated air 5_{(b)} from surfaces 241_{(b)}. Venting aperture 28_{(b)}, as shown in FIGS. 43, 44, 46 and 47, is an elongate aperture across a majority of the width of base 22_{(b)}. FIGS. 43-46 further show a deflector member 15_{(b)} secured to base 22_{(b)} along elongate aperture 28_{(b)}. Deflector member 15_{(b)} has a pair of oppositely-facing beveled deflector surfaces 150_{(b)} oriented to direct and accelerate air flow in opposite directions along heat-dissipating surfaces 241_{(b)}.

In LED light fixture 100E_{(b)}, as shown in FIGS. 43-47, the plurality of LED-array modules 31_{(b)} are in lengthwise relationship to one another. Venting aperture 28_{(b)} is distal from first and second ends 201_{(b)} and 202_{(b)} of extrusion 20_{(b)}.

In LED light fixture 100E_{(b)} distal LED-array modules 34_{(b)} are spaced from proximal LED-array modules 33_{(b)}. Venting aperture 28_{(b)} is distal from first and second ends 201_{(b)} and 202_{(b)} of extrusion 20_{(b)} and is at the space 29_{(b)} between proximal and distal LED-array modules 33_{(b)} and 34_{(b)}.

LED-adjacent surface 220E_{(b)} of fixture 100E_{(b)} has a length 224E_{(b)}. As best shown in FIG. 43, length 224E_{(b)} is approximately a dimension which is (a) the sum of module-length 311_{(b} of pairs of end-to-end LED-array modules 31_{(b)} plus (b) the length of space 29_{(b)} between proximal and distal LED-array modules 33_{(b)} and 34_{(b)} LED-adjacent surface 220E_{(b)}, as further shown in FIG. 43, has width 222_{(b)} which is approximately the multiple of the three LED-array modules 31_{(b)} mounted in side-by-side relationship thereon by module-width 310_{(b)}.

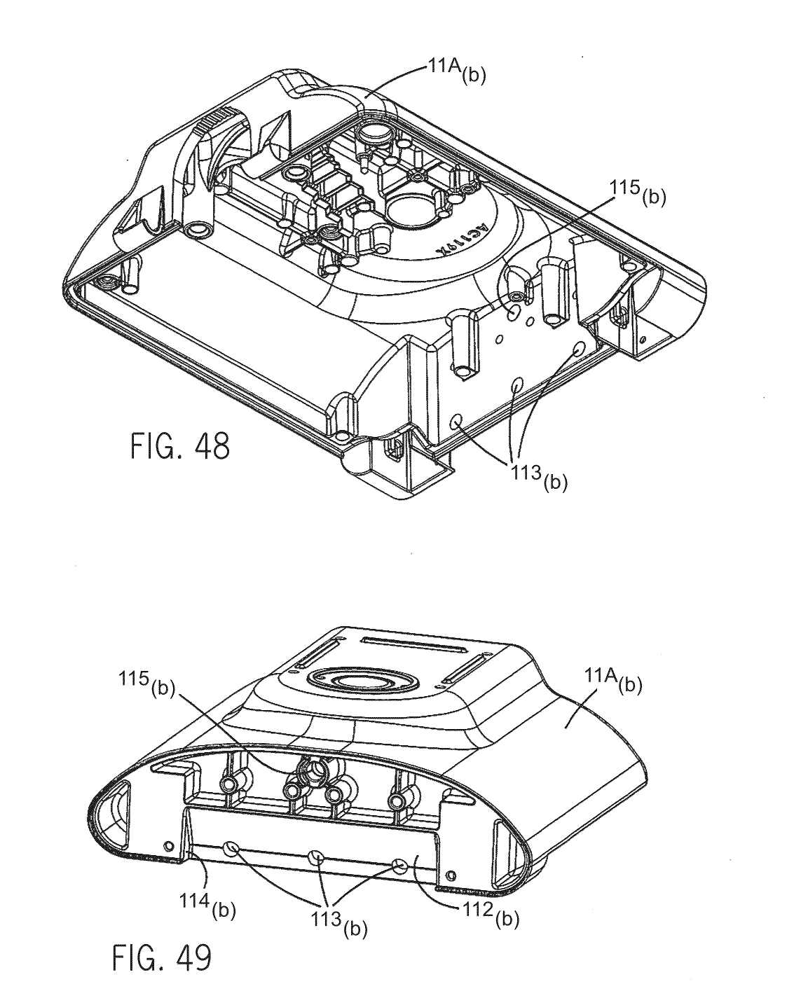

FIGS. 48 and 49 best illustrate first end-portion 11_{(b)} which is configured for mating arrangement with single-piece extrusion 20_{(b)} and its wireway 26_{(b)}.

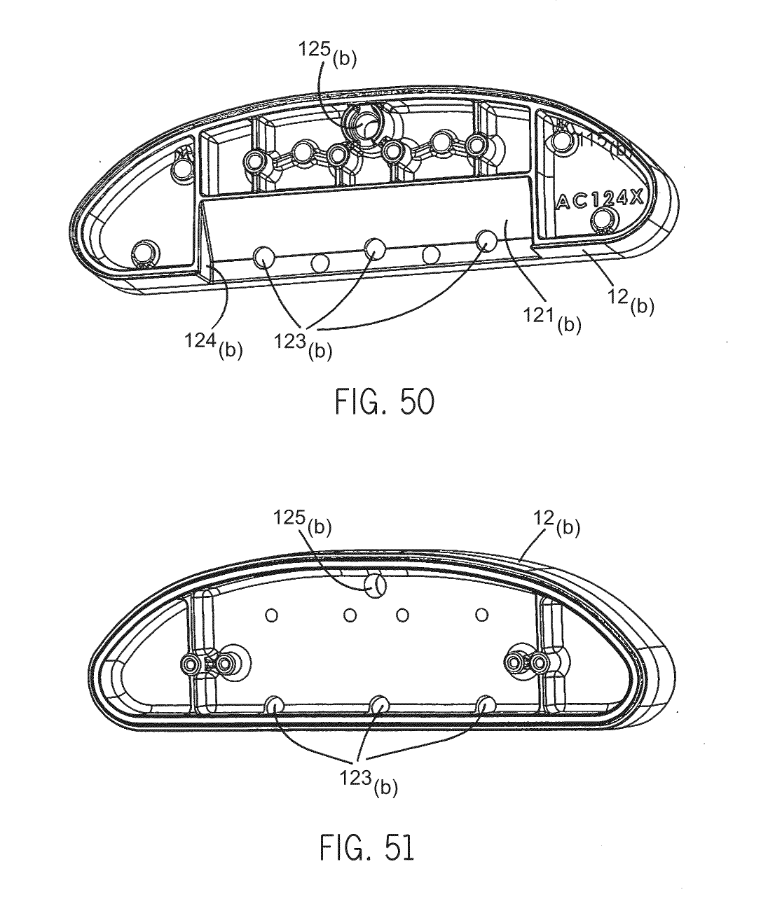

FIGS. 50 and 51 illustrate second end-portion 12_{(b)} which is configured for mating arrangement with single-piece extrusion 20_{(b)} and its wireway 26_{(b)} and shows wire-accesses 123_{(b)} and 125_{(b)} through which wires 19_{(b)} are received into second end-portion 12_{(b)} and channeled to wireway 26_{(b)}.

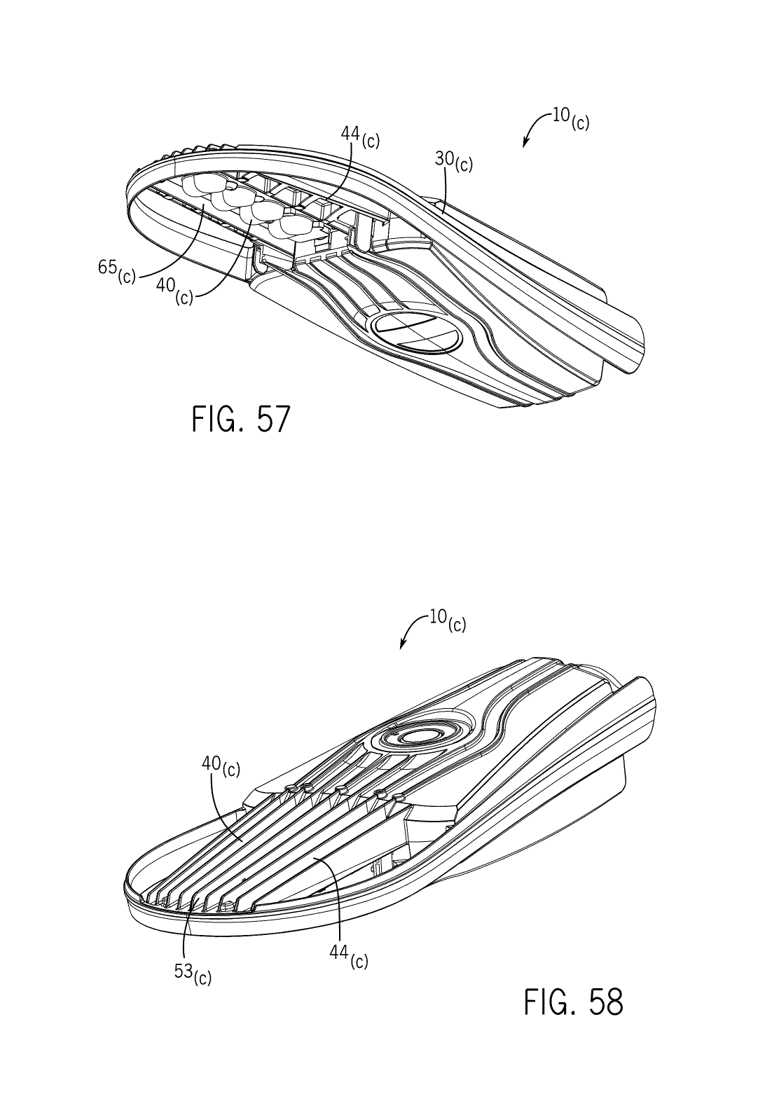

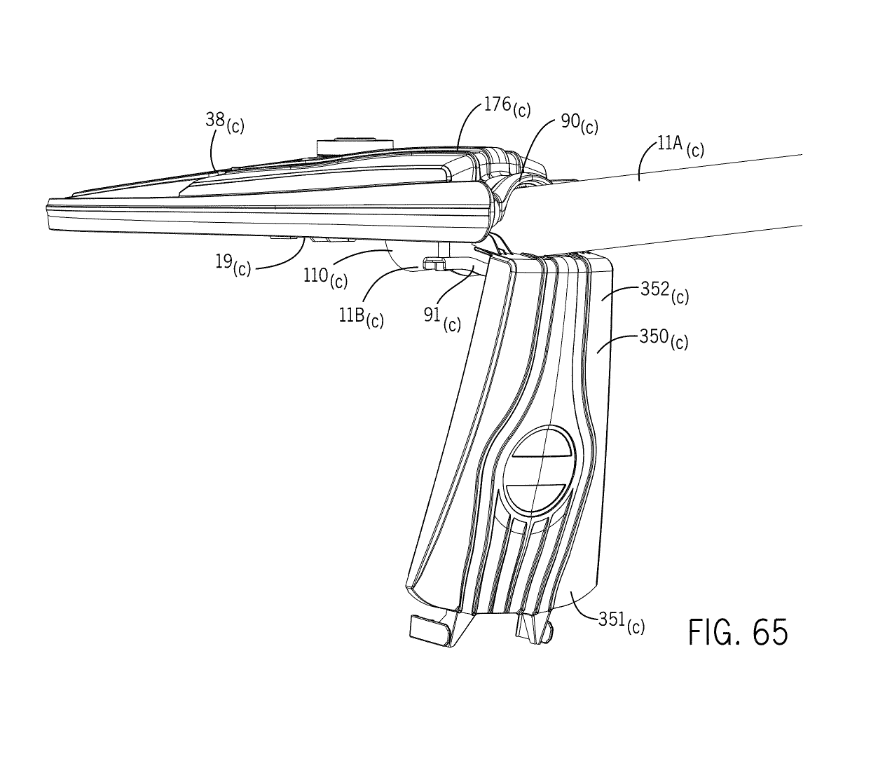

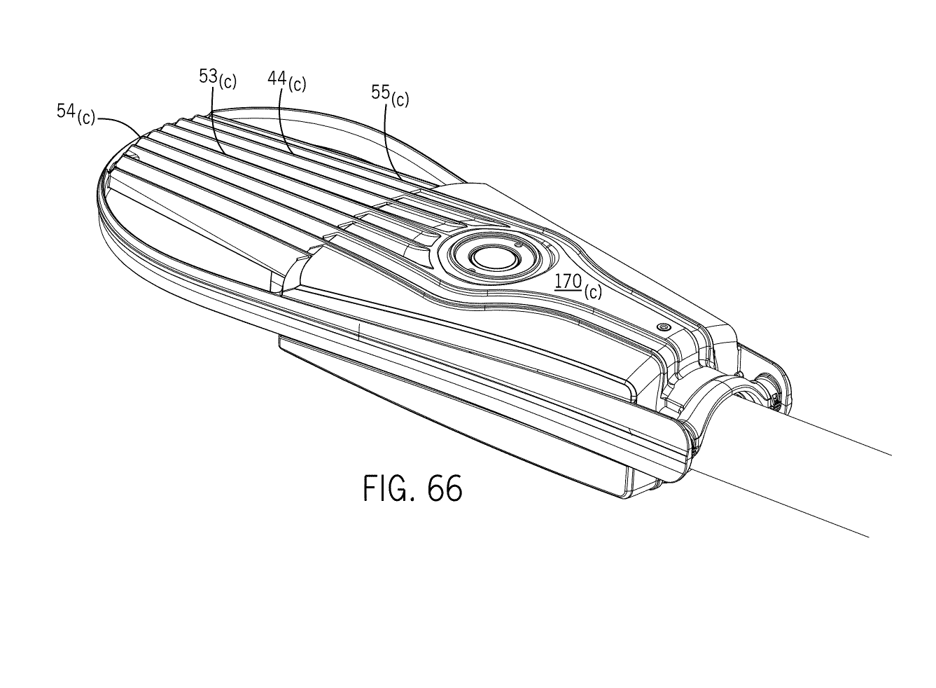

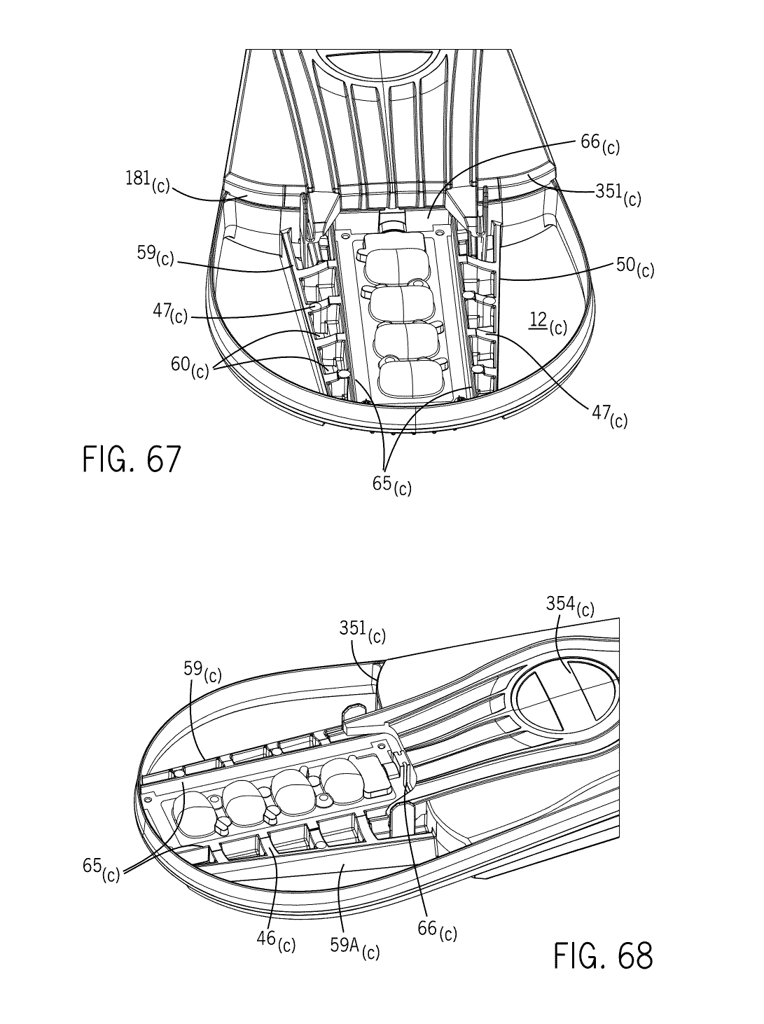

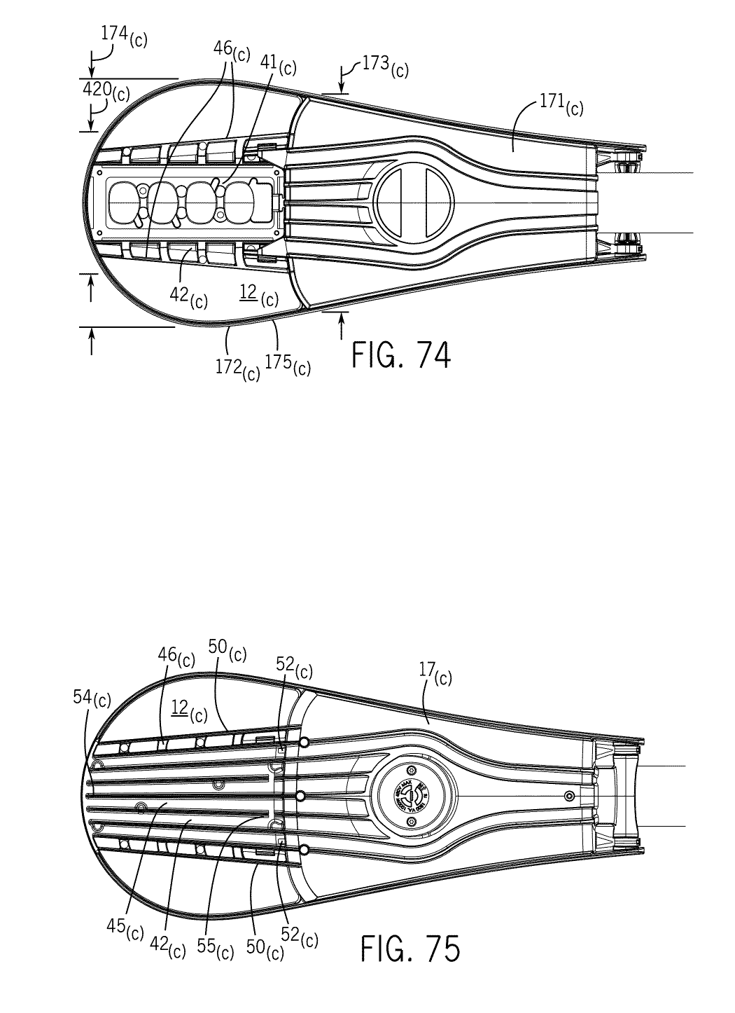

FIGS. 57-75, 88-89 and 91-93 illustrate a light fixture 10_{(c)} which is a first embodiment in accordance with this invention. Light fixture 10_{(c)} includes a frame 30_{(c)} and an LED assembly 40_{(c)} secured with respect to frame 30_{(c)}. Frame 30_{(c)} surrounds and defines a forward open region 31_{(c)} and a rearward region 32_{(c)}. Rearward region has a rearmost portion 33_{(c)} adapted for securement to a support member 11_{(c)}. LED assembly 40_{(c)} is positioned within open forward region 31_{(c)} with open spaces 12_{(c)} remaining therebetween—e.g., between either side of frame 30_{(c)} and LED assembly 40_{(c)}. Other embodiments are possible where there are additional open spaces or one single open space.

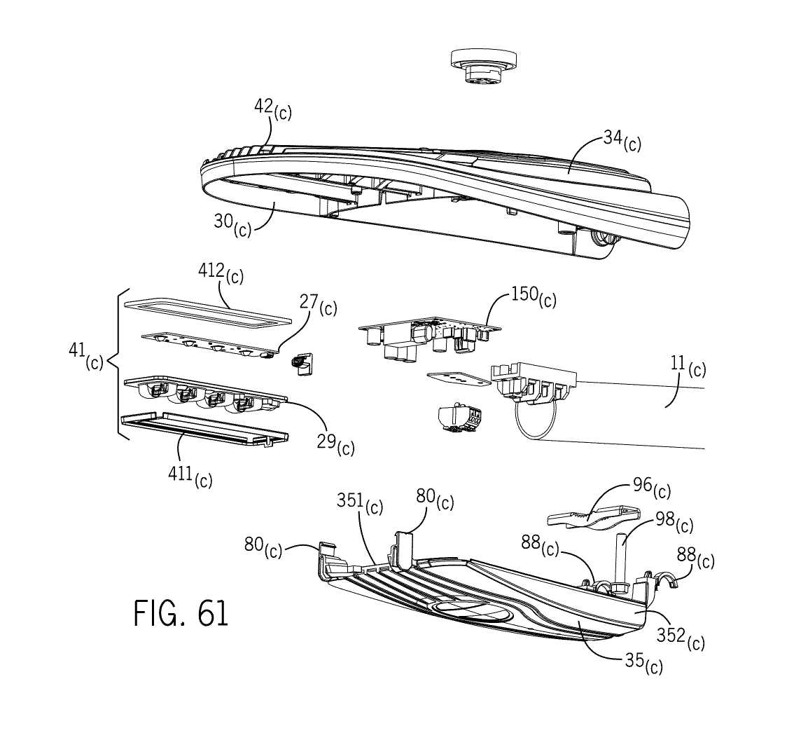

LED assembly 40_{(c)} includes a heat sink 42_{(c)} and an LED illuminator 41_{(c)} secured with respect to heat sink 42_{(c)}. Heat sink 42_{(c)} includes an LED-supporting region 43_{(c)} with heat-dissipating surfaces 44_{(c)} extending from LED-supporting region 43_{(c)}. LED illuminator 41_{(c)} is secured with respect to LED-supporting region 43_{(c)}. As shown in FIG. 61, LED illuminator 41_{(c)} includes a circuit board 27_{(c)} with LED emitters 20_{(c)} thereon and an optical member 29_{(c)} over LED emitters 20_{(c)} for illumination of areas below light fixture 10_{(c)} (when fixture 10_{(c)} is mounted in its usual use orientation).

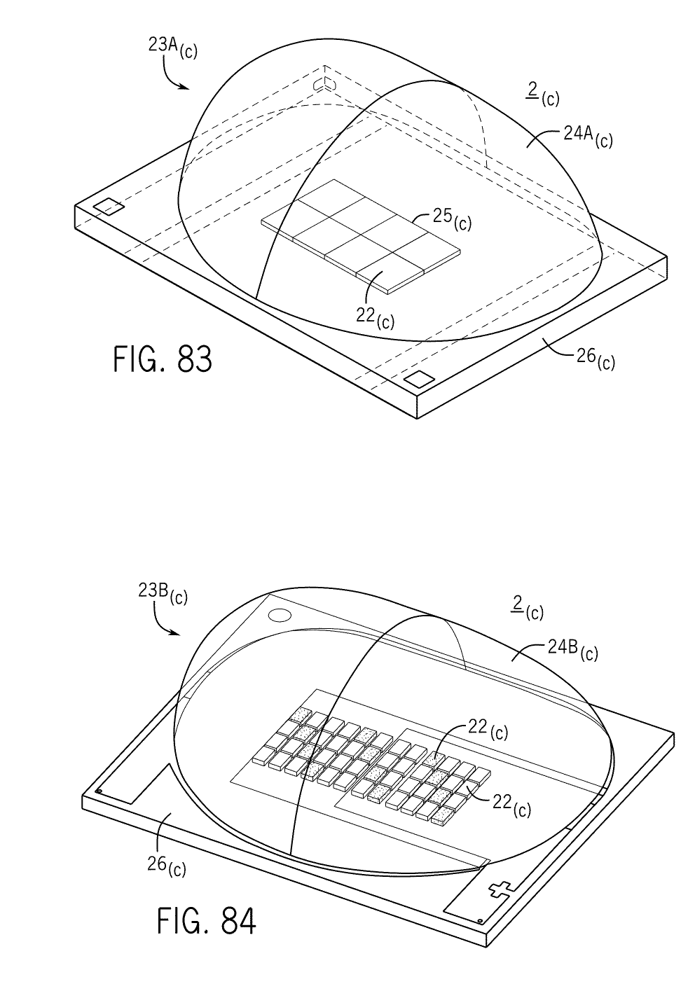

FIGS. 83-87 show LED emitters in different forms among those usable in the present invention. Each LED emitter includes one or more light-emitting diodes (LED) 22_{(c)} with a primary lens 24_{(c)} thereover, forming what is referred to as LED package.

FIGS. 83 and 84 illustrate exemplary LED packages 23A_{(c)} and 23B_{(c)}, each including an array of LEDs 22_{(c)} on an LED-populated area 25_{(c)} which has an aspect ratio greater than 1, and primary lenses 24_{(c)} being overmolded on a submount 26_{(c)} over LED-populated area 25_{(c)}. It is seen in FIG. 84 that the array may include LEDs 22_{(c)} emitting different-wavelength light of different colors such as including red LEDs along with light green or other colors to achieve natural white light. Light emitters of the type as LED packages 23A_{(c)} and 23B_{(c)} are described in detail in patent application Ser. No. 13/441,558, filed on Apr. 6, 2012, and in patent application Ser. No. 13/441,620, filed on Apr. 6, 2012. Contents of both applications are incorporated herein by reference in their entirety.

FIGS. 83 and 84 also illustrate versions of LED light emitters configured to refract LED-emitted light toward a preferential direction 2. In each LED package 23A_{(c)} and 23B_{(c)}, each LED array defines emitter axis. FIGS. 83 and 84 illustrate primary lens 24A_{(c)} configured to refract LED-emitted light toward preferential side 2. It should be understood that for higher efficiency the LED emitter may have a primary lens having its centerline offset from the emitter axis and also being shaped for refraction of LED-emitted light toward preferential side 2. In FIGS. 83 and 84, primary lens 24A_{(c)} is asymmetric.

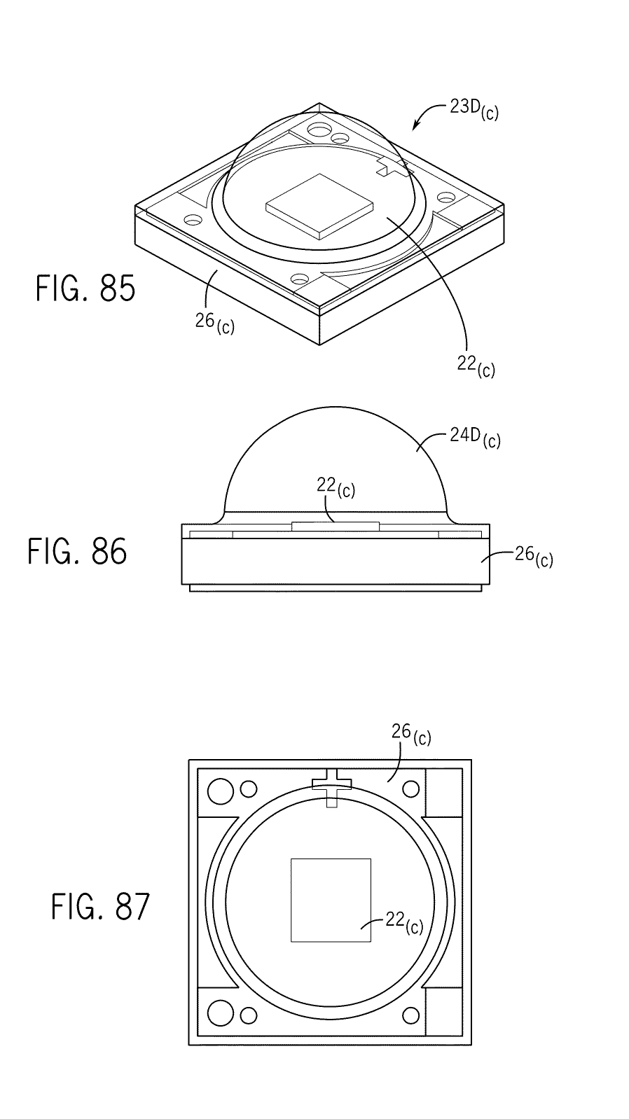

FIGS. 85-87 show LED package 23D_{(c)} with a single LED 22_{(c)} on a submount 26_{(c)} and a hemispheric primary lens 24D_{(c)} coaxially overmolded on submount 26_{(c)} over LED 22_{(c)}.

In fixtures utilizing a plurality of emitters, a plurality of LEDs or LED arrays may be disposed directly on a common submount in spaced relationship between the LEDs or LED arrays, each of which is overmolded with a respective primary lens. These types of LED emitters are sometimes referred to as chip-on-board LEDs.

LED optical member 29_{(c)} is a secondary lens placed over the primary lens. In embodiments with a plurality of LED emitters (packages), optical member 29_{(c)} includes a plurality of lenses 28_{(c)} each positioned over a respective one of the primary lenses. The plurality of secondary lenses 28_{(c)} are shown molded as a single piece 29_{(c)} with a single flange surrounding each of the plurality of lenses 28_{(c)}.

FIG. 61 also illustrates LED illuminator 41_{(c)} including a securement structure which includes rigid peripheral structure 411_{(c)} which applies force along the circuit-board peripheral area toward heat sink 42_{(c)}. This structure serves to increase thermal contact across the facing area of the thermal-engagement surface of circuit board 27_{(c)} and the surface of heat sink 42_{(c)} which receives circuit board 27_{(c)}. This arrangement facilitates removal of heat from LED emitters 20_{(c)} during operation by increasing surface-to-surface contact between the thermal-engagement surface of the circuit board and the heat sink by facilitating excellent, substantially uniform thermal communication from the circuit board to the heat sink, thereby increasing heat transfer from the LEDs to the heat sink during operation. Rigid peripheral structure 411_{(c)} may be a drawn sheet-metal single-piece structure. As shown in FIG. 61, a gasket 412_{(c)} is sandwiched between optical member 29_{(c)} and heat sink 42_{(c)}, thereby facilitating fluid-tight sealing of the circuit board 27_{(c)}. The securement structure is described in detail in Patent Application Ser. No. 61/746,862, filed Dec. 28, 2012, the entire contents of which are incorporated herein by reference.

LED light fixture 10_{(c)} has a housing 17_{(c)} and LED assembly 40_{(c)} is secured with respect to housing 17_{(c)}. Housing 17_{(c)} has an enclosure 13_{(c)} which is within rearward region 32_{(c)} and defines a chamber 14_{(c)} enclosing electronic LED power circuitry 15_{(c)}. As shown in FIGS. 61-63, 65 and 73, enclosure 13_{(c)} has an upper shell 34_{(c)} and a lower shell 35_{(c)}. Lower shell 35_{(c)}, which is a one-piece polymeric structure, is movably secured with respect to upper shell 34_{(c)}, which is a metal structure.

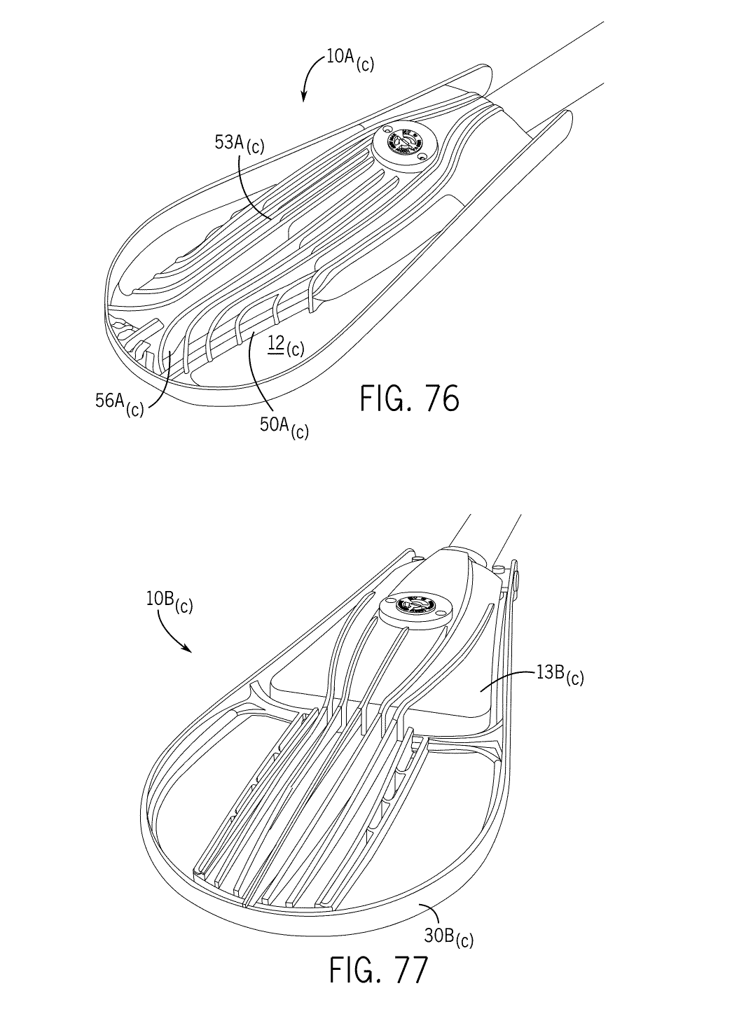

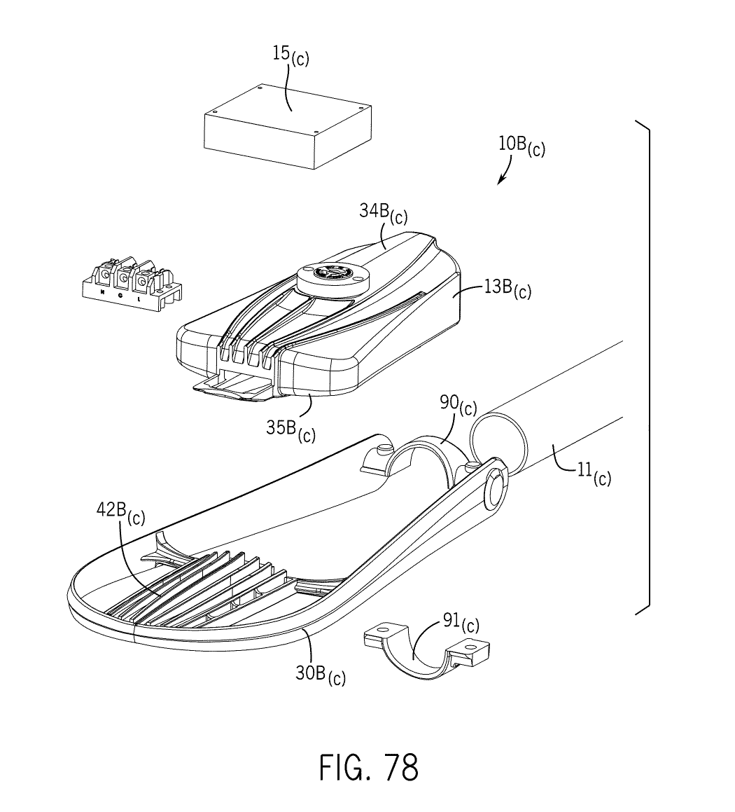

In various embodiments of the invention, including the first embodiment (which is shown in FIGS. 57-75, 88-89 and 91-93), a second embodiment which is shown in FIG. 76, and a third embodiment which is shown in FIGS. 77 and 78, the heat sink and the frame are formed as a single piece by metal casting. In the first and second of these embodiments, the frame, the heat sink and the upper shell are all formed as a single piece by metal casting.

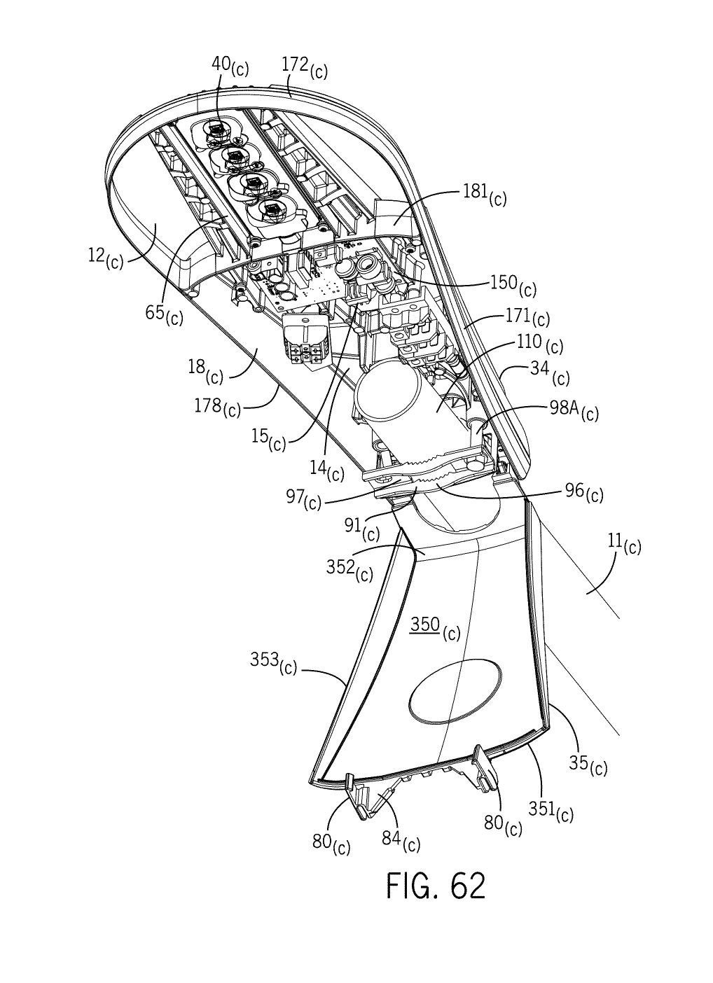

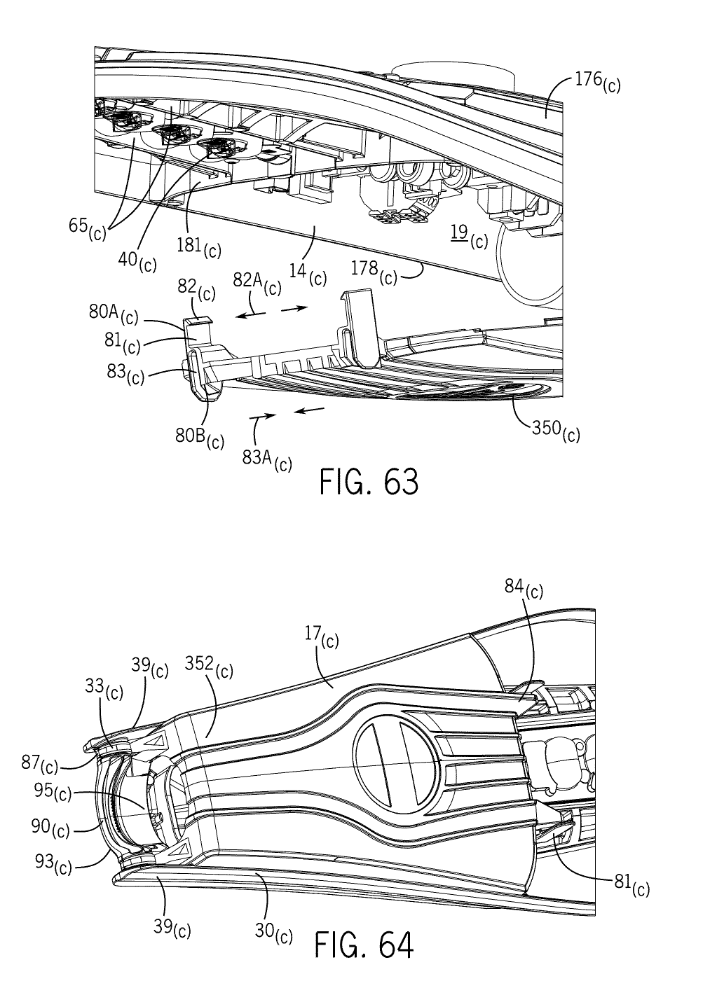

FIGS. 62 and 63 illustrate electronic LED power circuitry 15_{(c)} within chamber 14_{(c)}. Such LED power circuitry includes a caseless LED driver 150_{(c)} which is removably secured to the inner surface of upper shell 34_{(c)}. Driver components of caseless LED driver 150_{(c)} are encapsulated (potted) in a protective polymeric material prior to installation in the fixture such that driver 150_{(c)} is readily replaceable and does not have any potting applied during or after installation in the fixture. Suitable examples of such protective polymeric encapsulating material include thermoplastic materials such as low-pressure injection-molded nylon, which amply protect driver 150_{(c)} from electrostatic discharge while conducting heat to upper shell 34_{(c)} to facilitate cooling of the driver during operation.

With lower shell 35_{(c)} being of polymeric material, a wireless signal can be received by the antenna which is fully enclosed within chamber 14_{(c)} along with circuitry for wireless control of the fixture. Such circuitry with the antenna may be included as part of LED driver 150_{(c)}. The advantage of the fully enclosed antenna is also available on other embodiments of this invention having enclosures, all or portions of which are non-metallic material.

Housing 17_{(c)} includes a main portion 171_{(c)} which includes upper shell 34_{(c)} and lower shell 35_{(c)} and also includes a forward portion 172_{(c)} extending forwardly from main portion 171_{(c)}. (Forward portion 172_{(c)} of housing 17_{(c)} is the forward portion of frame 30_{(c)}.) In main portion 171_{(c)}, upper shell 34_{(c)} forms a housing body 176_{(c)} and lower shell 35_{(c)} serves as a cover member 350_{(c)} movably secured with respect to housing body 176_{(c)}.

As shown in FIGS. 62-66 and 73, housing body 176_{(c)} of the first embodiment has a main wall 170_{(c)} (the upper portion of upper shell 34_{(c)}) and a surrounding wall 18_{(c)} extending downwardly therefrom to a housing-body edge 178_{(c)}. Surrounding wall 18_{(c)} has two opposed lateral wall-portions 180_{(c)} extending between a forward heat-sink-adjacent wall-portion 181_{(c)} and a rearward wall-portion 182_{(c)}. Cover member 350_{(c)} has a forward end 351_{(c)} and a rearward end 352_{(c)}. FIGS. 62, 64, 65 and 73 show rearward end 352_{(c)} hingedly secured with respect to rearward wall-portion 182_{(c)} of housing body 176_{(c)}.

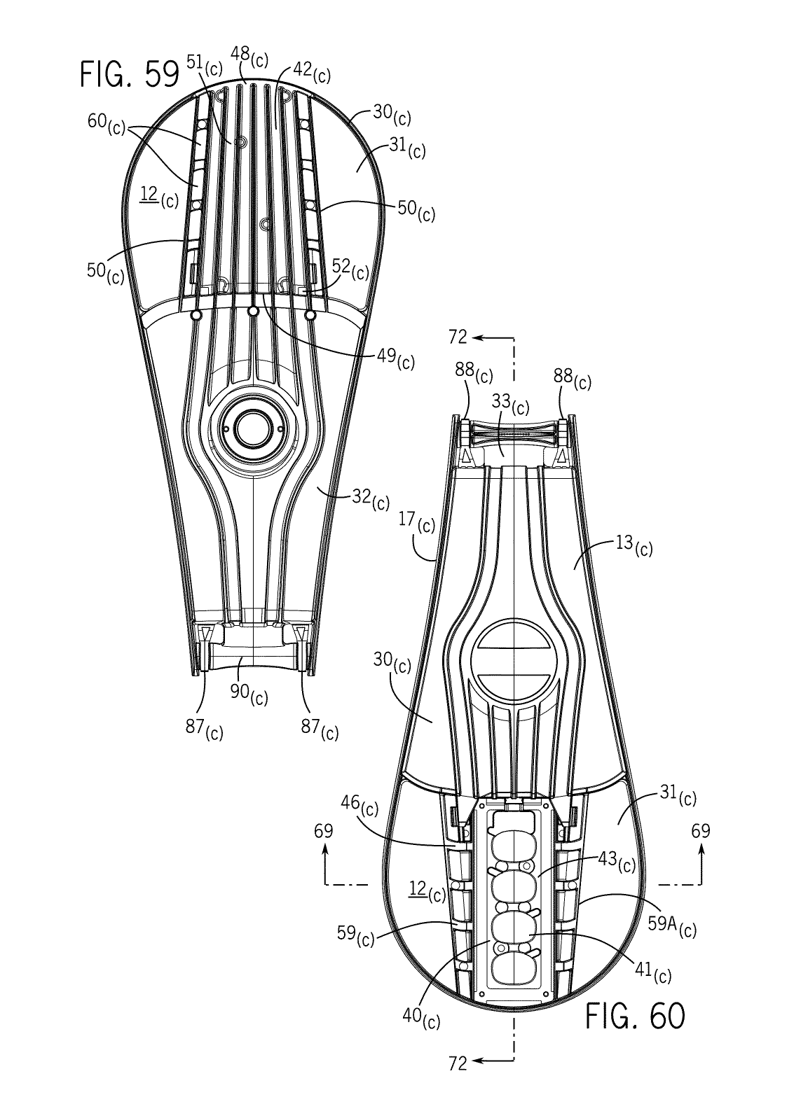

The nature of the hinging securement is seen in FIGS. 59-62, 64, 65, 71, 74 and 75. In particular, polymeric lower shell 35_{(c)} has an integral hinging member 87_{(c)} in snap engagement with rearmost portion 33_{(c)} of frame 30_{(c)}. Hinging member 87_{(c)} has a pair of engaging portions 88_{(c)}, and the flexibility of the polymeric material of lower shell 35_{(c)} permits snap engagement of each engaging portion 88_{(c)} with rearmost portion 33_{(c)} of frame 30_{(c)} for secure pivoting thereabout. This provides secure connection of lower shell 35_{(c)} portion with upper shell 34_{(c)}, allowing lower shell 35_{(c)} to hang safely in open position during servicing of light fixture 10_{(c)}. In other words, the snap engagement of hinging member 87_{(c)} with rearmost portion 33_{(c)} allows controlled disengagement of lower shell 35_{(c)} from upper shell 34_{(c)}.

As shown in FIGS. 61-63 and 65, forward end 351_{(c)} of cover member 350_{(c)} has an integrated latching member 80_{(c)} detachably securing forward end 351_{(c)} of cover member 350_{(c)} with respect to forward wall-portion 181_{(c)} of housing body 176_{(c)}, thereby closing chamber 14_{(c)}. As seen in FIGS. 62-64, cover member 350_{(c)} has a cover edge 353_{(c)} which is configured to engage housing-body edge 178_{(c)}.

FIGS. 61-63, 65 and 73 show that integrated latching member 80_{(c)} includes a spring tab 81_{(c)} with a hook 82_{(c)} at one end 80A_{(c)} and a release actuator 83_{(c)} at opposite end 80B_{(c)}. FIG. 63 shows hook 82_{(c)} positioned and configured for locking engagement with respect to housing body 176_{(c)}. Release actuator 83_{(c)} is configured such that force applied thereto in the direction of arrow 83A_{(c)} pivots hook 82_{(c)} in opposite direction 82A_{(c)} sufficiently to release hook 82_{(c)} from the locking engagement. This serves to detach forward end 351_{(c)} of cover member 350_{(c)} from housing body 176_{(c)} to allow access to chamber 14_{(c)}. In should be understood that other suitable locking engagement between cover member 350_{(c)} and housing body 176_{(c)} may be possible.

As seen in FIGS. 57-60, 64, 67, 68, 74 and 75, hook 82_{(c)} is positioned and configured for locking engagement with the one-piece casting. Integrated latching member 80_{(c)} also includes a cover-member forward extension 84_{(c)} extending beyond forward wall-portion 181_{(c)} of housing-body surrounding wall 18_{(c)}. Spring tab 81_{(c)} is supported by forward extension 84_{(c)} such that hook 82_{(c)} is positioned for locking engagement with heat sink 42_{(c)}. As seen in FIGS. 59, 67, 73 and 75, heat sink 42_{(c)} has a protrusion 85_{(c)} configured and positioned for locking engagement by hook 82_{(c)}.

Light fixture 10B_{(c)} of the third embodiment, shown in FIGS. 77 and 78 and which as indicated above includes frame 30B_{(c)} and heat sink 42B_{(c)} formed as a one-piece metal casting, has upper shell 34B_{(c)} and lower shell 35B_{(c)} both formed of polymeric material. The enclosure 13B_{(c)} which is formed by such polymeric shells is secured with respect to the metal casting of this embodiment.

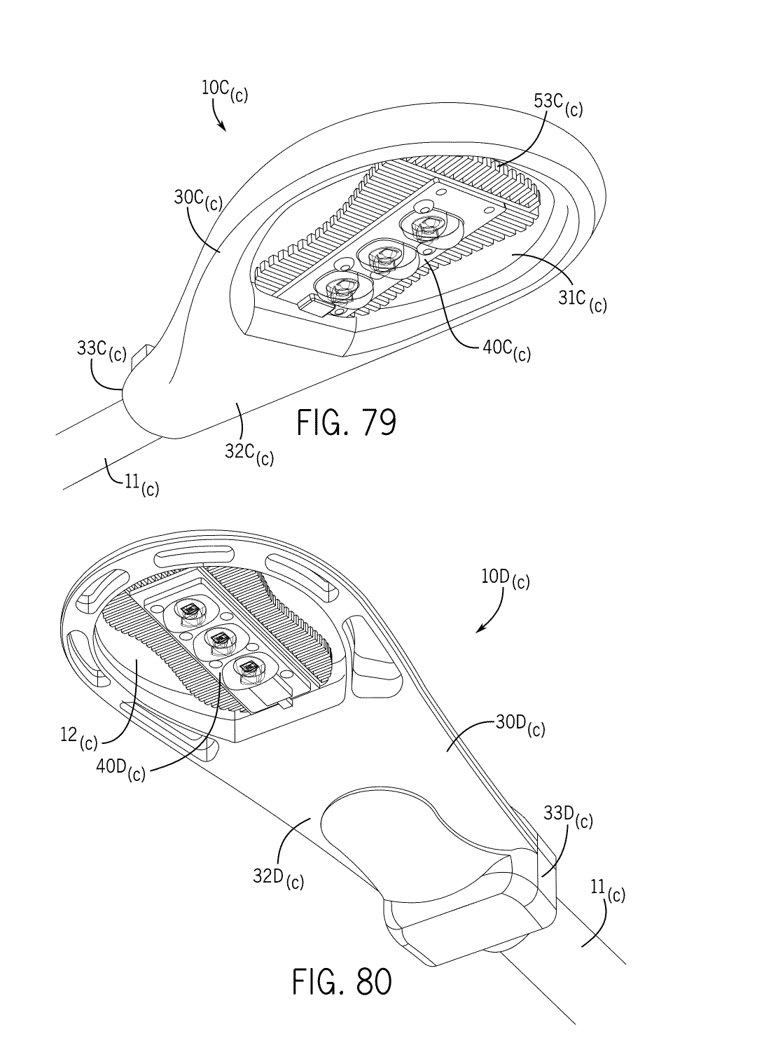

A fourth embodiment of this invention is illustrated in FIG. 79. In such embodiment, LED light fixture 10C_{(c)} has a non-metallic (polymeric) frame 30C_{(c)}. Frame 30C_{(c)} defines a forward open region 31C_{(c)} and has a rearward region 32C_{(c)} with a rearmost portion 33C_{(c)} adapted for securement to support member 11_{(c)}.

FIGS. 80-82 illustrate a fifth embodiment of this invention. Light fixture 10D_{(c)} has an LED assembly 40D_{(c)} secured with respect to a non-metallic (polymeric) frame 30D_{(c)}. In the fourth and fifth embodiments, the frame itself serves to form the enclosure for the LED power circuitry, and such circuitry may include a fully-enclosed antenna.

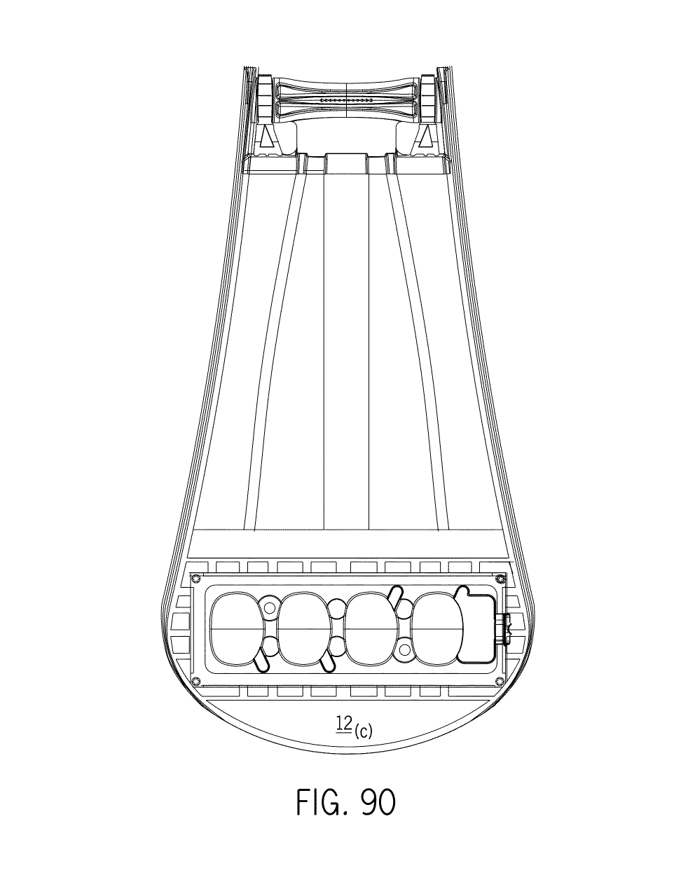

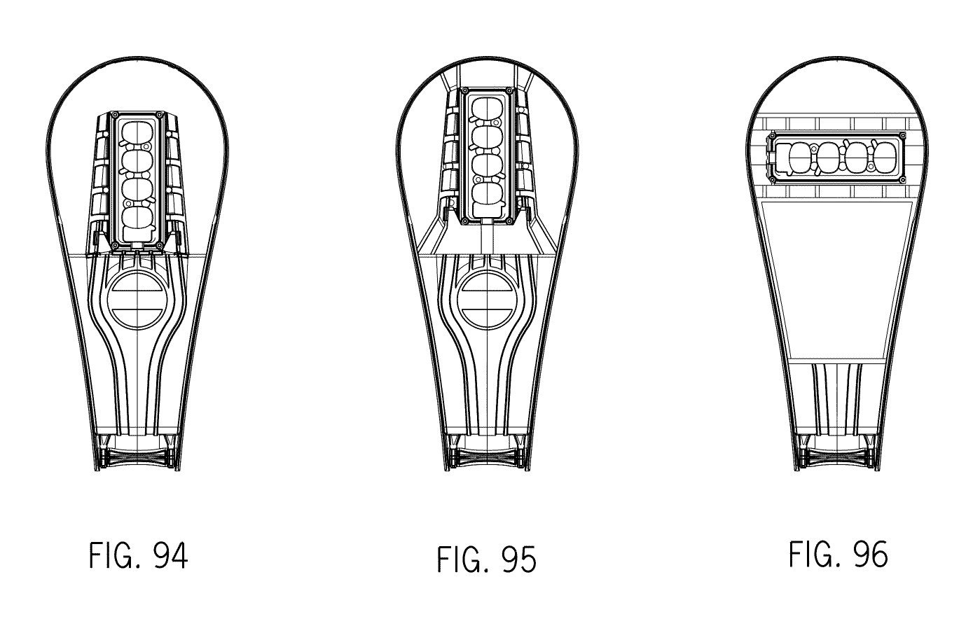

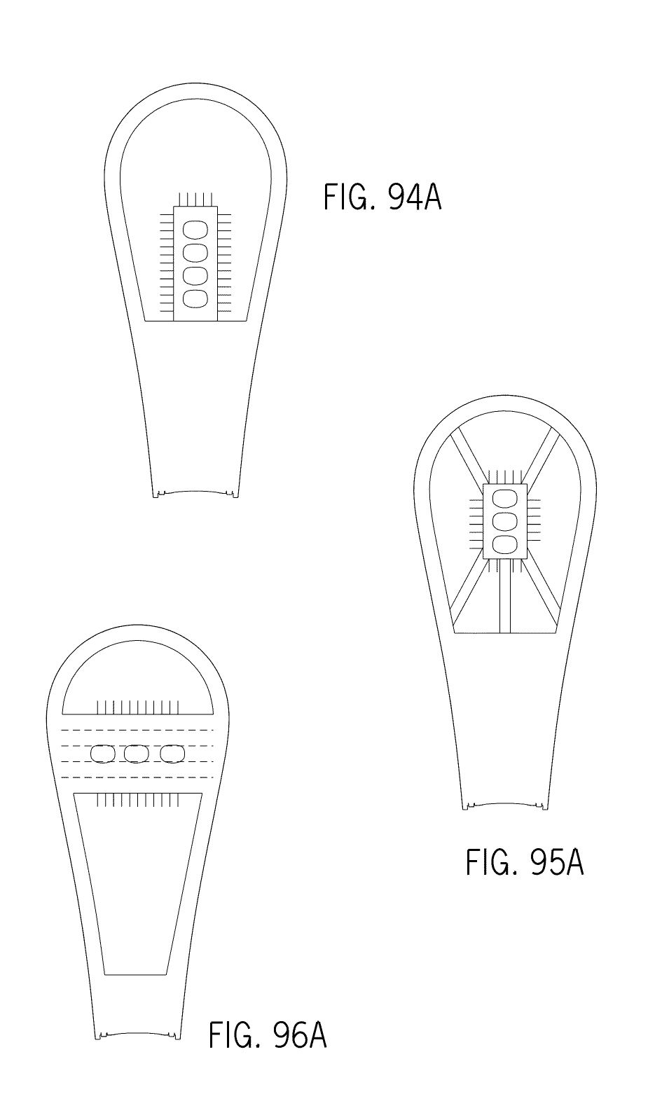

The embodiments of FIGS. 79-82 each include extruded heat sinks which are characterized by having fins extending laterally on either side and forwardly on the front side. In each embodiment, the extruded heat sink has been extruded in a direction orthogonal to both the forward and the lateral directions. The extruded dimension, which is illustrated by numeral 72_{(c)} in FIG. 82, is less than the forward-rearward and side-to-side dimensions 73_{(c)} and 74_{(c)} of such heat sink, as illustrated in FIG. 25. In some embodiments, the fins may be on at least three sides of the heat sink, as seen in FIGS. 90, 96, 94A and 95A. As seen in FIGS. 90, 94-95A, through-spaces 12_{(c)} may be located along at least two of transverse sides of the heat sink, e.g., at least on one lateral side and on the front and rear sides of the heat sink.

FIGS. 90-96 illustrate examples of embodiments which include at least one wall extending within the open space 12 and open for air/water-flow along at least two sides thereof. The examples of light fixture configurations shown in each of FIGS. 90-96 have at least one wall which extends within the open space substantially along the base. FIGS. 90 and 96 illustrate examples of at least one wall dividing the open space into an illuminator-adjacent flow region and a chamber-adjacent flow region.

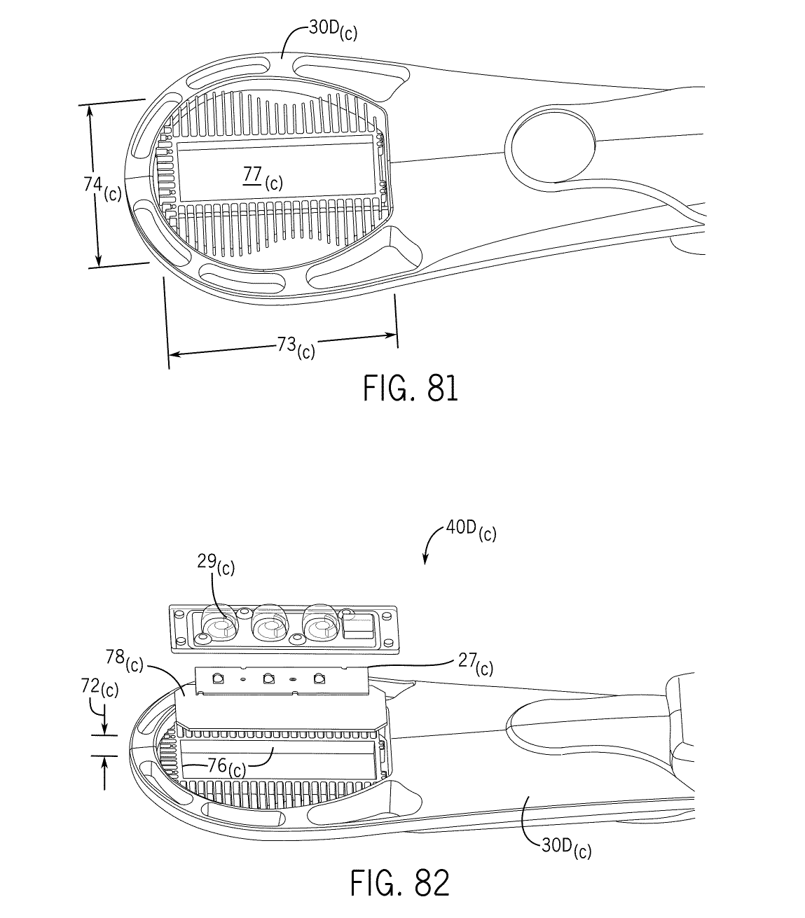

The “short” extrusions of the heat sinks of the fourth and fifth embodiments are facilitated by structure shown best in FIGS. 81 and 82. More specifically, the heat sinks are each formed by an extrusion having a middle portion void, i.e., having walls 76_{(c)} defining a central opening 77_{(c)}. As seen in FIG. 82, these heat sinks include, in addition to such extrusion, a mounting plate 78_{(c)} in thermal contact with the extrusion. Mounting plate 78_{(c)} may be thermally engaged to the extrusion by screws or in other ways. As shown in FIG. 82, LED illuminator 41_{(c)} is secured to mounting plate 78_{(c)}.

The laterally- and forwardly-extending fins are open to free flow of ambient fluid (air and water), and their position and orientation serve to promote rapid heat exchange with the atmosphere and therefore rapid cooling of the LED illuminator during operation. Upwardly-flowing air and downwardly-flowing water (in the presence of precipitation) facilitate effective cooling, and reduce the need for upwardly-extending fins on top of the heat sinks.

Certain aspects are illustrated best by reference to the first embodiment, particularly as shown in FIGS. 57-63, 65-69, 73-82 and 90. Heat sink 42_{(c)} of such embodiment has a front side 48_{(c)}, a rear side 49_{(c)} and lateral sides 50_{(c)} and is open to ambient-fluid flow to and from the various heat-dissipating surfaces 44_{(c)}. Heat sink 42_{(c)} includes a central portion 45_{(c)} and peripheral portions 46_{(c)} along opposite lateral sides 50_{(c)}. Peripheral portions 46_{(c)} have peripheral heat-dissipating surfaces 47_{(c)} along lateral sides 50_{(c)} of heat sink 42_{(c)}. Central portion 45_{(c)} includes LED-supporting region 43_{(c)} and has central heat-dissipating surfaces 51_{(c)} opposite LED illuminator 41_{(c)} from which a plurality of elongate fins 53_{(c)} protrude in a direction opposite LED illuminator 41_{(c)}. Fins 53_{(c)} extend from front fin-ends 54_{(c)} adjacent to front side 48_{(c)} of heat sink 42_{(c)} to rear fin-ends 55_{(c)} adjacent to rear side 49_{(c)} of heat sink 42_{(c)}. As shown in FIGS. 59, 66, 72 and 75-78, some of rear fin-ends 55_{(c)} are integral with housing 17_{(c)}.

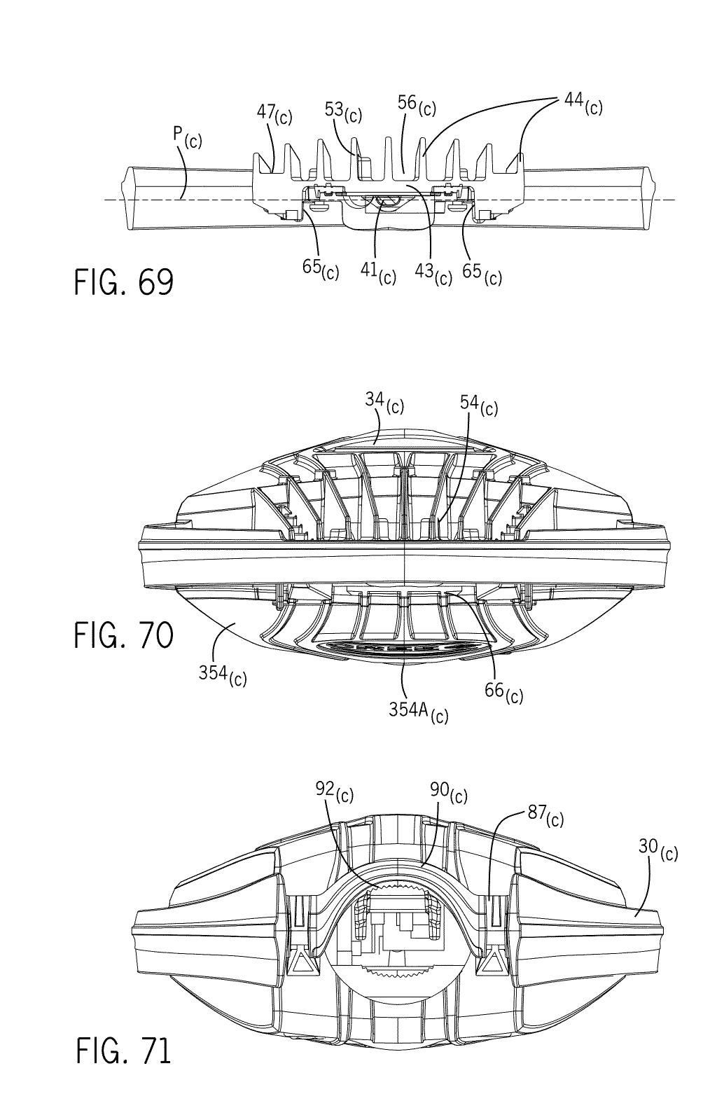

FIGS. 59, 73, 75, 81 and 90 show central-portion openings 52_{(c)} facilitating ambient-fluid flow to and from heat-dissipating surfaces 51_{(c)} of central portion 45_{(c)}. Central-portion openings 52_{(c)} are adjacent to enclosure 13_{(c)} and are partially defined by housing 17_{(c)}. Fins 53_{(c)} of central portion 45_{(c)} define between-fin channels 56_{(c)} (shown in FIG. 69), which in a mounted position extend along a plane which is close to, but not, horizontal. Between-fin channels 56_{(c)} are open at front fin-ends 54_{(c)}; i.e., there is no structural barrier to flow of liquid from between-fin channels 56_{(c)} at front fin-ends 54_{(c)}.

In the second embodiment illustrated in FIG. 76, fins 53A_{(c)} are configured such that between-fin channels 56A_{(c)} are open along the front and lateral sides of the heat sink.

Referring again to the first embodiment, FIGS. 59 and 75 show rear fin-ends 55_{(c)} configured to permit ambient-fluid flow from between-fin channels 56_{(c)} to central-portion openings 52_{(c)}, thereby facilitating liquid drainage therefrom. Liquid drainage from the top of heat sink 42_{(c)} is facilitated by inclination of the top surface of heat sink 42_{(c)}, as explained more specifically below.

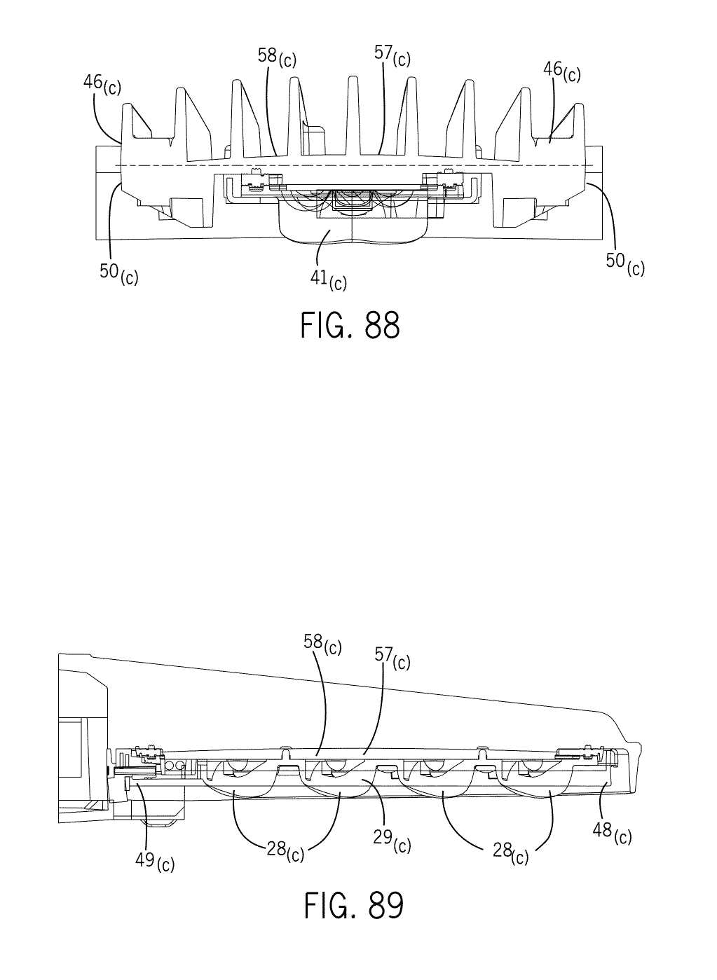

FIGS. 88 and 89 show between-fin surfaces 57_{(c)} inclined off-horizontal when light fixture 10_{(c)} is in its usual use orientation. More specifically, FIG. 88 shows surfaces 57_{(c)} sloping toward lateral sides 50_{(c)} of heat sink 42_{(c)}, and FIG. 89 shows surfaces 57_{(c)} sloping toward front and rear sides 48_{(c)} and 49_{(c)} of heat sink 42_{(c)}. In other words, portions of surfaces 57_{(c)} are slightly but sufficiently downwardly inclined toward at least two dimensions and in this embodiment on each of the four sides of heat sink 42_{(c)}.

FIGS. 88 and 89 show LED assembly 40_{(c)} on a bottom surface of heat sink 42_{(c)}. Heat sink 42_{(c)}, when the fixture is in its mounted orientation, includes a top surface which in plan view has a surrounding edge. FIG. 88 shows the top surface sloping downwardly toward the surrounding edge in opposite lateral plan-view directions, thereby facilitating liquid drainage from the heat sink. FIG. 89 shows the top surface sloping downwardly toward the surrounding edge in the forward and rearward directions. FIG. 88 further shows a plurality of elongate fins 53_{(c)} protruding from the top surface in a direction opposite LED illuminator 41_{(c)}. Sloping top surface includes between-fin surfaces 57_{(c)}.

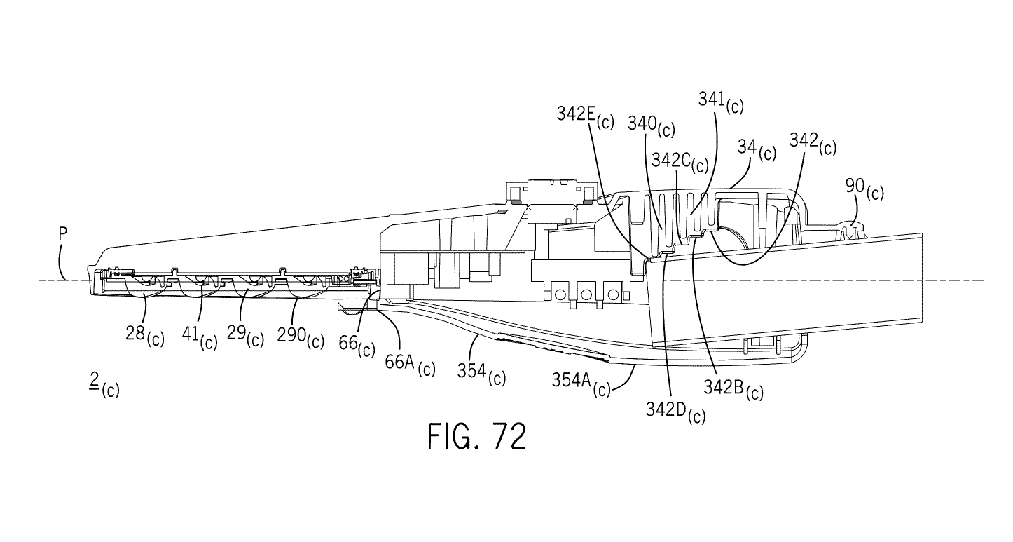

FIGS. 58 and 72 show housing 17_{(c)} including a housing top surface sloping downwardly in the forward direction. These figures also show the top housing surface sloping toward the top surface of heat sink 42_{(c)}, whereby liquid drainage from the housing facilitates cooling of heat sink 42_{(c)}. FIGS. 70 and 71 show the housing top surface sloping downwardly in opposite lateral plan-view directions, thereby facilitating liquid drainage therefrom.

Housing upper shell 34_{(c)} and heat sink 42_{(c)} are formed as a single piece, whereby the housing upper shell facilitates heat dissipation. The heat sink, the frame and the housing upper shell are formed as a single piece.

In addition to the above-described sloping, LED light fixture 10_{(c)} has various advantageous structural taperings. As seen best in FIGS. 59 and 60, heat sink 42_{(c)}, in plan view is tapered such that it is wider at its rearward end than at its forward end. Additionally, as seen in FIGS. 58 and 72, each of central-portion fins 53_{(c)} has a tapered configuration such that its vertical dimension at the rearward end of heat sink 42_{(c)} is greater than its vertical dimension at the forward end of heat sink 42_{(c)}. Furthermore, as seen in FIGS. 69 and 70, fins 53_{(c)} have progressively lesser vertical dimensions toward each of opposite lateral sides 50_{(c)} of heat sink 42_{(c)}.

As shown in FIGS. 57, 61, 6 and 67-69 and 88, peripheral portions 46_{(c)} of heat sink 42_{(c)} extend along opposite lateral sides 50_{(c)}. Peripheral heat-dissipating surfaces 47_{(c)} include a plurality of fins 59_{(c)} extending laterally from central portion 45_{(c)} of heat sink 42_{(c)}, with open spaces 60_{(c)} formed between adjacent pairs of fins 59_{(c)}. As seen in FIGS. 59, 60, 67-69 and 73-75, peripheral portion 46_{(c)} also has a peripheral fin 59A_{(c)} along each lateral side 50_{(c)} of heat sink 42_{(c)}. Peripheral fins 59A_{(c)} extend in length from front fin-ends 54A_{(c)} adjacent to front side 48_{(c)} of heat sink 42_{(c)} to rear fin-ends 55A_{(c)} adjacent to rear side 49_{(c)} of heat sink 42_{(c)}. Rear fin-ends 55A_{(c)} of peripheral fins 59A_{(c)} are integral with housing 17_{(c)}. The configuration of peripheral portions 46_{(c)} of heat sink 42_{(c)} serves to facilitate cooling by providing additional heat-exchange surfaces in particular effective locations.

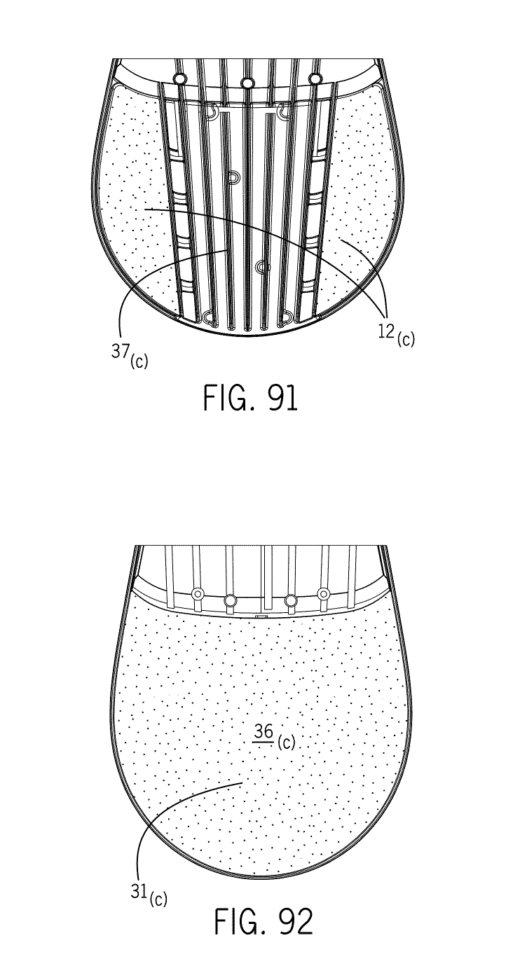

The various embodiments disclosed herein each illustrate one aspect of the present invention particularly related to the frame and open character of the fixtures. This is discussed in particular with respect to the first embodiment, and in particular with reference to FIGS. 91-93 which schematically illustrate “projected” areas of structure and through-spaces of the fixture in plan view.

More specifically, the first embodiment includes the following projected areas:

total area 36_{(c)} of light-fixture forward region 31_{(c)}≈67.0 sq.in.;

total area 37_{(c)} of LED assembly 40_{(c)}≈40.4 sq.in.;

total through-space area of the two lateral side voids 12_{(c)}≈26.5 sq.in.;

total area of the entire fixture≈160 sq. in.

FIGS. 91-93 show projected LED-assembly area 37_{(c)} of about 60% of the projected forward-region area 36_{(c)}. The total through-space area of the two lateral side voids 12_{(c)} is about two-thirds of projected LED-assembly area 37_{(c)}.

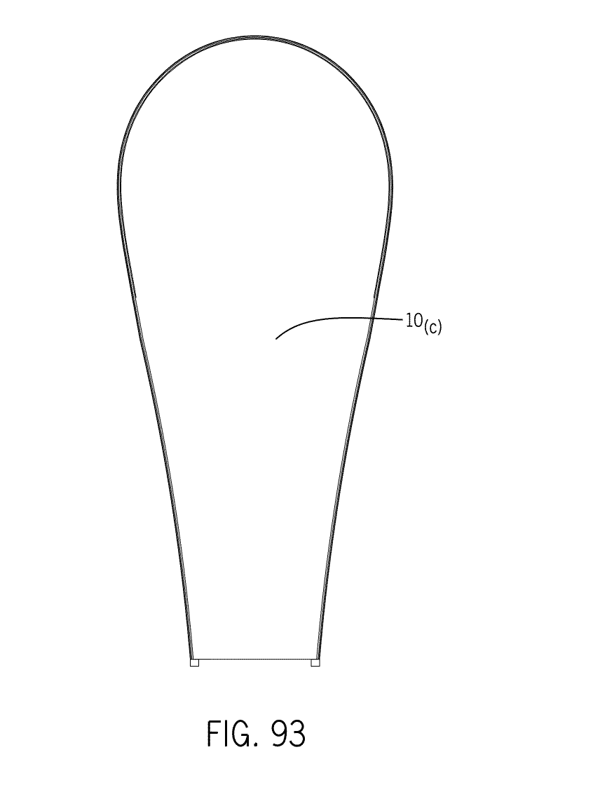

When describing the openness aspect of this invention using reference to the illuminator plane P indicated in FIGS. 69 and 72, plane P is defined by LED illuminator 41_{(c)} directly facing the area to be illuminated. The intersections referred to above with such plane P are illustrated in FIGS. 91 and 93.

Using such parameters, the total through-space area in the illuminator plane is slightly over 15% of the fixture area. And, if the light fixture is configured such that the enclosure with its LED power circuitry, rather than being beside the LED assembly, is offset above or otherwise away from the LED assembly (such as being in the support member), then the total through-space area in the illuminator plane may be at least about 40% of the fixture area. Described differently, the total through-space area in illuminator plane P is about two-thirds of the projected LED-assembly area.

While openness is discussed above with particular reference to the first embodiment, it should be noted that FIG. 76 illustrates an embodiment in which light fixture 10A_{(c)} has openness along the majority of its length. More specifically, the openness extends well to the rear of the forward portion of fixture 10A_{(c)}, i.e., well to the rear of the LED assembly of such fixture, including on either side of the enclosure.

Such openness in an LED light fixture offers great flexibility from the standpoint of form-factor design, e.g., allowing overall shape of the fixtures to better accommodate replacement of existing non-LED fixtures of various shapes. Several of the embodiments disclosed herein have frames which at least in their forward portions provide a footprint substantially similar to the footprint of so-called “cobrahead” light fixtures. This is achieved despite the fact that the LED assemblies used in fixtures according to the recent invention have substantially straight opposite lateral sides, as seen in the figures.

The advantages of the openness disclosed herein extend beyond form-factor concerns. Just one example includes avoiding or minimizing accumulation of snow, leaves or other materials on the fixtures.

Another aspect of the present inventive light fixtures is illustrated in FIGS. 57,62, 63 and 67-69. Referring in particular to the first embodiment, central portion 45_{(c)} of heat sink 42_{(c)} has downwardly-extending shield members 65_{(c)} at lateral sides 50_{(c)} of heat sink 42_{(c)}. Shield members 65_{(c)} are configured and dimensioned to block illumination which, when fixture 10_{(c)} is installed as street-light, minimize upward illumination. This facilitates compliance with “dark-sky” requirements for limiting light pollution.

FIG. 72 shows that optical member 29_{(c)} is configured for directing emitter light in preferential direction 2 toward the forward side. FIGS. 57, 62, 63, 67-70 and 72 show a downwardly-extending shield member 66_{(c)} at rearward side 49_{(c)} of central heat-sink portion 45_{(c)}. Shield member 66_{(c)} is configured and dimensioned to block rearward illumination. Rearward shield member 66_{(c)} extends to a position lower than the lowermost outer-surface portion 290_{(c)} of optical member 29_{(c)}. Rearward shield member 66_{(c)} may include a reflective coating redirecting rearward light.

FIGS. 57, 62, 63, 67-70 and 72 show that forward wall-portion 181_{(c)} of housing main portion 171_{(c)} partially defines rearward shield member 66_{(c)}. These figures also show cover-member forward end 351_{(c)}, which is secured to forward wall-portion 181_{(c)} of housing body 176_{(c)}, partially defining rearward shield member 66_{(c)}. Reflective or white coating of housing 17_{(c)} may provide reflective characteristics for redirecting rearward light toward the preferential forward side 2.

As seen in FIGS. 57, 61, 70 and 72, cover member 350_{(c)} has a cover wall 354_{(c)} extending between rearward and forward ends 352_{(c)} and 351_{(c)}. Cover wall 354_{(c)} includes a lowermost portion 354A_{(c)} which is at a position lower than lowermost position 66A_{(c)} of rearward shield member 66_{(c)} to further block rearward illumination. Reflective or white coating of cover wall 354_{(c)} may provide reflective characteristics for redirecting rearward light in useful direction.

In some prior LED devices, back-light shielding has been in the form of individual shields disposed on a non-preferential side of each LED emitter. Some of such prior shielding was positioned over the exterior of a corresponding lens. In such prior cases, over time the back-light shielding often became covered with dust or other ambient particles and simply absorbed rearward light from the respective LED emitter. Such absorption translated in decreased efficiency of light output from such LED devices. In other examples, prior back-light shielding was positioned inside each lens corresponding to each individual LED emitter. While protected from contamination, such shielding resulted in lenses which were both complex and expensive to manufacture. In either type of the back-light shielding disposed on the non-preferential side of each individual LED emitter, there was still some undesired light in the rearward direction. Such light escaped the prior lens-shield configuration through unintended refraction or reflection by the lens.

In some other prior examples of back-light shielding used in light fixtures, such shields were in the form of a separate structure secured with respect to the fixture rearwardly to the illuminator. Such separate shielding structures often required complicated securement arrangements as well as interfered with the overall shape of the light fixture.

The integrated back-light shielding of the present invention, provides effective blocking of rearward light and provides reflection of such light away from areas of undesired illumination. The reflection provided by the integrated back-light shield of this invention facilitates higher light-output efficiency of the LED illuminator used in the LED light fixture of the present invention. The integrated nature of the back-light shielding of the present invention provides all the benefits of a single back-light shield without disruption of the overall shape of the fixture. Furthermore, the back-light shielding of the present invention is defined by surfaces which are open to air and water flow, which facilitates self cleaning of the reflective surface and minimizes absorption of light received by such shield surface.

Another aspect of this invention is illustrated best in FIGS. 59-62, 64-66, 71-75, 77 and 78. These figures show an exterior fulcrum 90_{(c)} of fixture 10_{(c)} affixed to rearward portion 33_{(c)} of the fixture. Fulcrum 90_{(c)} is configured to pivotably engage one side 11A_{(c)} of support member 11_{(c)} when a fixture-adjacent end 110_{(c)} of support member 11_{(c)} is within fixture interior 19_{(c)}. FIGS. 61, 62, 65, 72, 73 and 78 show that fixture 10_{(c)} also includes an engager 91_{(c)} secured within fixture interior 19_{(c)} in position to engage the opposite side 11B_{(c)} of support member 11_{(c)} at a position offset from fulcrum 90_{(c)}. This arrangement holds fixture 10_{(c)} in the desired orientation when support member 11_{(c)} is held between fulcrum 90_{(c)} and engager 91_{(c)}.

FIGS. 64-66 show that fulcrum 90_{(c)} is shaped to limit lateral movement of support member 11_{(c)} thereagainst by its cradling shape and the fact that fulcrum 90_{(c)} includes a row of teeth 92_{(c)} configured to engage support member 11_{(c)}.

Fulcrum 90_{(c)} is part of a fulcrum member 93_{(c)} which also includes support structure 95_{(c)} for fulcrum 90_{(c)}. FIGS. 59, 60, 64-66, 71, 74 and 75 show frame 30_{(c)} having a pair of rearmost extensions 39_{(c)} between which fulcrum 90_{(c)} is secured. FIG. 10 also shows heat sink 42_{(c)}, frame 30_{(c)}, upper shell 34_{(c)} and fulcrum 90_{(c)} formed as a single piece.

The exterior fulcrum provides advantages such as allowing a smaller aperture for a support-member entry into the fixture interior 13_{(c)} as well as easier access to the interior by providing more room for clearance of a compartment door. The smaller entry aperture may eliminate the need for a splash guard which is typically required for UL listed outdoor light fixtures, while still providing for the possibility of a splash-guard arrangements.

As shown in FIGS. 62, 65 and 73, engager 91_{(c)} is adjustably secured with respect to upper shell 34_{(c)} and includes a yoke 96_{(c)} shaped to substantially conform to the shape of support member 11_{(c)}. Yoke 96_{(c)} has a pair of pin-receiving apertures 97_{(c)} with a shaft portion 98A_{(c)} of a corresponding pin 98_{(c)} extending therethrough into threaded engagement with upper shell 34_{(c)}.

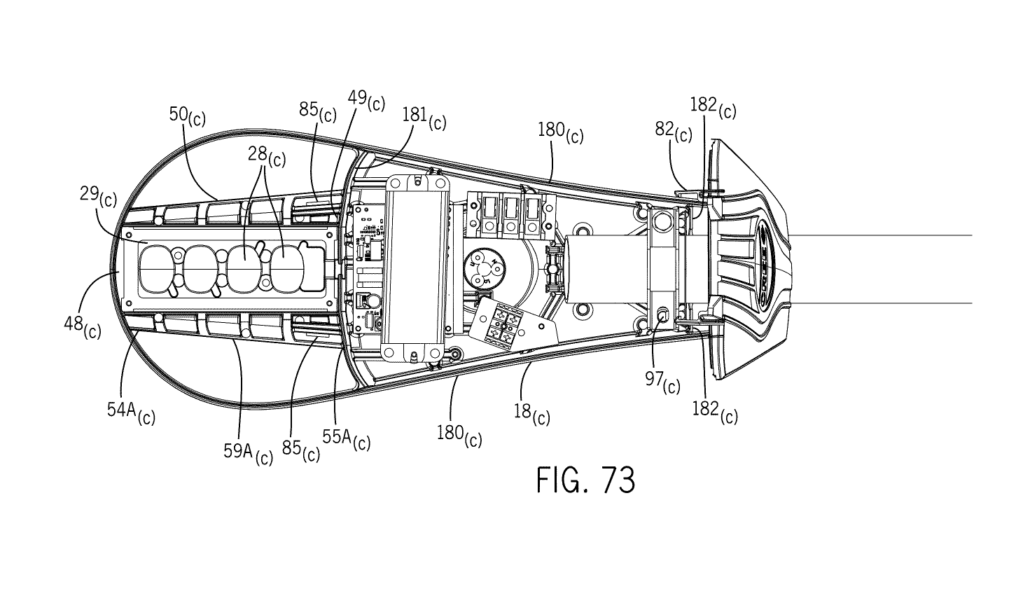

FIGS. 72 and 73 show that fixture interior 19_{(c)} has an angle-referencing region 340_{(c)} shaped to engage fixture-adjacent end 110_{(c)} of support member 11_{(c)} in order to facilitate positioning of fixture 10_{(c)} (with respect to support member 11_{(c)}) within one of plural predetermined angle ranges 344). FIG. 72 shows angle-referencing region 340_{(c)} as a step-like configuration extending downwardly from upper shell 34_{(c)}. Steps 341_{(c)} each correspond to one of the plural predetermined angle ranges such that, depending on which of steps 341_{(c)} is selected for engagement by fixture-adjacent end 110_{(c)} of support member 11_{(c)}, adjustment of engager 91_{(c)} locks fixture 10_{(c)} at a particular angle with respect to support member 11_{(c)} within the range of the selected step 341_{(c)}. Such predetermined angle ranges are range 342A_{(c)} (which includes the range of about −5° to about −2.5°), range 342B_{(c)} (which includes the range of about −2.5° to about 0°), range 342C_{(c)} (which includes the range of about 0° to about +2.5°), range 342D_{(c)} (which includes the range of about +2.5° to less than about)+5°, and range 342E_{(c)} (which includes the range of about)+5°.

FIGS. 59 and 60 show light fixture 10_{(c)} which in plan view has central and outward portions. The central portion includes housing 17_{(c)} enclosing LED power circuitry, heat sink 42_{(c)} secured with respect to housing 17_{(c)} and supporting LED illuminator 40_{(c)}. The central portion also includes a mount adapted for securement to support member 11_{(c)}. As seen in FIGS. 59 and 60, the outward portion defines an outer plan-view shape of fixture 10_{(c)} and is secured to the central portion with through-space(s) 12_{(c)} between the central and outward portions.

As further seen in FIGS. 59, 60, 74 and 75, through-spaces 12_{(c)} are along heat sink 42_{(c)} on opposite sides thereof. Through-spaces are shown along opposite sides of the central portion. FIG. 76 shows through-spaces 12_{(c)} being along housing 17_{(c)}.

The outward portion has an outer perimeter which in plan view may be substantially similar to the footprint of a cobrahead non-LED light fixture.

This invention gives great flexibility in providing LED light fixtures for a variety of particular roadway lighting and other similar outdoor lighting purposes. The desired light-output level determined by the particular application and/or determined by dimensional constraints (e.g., pole height, area to be illuminated, and desired foot-candles of illumination in the target area) can be varied substantially by selection of the particular appropriate LED illuminator and chosen power level, with or without modification of heat-sink size, without departing from a particular desired form factor, such as the above-mentioned “cobrahead” form. The open “footprint” of the fixture of this invention allows such flexibility in a light fixture with advantageous performance characteristics, both in light output and in heat dissipation.

One example of such light fixture is the fixture referred to as the first embodiment. Such particular fixture with a chosen four LED emitters and a heat sink as shown at power level of twenty-four watt gives an output of about 2411-2574 lumens, depending on LED correlated color temperature (CCT). The same fixture with applied power of 42 watt gives an output of about 3631-3884 lumens, again depending on LED CCT. Higher lumen outputs can be achieved by corresponding adjustments in the number and nature of LED emitters, with or without corresponding adjustment of the heat sink. These changes can be made with or without change in the “footprint” of the fixture.

While the principles of the invention have been shown and described in connection with specific embodiments, it is to be understood that such embodiments are by way of example and are not limiting.

1. An LED light fixture comprising:
a housing portion forming a chamber enclosing at least one driver; and
a base extending from the housing portion and supporting at least one LED illuminator outside the chamber, the housing portion and the base defining an open space therebetween permitting air/water-flow therethrough.

2. The LED light fixture of claim 1 wherein the housing portion and the base are each formed as part of a one piece comprising at least one frame member supporting the base with respect to the housing portion and including forward and rearward regions.

3. The LED light fixture of claim 2 wherein:
the rearward region includes the chamber and a rearmost portion adapted for securement to a support member; and
the base is within the forward region defining the open space along at least three sides of the base.

4. The light fixture of claim 2 wherein
the at least one LED illuminator is in thermal contact with an illuminator-supporting region of the base, the at least one LED illuminator comprising an optical member disposed over at least one LED emitter and configured for directing emitter light predominantly forward; and
a rearward shield member extends downwardly at the rearward side of the base, the rearward shield member extending lower than a lowermost outer-surface portion of the optical member to block rearward illumination therefrom.

5. The light fixture of claim 1 wherein the base is a separate structure secured with respect to the housing.

6. The light fixture of claim 5 wherein the base comprising a pair of extruded side portions each forming a channel along the base, the side portions and the base being of a single-piece extrusion secured with respect to the housing.

7. The light fixture of claim 5 wherein:
the base is a single-piece extrusion having an illuminator-supporting region;
the at least one LED illuminator comprises a plurality of LED modules in thermal contact with the illuminator-supporting region of the single-piece extrusion.

8. The LED light fixture of claim 7 wherein
the LED-array modules are substantially rectangular having predetermined module-lengths; and
the illuminator-supporting region has a length which is selected from one module-length and a multiple thereof.

9. The LED light fixture of claim 8 wherein at least one of the plurality of modules has a module-length different than the module-length of at least another of the plurality of modules.

10. The light fixture of claim 5 wherein the base comprises a plurality of extruded heat sinks.

11. The light fixture of claim 10 wherein the at least one LED illuminator comprises a plurality of LED modules each in thermal contact with a respective one of the extruded heat sinks.

12. The light fixture of claim 11 wherein each heat sink supports one of the LED modules.

13. The light fixture of claim 5 wherein the open space is along at least three sides of the base.

14. The light fixture of claim 13 wherein the base comprises a plurality of extruded heat sinks.

15. The light fixture of claim 14 wherein the at least one LED illuminator comprises a plurality of LED modules each in thermal contact with a respective one of the extruded heat sinks.

16. The light fixture of claim 1 comprising at least one wall extending within the open space and open for air/water-flow along at least two sides thereof.

17. The LED lighting fixture of claim 16 wherein the at least one wall extends within the open space substantially along the base.

18. The LED lighting fixture of claim 17 wherein the at least one wall divides the open space into an illuminator-adjacent flow region and a chamber-adjacent flow region.
